(19) United States
(12) Patent Application Publication
(10) Pub. No.: US 2015/0131126 A1
(43) Pub. Date: May 14, 2015

(54) PRINT MANAGEMENT SYSTEM AND METHOD

(71) Applicant: Zsunami, Inc., Dallas, TX (US)

(72) Inventors: Damon Clyde Daniels, Dallas, TX (US); Damien Andrew Gough, Dallas, TX (US)

(21) Appl. No.: 14/076,498

(22) Filed: Nov. 11, 2013

(51) Int. Cl. G06F 3/12; G06K 15/02

(52) U.S. Cl. CPC G06F 3/1256; G06K 15/1882; G06K 15/1814; G06F 3/1204; G06F 3/1285
USPC 358/2.1; 358/1.15

(57) ABSTRACT

A print management system/method allowing definition of font-based vector artwork images (VAI) that may be associated with selected vector palette groups (VPG) for print publication is disclosed. The system/method operates to permit a publisher to define a catalog of VAIs and associated VPGs that together define sets of font-based presentation images (FPI). Customers may select among the various FPI to generate a proof/production print (PPP) file that is processed by a web server to generate an encapsulated document file (EDF) incorporating the PPP in addition to information supporting an electronic financial transaction (EFT) between the customer and publisher. The customer may transfer the EDF to a printer who then activates the EDF to affect both the print publication of the PPP and an ETF between the customer and publisher based on the number of physical prints of the PPP by the printer.

### CROSS REFERENCE TO RELATED APPLICATIONS

Not Applicable

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention relates to print management systems/methods and specifically addresses application contexts in which a graphic image may be associated with a variety of color palette combinations prior to hardcopy print generation. In these situations, generation of individual proof/production print (PPP) rendered images typically results in a large inventory of images that must be maintained by a publisher. The present invention addresses this by generating images in a font-based vector artwork image (VAI) format and associating the image with one or more vector palette groups (VPG) of colors that are then used by the print publisher for PPP rendering.

The present invention may incorporate a system/method to encapsulate the PPP files associated with the VAI/VPG combinations in an encapsulated document file (EDF) that permits print publishers to render the PPP image and compensate the owner of the VAI/VPG data for the use of this information in generating printed hardcopy.

### PRIOR ART AND BACKGROUND OF THE INVENTION

### Overview

The prior art teaches various predefined graphical images may be associated with customer graphical user interface (GUI) selections for the purposes of generating ‘custom’ printing jobs such as may be associated with greeting cards, business cards, posters, and the like. In these situations the publisher may generally invest in the production of a graphic image that may be rendered in a variety of color combinations. Each of these color combinations represents a rendered option that may be selected by the customer via a GUI for eventual publication via some form of mechanical print process.

### DEFICIENCIES IN THE PRIOR ART

The prior art as detailed above suffers from the following deficiencies:
Consumers are generally limited to specific image patterns having embedded color selections. This limits the ability for the consumer to change a given image presentation.
Publishers are forced to generate a plethora of image variations having colors that match the breadth of anticipated customer design. This requires maintaining a large catalog of colored images and requires significant manpower to maintain.
The file size associated with rendered images can be quite large and as such rendering these images for preview can be problematic in Internet web-based applications.
Publishers do not have a methodology to recoup the investment in generating the original image and as such reproduction of the image may not be limited by the publisher once given to the customer.

While some of the prior art may teach some solutions to several of these problems, the core issues of allowing customer customization of publisher images while simultaneously allowing the publisher to proffer suggested image color combinations under a controlled distribution paradigm has not been addressed by the prior art.

### OBJECTIVES OF THE INVENTION

Accordingly, the objectives of the present invention are (among others) to circumvent the deficiencies in the prior art and affect the following objectives:
(1) Provide for a print management system and method that allows for publisher to define images in a manner that permits easy swapping of colors within the image based on groups of preselected color combinations.
(2) Provide for a print management system and method that reduces the amount of cataloging overhead associated with supporting multiple color variations on a given stock image.
(3) Provide for a print management system and method that allows customers to select from a variety of 2D and 3D images for use in a print/production publication (PPP).

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

A system and method for allowing rapid modification of colors associated with a stock image is disclosed.

### System Overview

The invention system generally incorporates a color change tool whose functionality avoids the need to replicate each graphic element and have to assign a unique color mix to it in order for it to be made available to a consumer as replacement color in the original graphic design.

Instead, the present invention enables the end user to change the color of the graphical element by selecting from pre-selected colors, available in a color library (vector palette group (VPG)), each represented by an individual letter in a unique font library. Fonts are organized in color families for easier use by the end user.

### Method Overview

The invention method generally incorporates the following steps as depicted in FIG. 4 (0400):
(1) Each complex pattern within the image is broken down into unique vectorized shapes, representing the graphic elements of the design (0401).
(2) Each element has an original color mix assigned to it by the designer (0402).
(3) Each graphic element (shape) vector path of the design is then saved out into SVG or EPS format (0403).
(4) Once saved, the graphic element in its new format will be used to create a complex vector glyph, now represented as a custom vectorized font (CVF). Each letter in the new font represents one distinct vector pattern in the original design, or image file (0404).
(5) Kerning and/or metrics settings are adjusted to align each font character with the previous character along the Z-axis in Z-dimensional depth, instead of X/Y mapping rules adhered to by conventional fonts (0404).
(6) The image may be defined in a proof/production print by combining font characters representing the distinct vectors (0405).
(7) The CVF is then made available to be used in an online application for display/print of the image (0406).

Once generated, the CVF may be mated with associated VPG elements and displayed/printed using a web application to generate the resulting PPP image/hardcopy. As the resulting PPP in this situation is device independent, it may be used in a variety of contexts to render the graphic image with a variety of colorized variations.

### Application Overview

The CVF may be embedded within or used by any web application or end user for rendering of the colorized graphic image. Using this technique, specific pre-designed colors or 4-color (photographic) images can also be assigned font letters and libraries of fonts can be created with each letter of each font representing a unique color of the image or pattern.

With this technique, a 4-color (photo) image could be represented as the text string “ABCD” when typeset in the Z-dimension depth (font layers on top of each other). The next photo image would be represented as “EFGH” in the exact pattern as the first image, and so on. The amount of colors or letters is now variable for each graphical element in the design, without requiring new color assignments to each or requiring a copy of the unique shape to which it is to be applied. This is beneficial as web browsers and smart devices render fonts quickly, smoothly, and efficiently, enabling the user to make rapid color changes working on the original graphical shape. Therefore, using such a font, the consumer can easily and dynamically change images (colors/images) by simply entering keystrokes or letter changes.

As an example, if the design created a 2-color pattern and assigned 32 colors to each pattern shape, the result would be 1024 color combinations for these specific patterns, each represented by a unique font assignment selected by using one of 32 keystrokes. In contrast, the prior art would require the individual generation of the image for each of the 1024 color combinations, or a total of 1024 separate images.

Within this context the disclosed invention can also be used as an encryption technique for patterns and images, as the end user needs to know the order (ABCD vs. ACBD, etc.) the glyphs need to be aligned to achieve the desired complex pattern, design, or image.

### BRIEF DESCRIPTION OF THE DRAWINGS

For a fuller understanding of the advantages provided by the invention, reference should be made to the following detailed description together with the accompanying drawings wherein:

FIG. 1 illustrates a preferred exemplary system overview embodiment of the present invention;

FIG. 2 illustrates a preferred exemplary method overview embodiment of the present invention;

FIG. 3 illustrates a preferred exemplary system detail embodiment of the present invention;

FIG. 4 illustrates a preferred exemplary method detail embodiment of the present invention;

FIG. 5 illustrates a preferred exemplary alternate method detail embodiment of the present invention;

FIG. 6 illustrates a preferred exemplary system detail embodiment of the present invention implementing electronic funds transfer (EFT) print control limitations;

FIG. 7 illustrates a preferred exemplary system data flow of the present invention implementing electronic funds transfer (EFT) print control limitations;

FIG. 8 illustrates a preferred exemplary method detail embodiment of the present invention implementing electronic funds transfer (EFT) print control limitations;

FIG. 9 illustrates an exemplary preferred embodiment of an encapsulated document file (EDF) incorporating an embedded image payload useful in some preferred invention embodiments;

FIG. 10 illustrates an exemplary preferred embodiment of an encapsulated document file (EDF) incorporating an external image payload useful in some preferred invention embodiments;

FIG. 11 illustrates an exemplary EFT processing data flow associated with a preferred invention embodiment;

FIG. 12 illustrates an exemplary print job setup dialog associated with a preferred invention embodiment;

FIG. 13 illustrates an exemplary 3D printing application using the present invention teachings wherein the 3D object is printed from a part/product database;

FIG. 14 illustrates an exemplary 3D printing application using the present invention teachings wherein the 3D object is printed from a part/product database referencing a CAD file;

FIG. 15 illustrates an exemplary 3D printing application using the present invention teachings wherein the 3D object is printed from a part/product database that references a 3D scanned image;

FIG. 16 illustrates an exemplary 3D printing application using the present invention teachings wherein the 3D object is printed from a part/product database that is defined by a designer operating as a contractor for a part/product consumer;

FIG. 17 illustrates an exemplary system data flow depicting an application of the present invention to controlled customized artwork generation for greeting cards, books, comic books, and other publications;

FIG. 18 illustrates an exemplary application of the present invention as applied to unique serialized print renderings;

FIG. 19 illustrates an exemplary application of the present invention as applied to custom greeting card generation;

FIG. 20 illustrates an exemplary application of the present invention as applied to photograph print distribution;

FIG. 21 illustrates an exemplary first glyph with normal font spacing and metrics generated using the present invention;

FIG. 22 illustrates an exemplary second glyph with normal font spacing and metrics generated using the present invention;

FIG. 23 illustrates the exemplary first glyph of FIG. 21 and exemplary second glyph of FIG. 22 rendered with font spacing and metrics removed;

FIG. 24 illustrates a three-dimensional perspective view of the combined exemplary first and second glyph combination of FIG. 23;

FIG. 25 illustrates exemplary original CIP data that may have associated with it various colors and other display attributes for each of the graphical entities depicted;

FIG. 26 illustrates EPS data extracted from FIG. 25 and transformed into a first vector element as an EPS file;

FIG. 27 illustrates EPS data extracted from FIG. 25 and transformed into a first vector element as an EPS file;

FIG. 28 illustrates loading the EPS data from FIG. 26 as a font glyph in a font editor and associating this font glyph with a font character;

FIG. 29 illustrates loading the EPS data from FIG. 27 as a font glyph in a font editor and associating this font glyph with a font character;

FIG. 30 illustrates an exemplary font editor font character association dialog as depicted in FIG. 28 and FIG. 29;

FIG. 31 illustrates an exemplary font editor font saving dialog screen after all font character glyphs have been defined;

FIG. 32 illustrates a detail of the font saving dialog generally depicted in FIG. 31;

FIG. 33 illustrates an exemplary HTML file used to generate an exemplary test image display as depicted in FIG. 40;

FIG. 34 illustrates exemplary cascading style sheet (CSS) rules associated with the HTML file depicted in FIG. 33;

FIG. 35 illustrates exemplary cascading style sheet (CSS) rules associated with the HTML file depicted in FIG. 33;

FIG. 36 illustrates an exemplary font editor image generation for Layer 0 (character “0”) of the test image as depicted in FIG. 40;

FIG. 37 illustrates an exemplary font editor image generation for Layer 1 (character “1”) of the test image as depicted in FIG. 40;

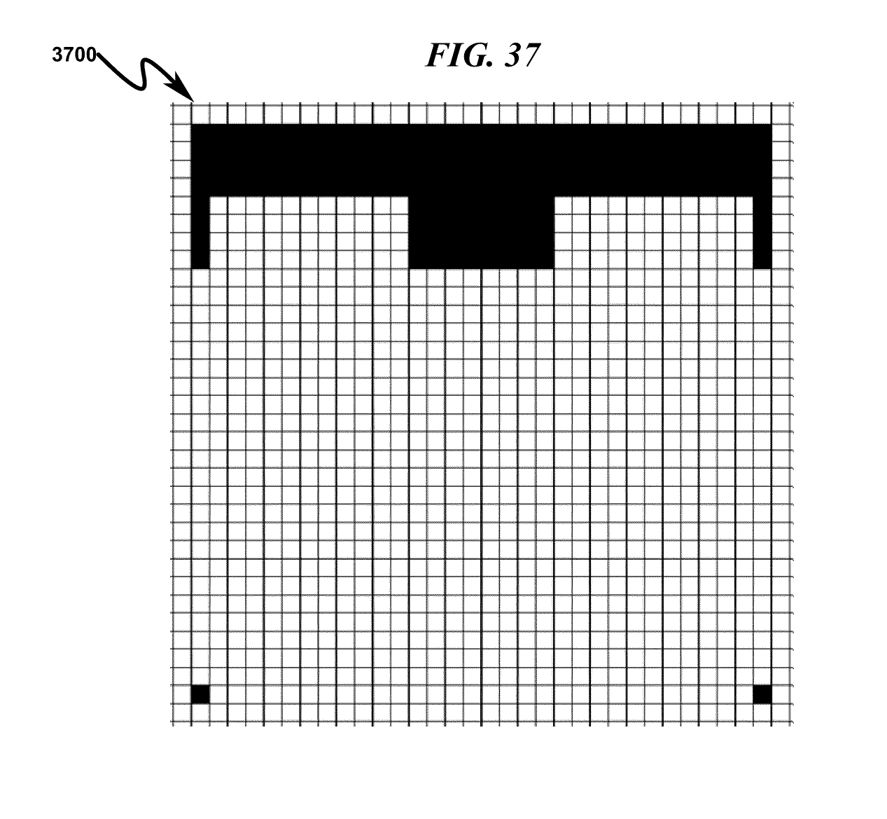

FIG. 38 illustrates an exemplary font editor image generation for Layer 2 (character “2”) of the test image as depicted in FIG. 40;

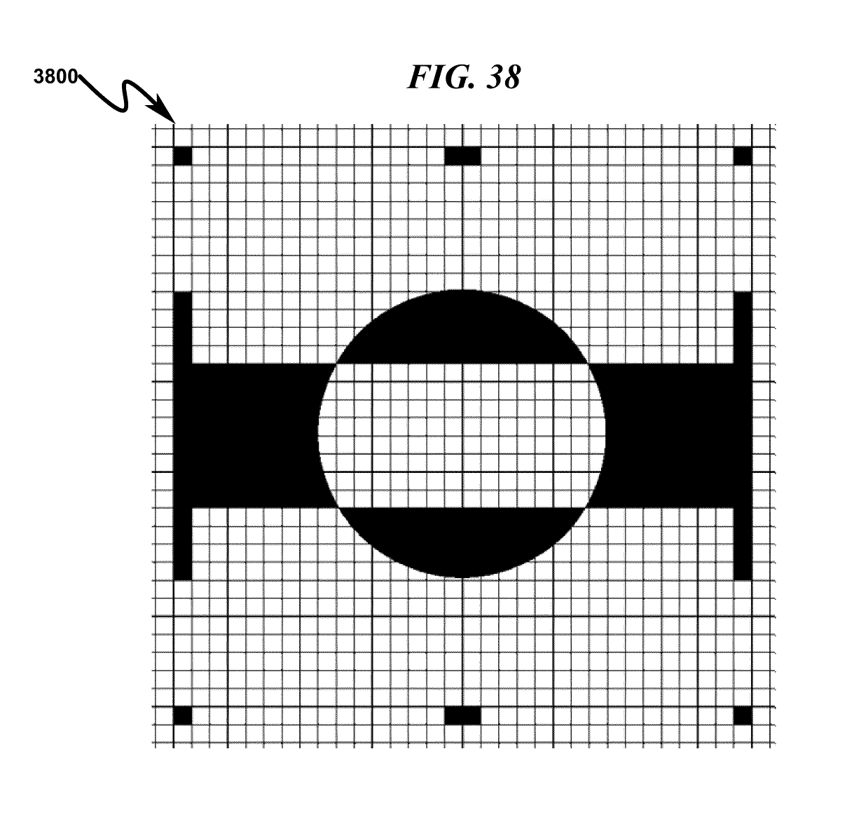

FIG. 39 illustrates an exemplary font editor image generation for Layer 3 (character “3”) of the test image as depicted in FIG. 40;

FIG. 40 illustrates an exemplary browser-based image display utilizing the font characters of FIG. 36-FIG. 39 and the HTML of FIG. 33 and CSS data in FIG. 34-FIG. 35;

FIG. 41 illustrates an exemplary HTML file used to generate an exemplary test image display as depicted in FIG. 48;

FIG. 42 illustrates exemplary cascading style sheet (CSS) rules associated with the HTML file depicted in FIG. 41;

FIG. 43 illustrates exemplary cascading style sheet (CSS) rules associated with the HTML file depicted in FIG. 41;

FIG. 44 illustrates an exemplary font editor image generation for Layer 0 (character “0”) of the test image as depicted in FIG. 48;

FIG. 45 illustrates an exemplary font editor image generation for Layer 1 (character “1”) of the test image as depicted in FIG. 48;

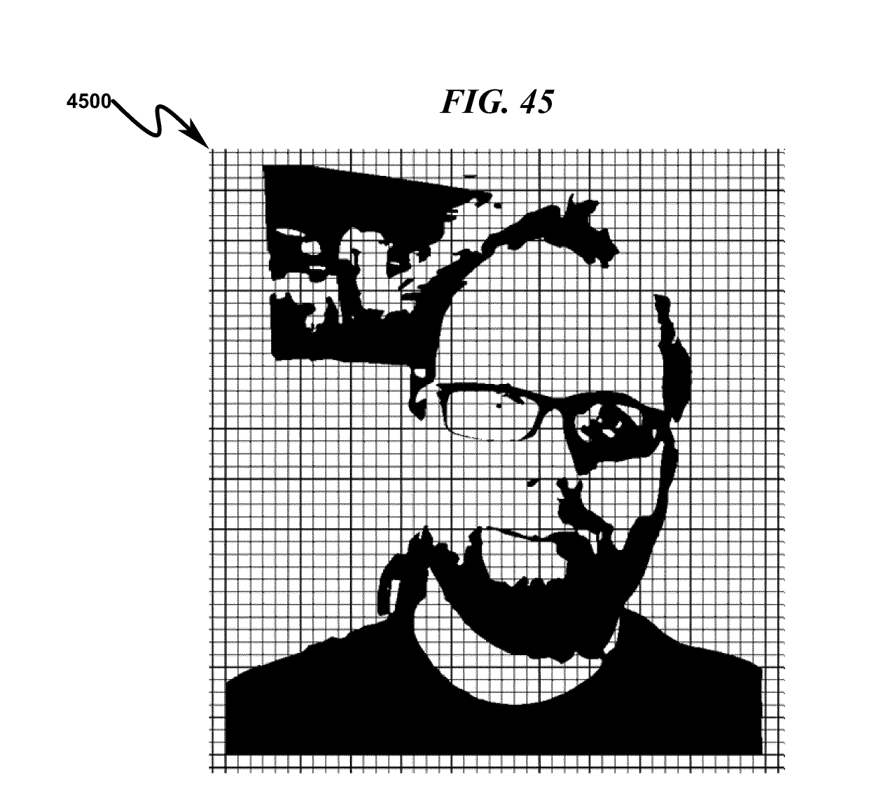

FIG. 46 illustrates an exemplary font editor image generation for Layer 2 (character “2”) of the test image as depicted in FIG. 48;

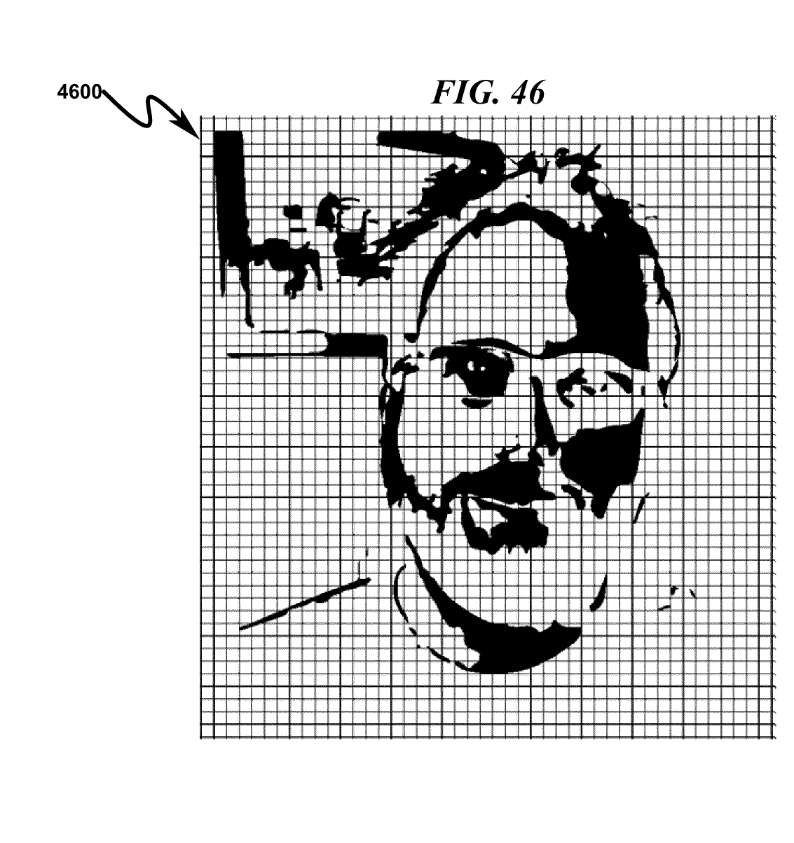

FIG. 47 illustrates an exemplary font editor image generation for Layer 3 (character “3”) of the test image as depicted in FIG. 48;

FIG. 48 illustrates an exemplary browser-based image display utilizing the font characters of FIG. 44-FIG. 47 and the HTML of FIG. 41 and CSS data in FIG. 42-FIG. 43;

FIG. 49 illustrates an exemplary HTML file used to generate an exemplary test image display as depicted in FIG. 56;

FIG. 50 illustrates exemplary cascading style sheet (CSS) rules associated with the HTML file depicted in FIG. 49;

FIG. 51 illustrates exemplary cascading style sheet (CSS) rules associated with the HTML file depicted in FIG. 49;

FIG. 52 illustrates an exemplary font editor image generation for Layer 0 (character “0”) of the test image as depicted in FIG. 56;

FIG. 53 illustrates an exemplary font editor image generation for Layer 1 (character “a”) of the test image as depicted in FIG. 56;

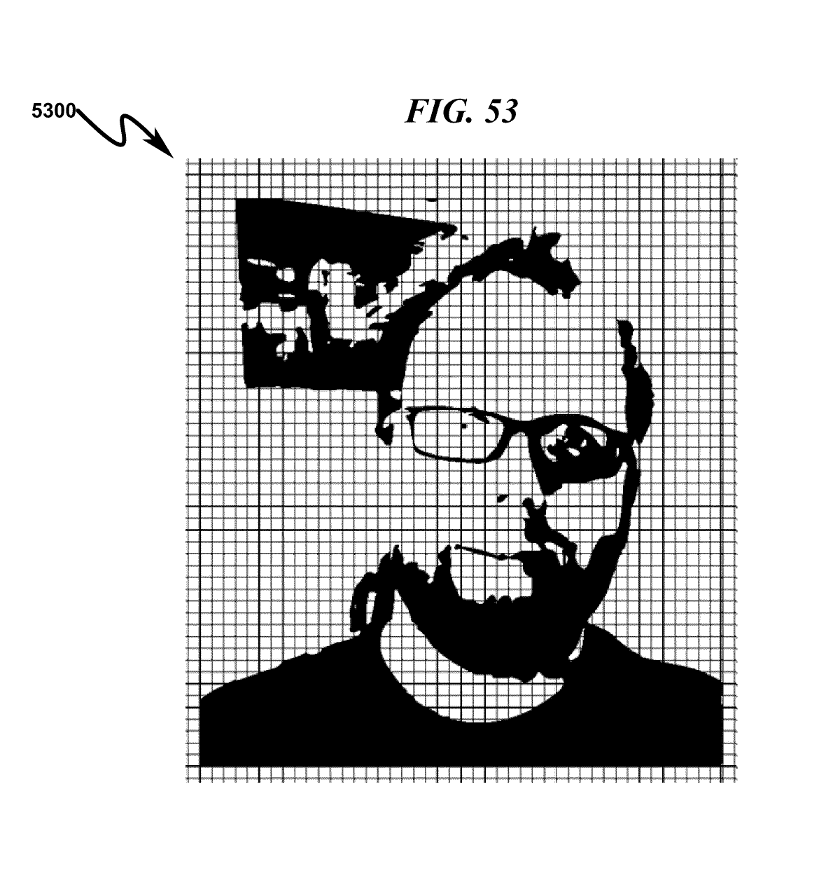

FIG. 54 illustrates an exemplary font editor image generation for Layer 2 (character “b”) of the test image as depicted in FIG. 56;

FIG. 55 illustrates an exemplary font editor image generation for Layer 3 (character “c”) of the test image as depicted in FIG. 56;

FIG. 56 illustrates an exemplary browser-based image display utilizing the font characters of FIG. 52-FIG. 55 and the HTML of FIG. 49 and CSS data in FIG. 50-FIG. 51;

FIG. 57 illustrates various ways in which font image files may be utilized in the context of the present invention;

FIG. 58 illustrates the use of HTML embedded web font references in the context of some preferred invention embodiments;

FIG. 59 illustrates an exemplary font image outline with associated left, right, top, bottom extents;

FIG. 60 illustrates exemplary stacked font image outlines with associated coincident left, right, top, bottom extents;

FIG. 61 illustrates modification of margin-left parameters to achieve overlapped font images;

FIG. 62 illustrates an exemplary font image outline offset outside the font left, right, top, bottom extents;

FIG. 63 illustrates an exemplary font image outline with associated left, right, top, bottom extents having coincident left and right extents; and

FIG. 64 illustrates an exemplary font image glyph outline and the rendered graphic image within a font editor.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a PRINT MANAGEMENT SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Internet Communication not Limitive

The present invention anticipates that a wide range of communication methodologies may be utilized to affect a specific implementation of the present invention. While the present invention specifically anticipates the use of the Internet for most applications, the present invention makes no limitation on the type of communication technology or computer networking that may be used. Thus, the term “computer network” and/or “Internet” are to be given the broadest possible definitions within the scope of the present invention.

### Standard Display Font (SDF) Format not Limitive

The present invention may make use of a wide variety of standard display font (SDF) definition formats in representing complex image pattern (CIP) data. While Web Open Font Format (WOFF), TrueType, OpenType, and Embedded OpenType font formats are preferred in many invention embodiments, the present invention is not limited to these particular SDF formats.

### Intermediate Graphic Format (IGF) not Limitive

The present invention may make use of a wide variety of intermediate graphic formats (IGF) in representing complex image pattern (CIP) data. While Encapsulate Postscript (EPS) and Scalable Vector Graphics (SVG) formats are preferred in many invention embodiments, the present invention is not limited to these particular formats.

### Payload File Format not Limitive

The present invention may utilize a wide variety of file formats when generating payload files associated with the Encapsulated Document File (EDF) described herein. The use of ZIP format in this context is only exemplary.

### Proof/Production Print (PPP) Document Format not Limitive

The present invention anticipates that many preferred invention embodiments may utilize Portable Document Format (PDF), Encapsulated PostScript (EPS), and/or Scalable Vector Graphics (SVG) file formats for the generation of the Proof/Production Print (PPP) files. However, the present invention is not necessarily limited to these particular file formats, and other web-compatible and/or printer-compatible file formats are also acceptable in this context.

### Printed Document not Limitive

While the present invention is applicable in many contexts to the production of two-dimensional printed documents, it is not limited to such, and the techniques discussed herein can equally be applied to any form of media, including but not limited to images, audio, video, printed matter, and three-dimensional objects printed using 3D printers and the like.

### Glyph Advance/Offset not Limitive

It will be assumed that in many preferred invention embodiments that the font definition data (FDD) described herein may incorporate glyph definitions in which the horizontal and/or vertical glyph offsets (advances) will be set to zero, thus indicating that the character advance associated with the font will be zero in the horizontal and/or vertical direction.

### Printer not Limitive

Within the context of the present invention disclosure, the term “printer” shall be broadly construed to include both 2D and 3D printing technologies. In some circumstances, data transfers to a “printer” may include a print shop or electronic data processing components operated by a print shop, including computers and the like directly controlling 2D and/or 3D printing devices.

### Image Rendering System Overview (0100)

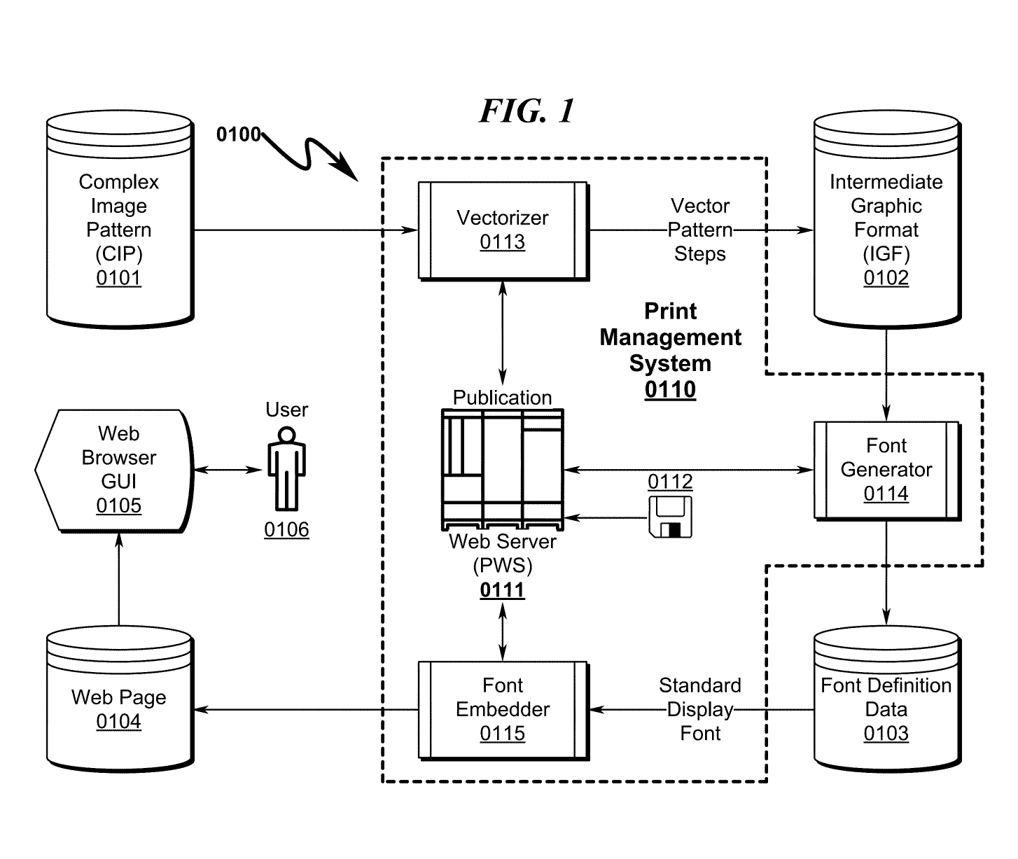

An overview of a presently preferred invention image rendering system embodiment is generally illustrated in FIG. 1 (0100). This system generally depicts the transformation of a complex image pattern (CIP) (0101) (that can variously be described in terms of a wide variety of graphics files well known in the art) into a format suitable for presentation within a web page (0104) by a web browser (0105) to a user (0106).

The system operates as follows. The CIP (0101) is operated on by a print management system (PMS) (0110) comprising a publication web server (0111) executing machine instructions retrieved from a computer readable medium (0112). These machine instructions comprise a vectorizer (0113), a font generator (0114), and a web page font embedder (0115). The CIP (0101) is operated on by the vectorizer (0113) to generate an intermediate graphic format (IGF) (0102) file which represents the content of the CIP (0101) in terms of vectors rather than conventional bitmaps or raster image data. The IGF file (0102) may be embodied in many formats with SVG and EPS being considered preferred but not limiting. The IGF (0102) information is operated on by a font generator (0114) to convert the vector information into a font definition file (0103) that permits the vectorized CIP information to be represented in TRUETYPE®, stroke font, glyph format, or some other standardized font representation. This font definition (0103) is then operated on by a font embedder (0115) that embeds the font in a web page (0104) that is interpreted by a web browser (0105) for display to a user (0106). Individual font characters can represent CIP (0101) color layers and thus be combined in an overlapped fashion (rather than offset in the X-Y direction as would occur with normal font displays).

The benefit of this image display approach is that changes in font color, Z-mapping overlap, and other aesthetic characteristics of the CIP (0101) data can be accomplished rapidly using the font display characteristics. Additionally, fonts may be efficiently processed by a wide range of web browser GUI (0105) interfaces, and as such the transmission payload and GUI response for the user (0106) is optimized using fonts rather than large CIP (0101) image files.

### Image Rendering Method Overview (0200)

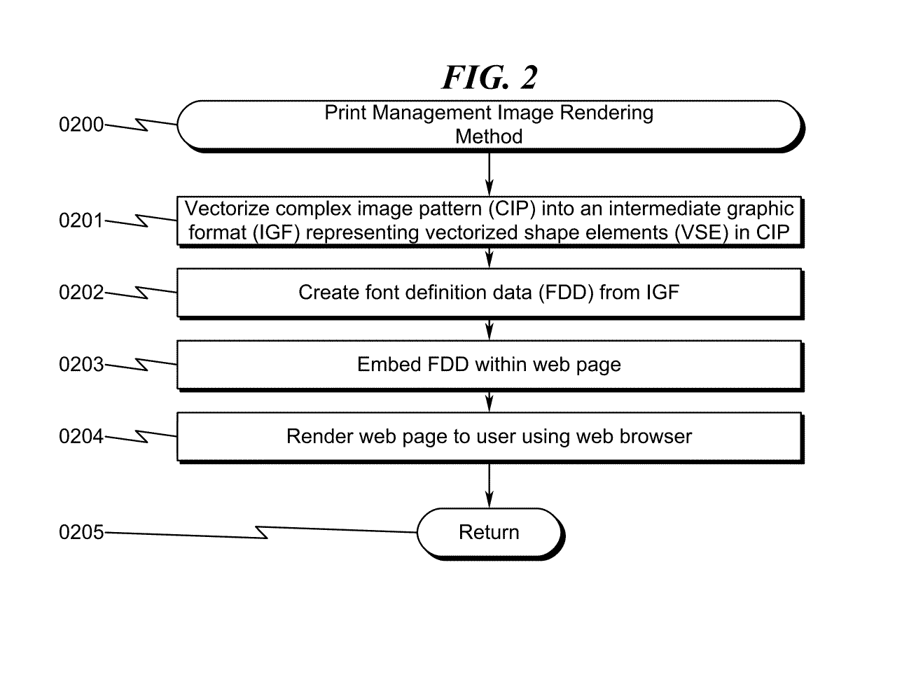

The above-described system may have an associated method as generally depicted in FIG. 2 (0200) and can be generalized as a print management image rendering method comprising the following steps:
(1) Vectorize a complex image pattern (CIP) to generate an intermediate graphic format (IGF) representing vectorized shape elements (VSE) with in the CIP (0201);
(2) Create font definition data (FDD) from the IGF (0202);
(3) Embed the FDD within a web page (0203); and
(4) Render the web page to user display/printer using a web browser (0204).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Application Context System Overview (0300)

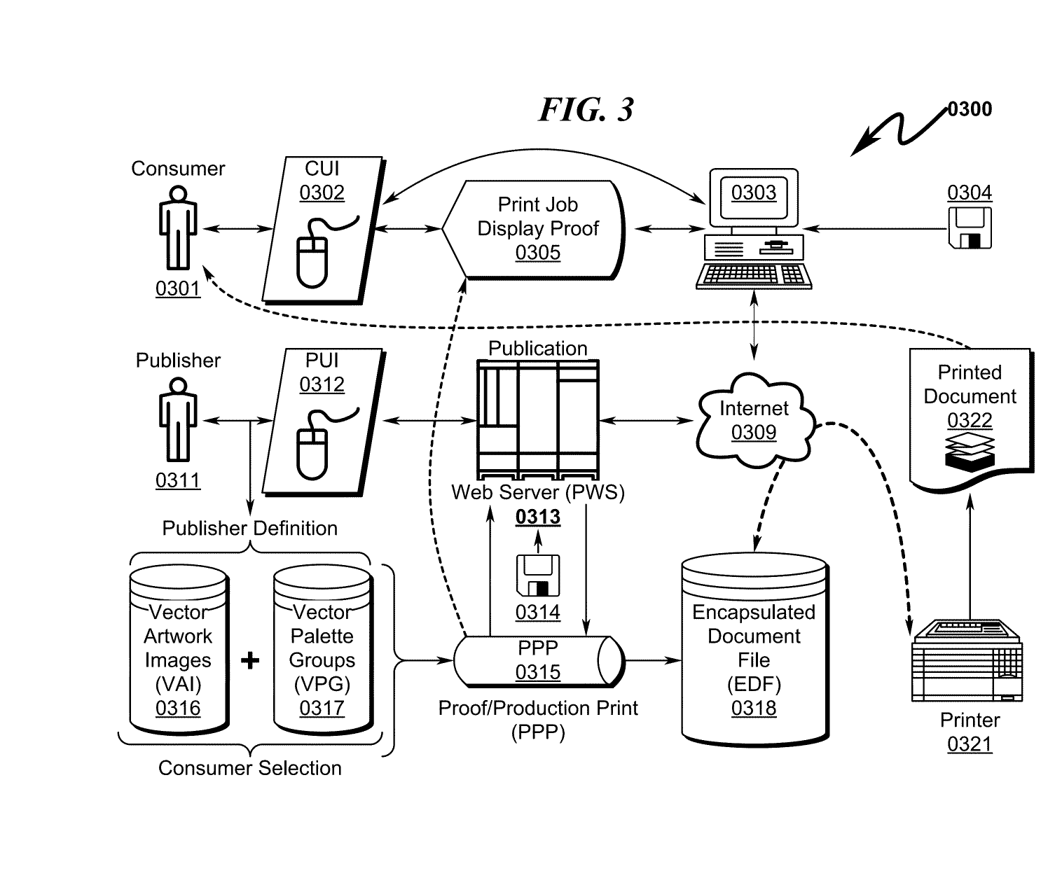

An overview of a presently preferred invention system embodiment is generally illustrated in FIG. 3 (0300) wherein a consumer (0301) interacts with a Consumer Graphical User Interface (CUI) (0302) operating in the context of a consumer computer system (CCC) (0303) running software read from a computer readable medium (0304). This CCC (0303) communicates via a communications network (0309) (typically the Internet) to a publication web server (PWS) (0313) similarly configured to support a publisher (0311) via a Publisher GUI (PUI) (0312) under control of software read from a computer readable medium (0314).

The PUI (0312) is configured to permit the publisher (0311) to generate graphic images comprising font-based vector artwork images (VAI) (0316). These VAI (0316) comprise font definitions that may be readily displayed and printed using a variety of web-based browser technologies and as such are essentially device independent in their capability of representation. Associated with these VAI (0316) are vector palette groups (VPG) (0317) also defined by the PUI (0312) to associate colors or groups of colors with specific print planes within the VAI (0316). This ability to define the VAI (0316) apart from their associated VPG (0317) color palette permits a given VAI (0316) to be rendered in a wide variety of color patterns as defined by the VPG (0317) sets associated with the selected VAI (0316). Since most of the image complexity of the resulting image is contained within the VAI (0316), variations on a given image theme with respect to color variations can be made easily without replication of the VAI (0316) data structure.

The system as depicted is configured to permit a consumer (0301) to interact with the CUI (0302) to make selections of a given VAI (0316) and an associated VPG (0317) to display a print job proof (0305) within the context of the CUI (0302) to determine if the selected VAI (0316) and VPG (0317) are aesthetically acceptable. Within this context the selected grouping of VPG (0317) colors associated with a given VAI (0316) may be in some cases limited based on choice limitations defined by the publisher (0311) or in some cases information provided by a print shop or other printer interface.

Once the consumer (0301) has selected a VAI (0316)/VPG (0317) pairing and generated a visual display proof (0305), the system is configured to render the VAI (0316)/VPG (0317) combination and generate an encapsulated document file (EDF) (0318) that incorporates the rendered vector image Proof/Production Print (PPP) (selected VAI (0316)+VPG (0317) combination to form a PPP file (0315)) in addition to information supporting an electronic funds transfer (EFT) between the consumer (0301) and publisher (0311).

The purpose of this EDF (0318) is to generate a file that the consumer (0301) may freely transport to any number of print shops (0321) (or printers) to generate physical prints of the PPP but under control of a financial agreement between the consumer (0301) and publisher (0311). The EDF (0318) may permit previews of the PPP but limits the printing of the PPP except in circumstances where the EFT between the consumer (0301) and publisher (0311) is activated. This configuration permits the publisher (0311) to generate publication content (0316, 0317) and license its publication to the consumer (0301) under strict print/quality guidelines so that for each printed document (0322) generated by the publisher (0311) is either remunerated via an EFT or the printed document (0322) quantity/quality is limited based on a pre-paid copy count specified in the EDF (0318).

Normally a publisher (0311) generating unique publishing content (artwork, etc.) for a customer (0301) may require that the printing of the published content be printed by the publisher (0311) in order for the publisher (0311) to recover overhead costs associated with the generation of the published content. The system/method as presented herein allows the publisher (0311) to generate content and allow that PPP content to be accessed/transferred by the consumer (0301) with the proviso that when the PPP is to be printed, the EDF container ensures that the publisher is financially compensated for the physical printing of the PPP. This financial model permits the publisher (0311) to be compensated for the intellectual property (IP) associated with publication of the PPP but also allows the consumer (0301) flexibility in where/when the PPP is physically generated.

### Method Overview

The above system description may in some preferred embodiments employ a lightweight portable vector image library font (“Stack Font”) to describe a complex image pattern (CIP) in a manner that is both display and print-friendly and that permits display in web-based user interfaces such as web browsers and the like. This method for creating variable complex vector patterns and images in web browsers and smart devices uses custom glyphs and Z depth font placement as described below.

As a contrasting background to the present invention, it is often a printing objective to make a two color complex pattern interchangeable with multiple color options for each of the two colors. A typical solution to this problem has been to save each pattern out with one set of color choices and then make that pattern available to the customer as an interchangeable image. The downside of this process is that this requires an image publisher to generate 108 images for 54 color choices for each product. Additionally, the thumbnail for the image would be the pattern itself and not just a color swatch.

Furthermore, within this objective is often the need to also show other products on a web page that were similar to the current product image thus making the number of required images larger by a multiple of how many similar products and required products would be on the page (3 more of each would require 6× as many images on the page as to the original 108). Thus, the shear time alone to prepare each product for this presentation in images alone would consume vast amounts of publisher time. This time also does not include time to create scripts or code to have all the images update simultaneously with each other and coding in a Z depth in the web page Cascading Style Sheet (CSS) to allow to images to overlap each other (i.e., creation of two transparent PNG files to accomplish this overlapping process). Thus, the combinatorial complexity and publisher operator time required to generate permutations of various image/color combinations as taught by the prior art quickly becomes extremely difficult to generate and unmanageable from a publisher maintenance standpoint.

In contrast to these conventional image display/rendering approaches, the present invention utilizes a different rendering approach to this problem by using a variable vector image. The present invention takes a complex pattern or image and vectorizes it into specific vector pattern steps of distinctive shapes, sizes, and colors as needed. This vector data is then saved out of each individual vector pattern (typically in a SVG or EPS format). Once the SVG or EPS is generated then this data is used to create a complex vector glyph in my new font for the application. Then the application font can be downloaded and used in the printing system or embedded in a displayed web page.

In this invention architecture, each letter in the application font represents (and renders) one distinct vector pattern in the complex pattern or image file. The next step in the rendering process is to adjust kerning and/or metrics settings to align each font character with the previous character along the Z-axis so that they will align on top of each other creating a glyph pattern that now reads in Z depth instead of being offset in and X or Y direction as are classic fonts. This permits embedding of several 4-color images in a library of fonts with each letter representing one color. Thus “ABCD” when typeset in Z depth (on top of each other) and in the correct order would render a given image. It is also then possible to embed another 4-color image in the letters “EFGH” in the exact same pattern as before. It is possible to carry out this pattern in the next logical step progressively to obtain many images embedded in the application font. This font configuration also allows the color and letters of the font to be varied individually.

The resulting graphical font representation described above is immensely beneficial in that all web browsers and smart devices render fonts quickly, smoothly, and efficiently. Thus, if the user has the application font representing the image features, they may easily change and dynamically alter images by inputting keystrokes or letter changes. This can also be used as another form of encrypting a pattern or image since the end user must know what order and glyphs need to be aligned to obtain the desired complex pattern or image. Additionally, this format can also be used to generate and display thousands of Quick Response (QR) Codes simultaneously.

### Method Overview Flow (0400)

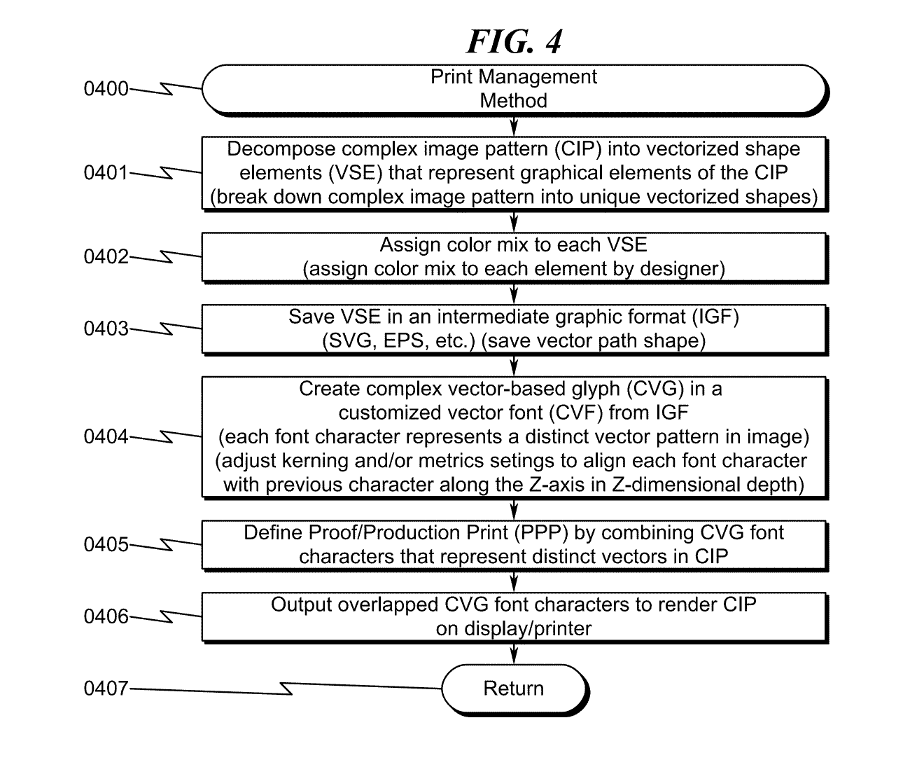

The present invention method anticipates a wide variety of variations in the basic theme of implementation in conjunction with the above-described system, but as generally depicted in FIG. 4 (0400) can be generalized as a print management method comprising the following steps:
(1) Decomposing a complex image pattern (CIP) into vectorized shape elements (VSE) that represent graphical elements of the CIP (0401);
(2) Assigning a color mix to each VSE (0402);
(3) Saving the VSE in an intermediate graphic format (IGF) (SVG, EPS, etc.) (0403);
(4) Creating a complex vector-based glyph (CVG) font from the IGF (0404);
(5) Defining a proof/production print (PPP) by combining CVG font characters that represent distinct vectors in the CIP (0405);
(6) Outputting overlapped CVG font characters to render the CIP on a display/printer device (0406).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Alternate Method Overview Flow (0500)

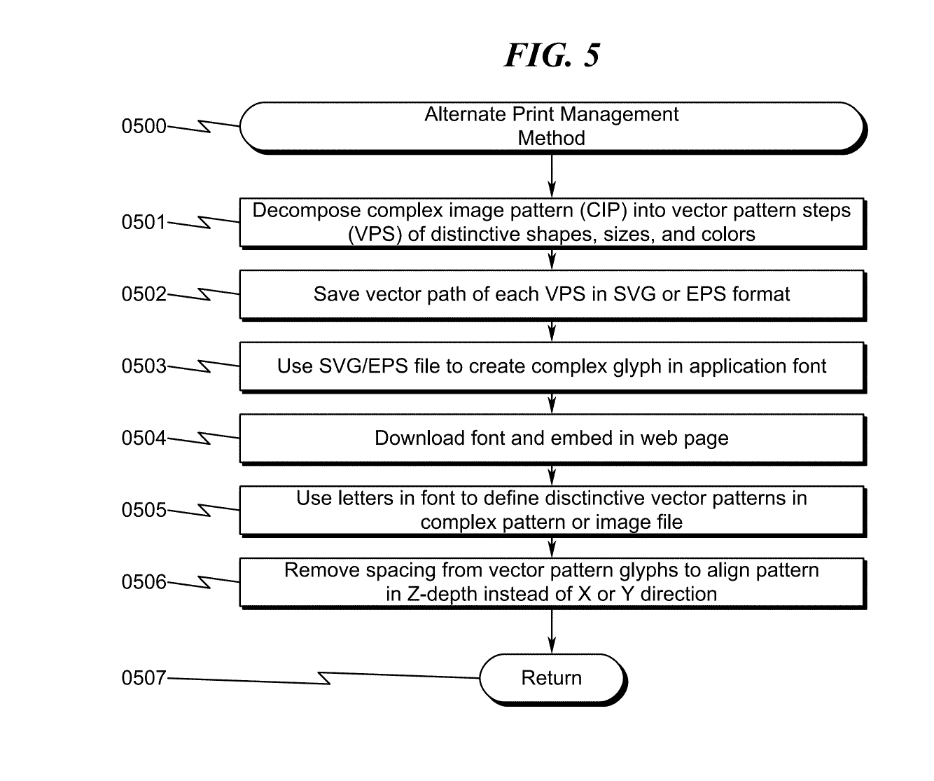

The method described in FIG. 4 (0400) may be embodied in more detail via the use of SVG/EPS files as depicted in the flowchart of FIG. 5 (0500), wherein an alternate print management method comprises the following steps:
(1) Decomposing a complex image pattern (CIP) into vector pattern steps (VPS) of distinctive shapes, sizes, and colors (0501);
(2) Saving the vector path of each VPS in SVG or EPS file format (0502);
(3) Using the SVG/EPS file to create a complex glyph in an application font (0503);
(4) Downloading the application font and embedding the font in a web page (0504);
(5) Using letters in the embedded font to define distinctive vector patterns in a complex pattern or image file (0505); and
(6) Adjusting kerning and metrics settings to align each font character with the previous character along the Z-axis in Z-depth (instead of a X or Y direction) (0506).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Controlled Print Distribution Embodiment Overview (0600)

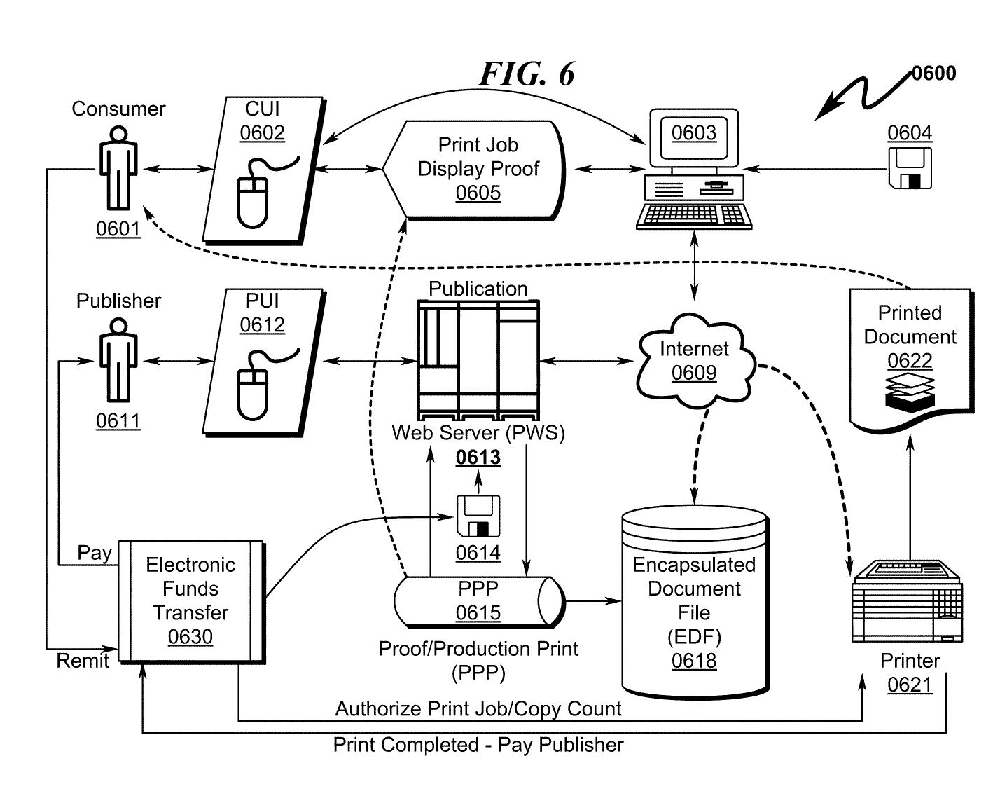

The exemplary embodiment generally illustrated in FIG. 3 (0300) may be augmented as depicted in FIG. 6 (0600) with an electronic funds transfer (EFT) processor (0630) that permits the publisher (0611) to control the distribution/reproduction of the PPP (0615) document by the consumer (0601) and/or the printer (0621). This controlled print distribution application permits the EDF (0618) to incorporate a variety of print control mechanisms to limit the printing of the PPP (0615) document and/or ensure that a financial feedback path from the printer (0621) to the publisher (0611) is maintained to ensure that as prints of the PPP (0615) are generated by the printer (0621) that the publisher is paid by the consumer (0601) using an EFT transaction.

The EFT (0630) processor can be incorporated within the software (0614) operating the publication web server (PWS) (0613) or operated in a separate server context. It should be noted that the EFT processor (0630) may operate to authorize individual prints of the PPP (0615) or in some circumstances authorize ‘batch’ prints of the PPP (0615) to occur. One skilled in the art will recognize that these variations are financially equivalent to the publisher but may result in lower network control overhead.

The link between the EFT (0630) processor and the printer (0621) will optimally be configured to ensure that any local memory (cache) within the printer (0621) is cleared after every print job is completed to ensure that additional prints of the PPP (0615) may not be generated without proper EFT (0630) processing of payments to the publisher (0611) by the consumer (0601).

### Exemplary System Data Flow (0700)

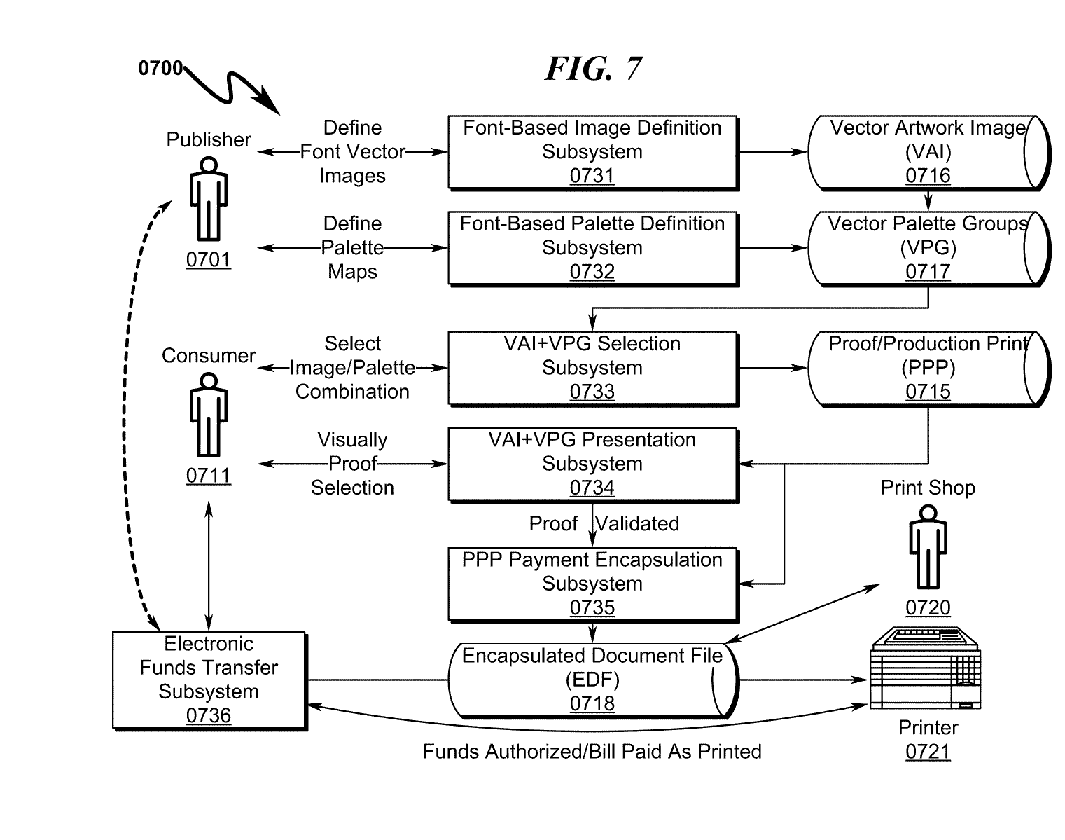

An overview of presently preferred invention system data flow is generally illustrated in FIG. 7 (0700) wherein a publisher (0701) interacts with a GUI to define font-based vector images (VAI) using a font-based image definition subsystem (0731) and associated palette maps (VPG) using a font-based palette definition subsystem (0732). This VAI (0716) and VPG (0717) data is stored in respective databases.

The consumer (0711) is permitted to select VAI (0716) and VPG (0717) combinations using a VAI+VPG selection subsystem (0733) to produce a proof/production print (PPP) (0715) image-and-colorization combination that may be visually presented using a rendering subsystem (0734) (optionally a web browser or the like). Once the PPP is validated by the customer (0711) (typically using a GUI approval screen dialog), the PPP is associated with a payment processing system using a PPP payment encapsulation subsystem (0735) to generate an encapsulated document file (EDF) (0718).

The EDF (0718) may be structured to encapsulate the PPP (0715) within a file configured to process funds transfer to the publisher (0701) using an electronic funds transfer (ETF) subsystem (0736) or in some cases the PPP (0715) may be separate from the EDF (0718) and simply referenced by the EDF (0718). In either case the EDF (0718) may incorporate encryption to ensure that the contents of the PPP (0715) is not readily readable by the consumer without first being processed by the EFT subsystem (0736).

The EDF (0718) may be freely distributed to the consumer (0711) and/or a print shop (0720) (printer) for rendering in physical form on a 2D or 3D printer (0721). Activation of the EDF (0718) for the purpose of ‘printing’ the PPP (0715) results in interaction with the EFT subsystem (0736) to enable a funds transfer to occur from the customer (0711) to the publisher (0701) each time the PPP (0715) is rendered on the printer (0721).

### Print Management EFT Controlled Distribution Method (0800)

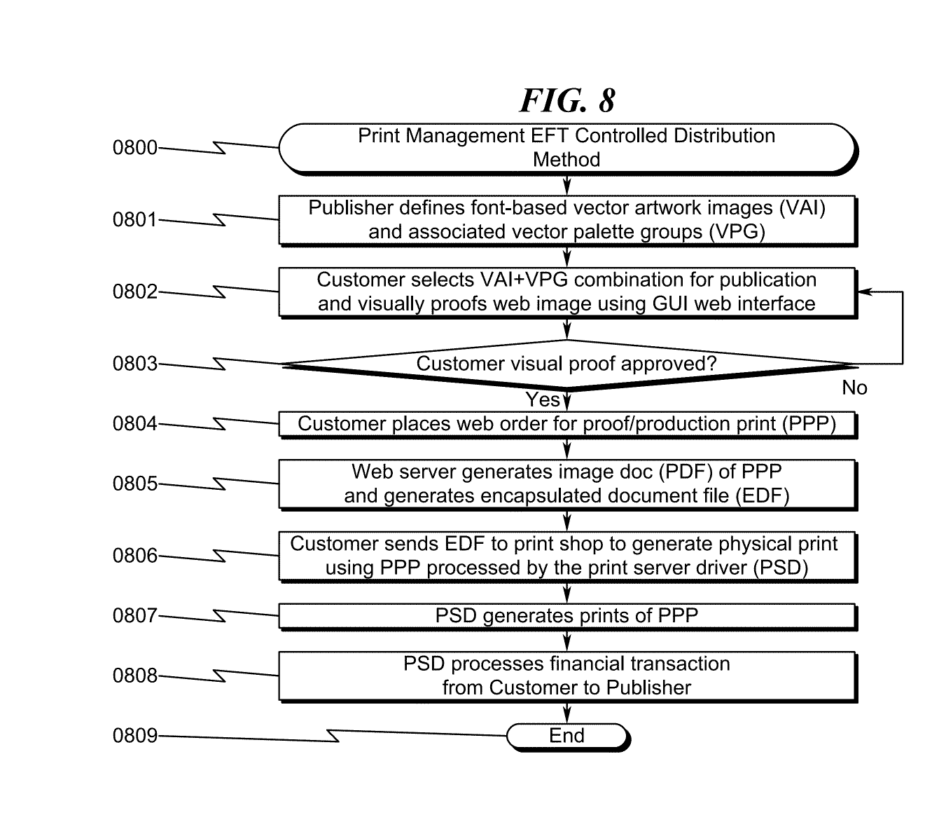

The data flow described in FIG. 7 (0700) may be embodied in the method flowchart of FIG. 8 (0800) to ensure that publisher created content when printed by the consumer will result in EFT payments to the publisher for each ‘printing’ of the PPP. This methodology as depicted in FIG. 8 (0800) comprises the following steps:
(1) Defining publisher font-based vector artwork images (VAI) and associated vector palette groups (VPG) (0801);
(2) Selecting customer VAI+VPG combinations for publication and visually proofing web images created by these combinations using a GUI web interface (0802);
(3) Determining if a visual proof of the customer selected VAI+VPG combinations is approved by the customer, and if not, proceeding to step (2) (0803);
(4) Placing a customer web order for a proof/production print (PPP) (0804);
(5) Generating an intermediate graphic file (IGF) document using a web server of the PPP and generating an encapsulated document file (EDF) from the IGF (0805);
(6) Transmitting the EDF to a print shop to render a physical print of the PPP using a print server driver (PSD) (0806);
(7) Generating prints of the PPP via the PSD (0807); and
(8) Processing a financial transaction from the customer to the publisher for each PPP print generated by the PSD (0808).

Note that this same methodology can be used to ‘print’ a wide variety of media objects, such as 2D prints, 3D objects, audio files, video files, etc. Thus, the term ‘print’ or ‘render’ should be given a broad interpretation in this context.

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Exemplary EDF File Structures (0900)-(1100)

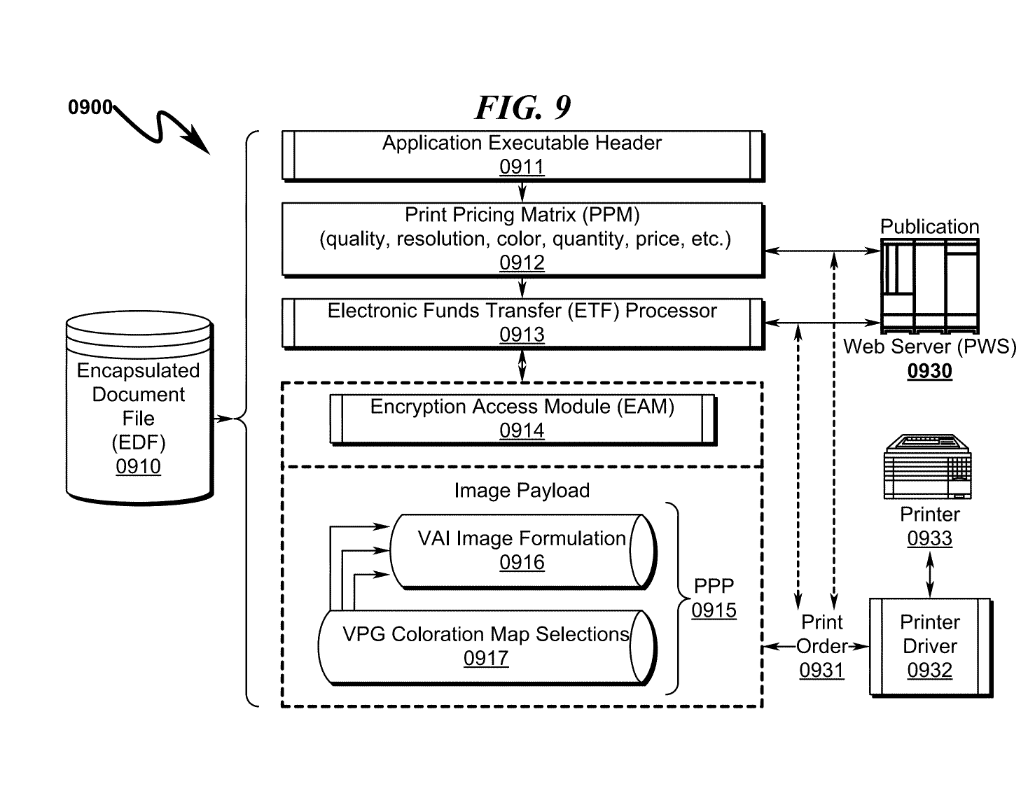

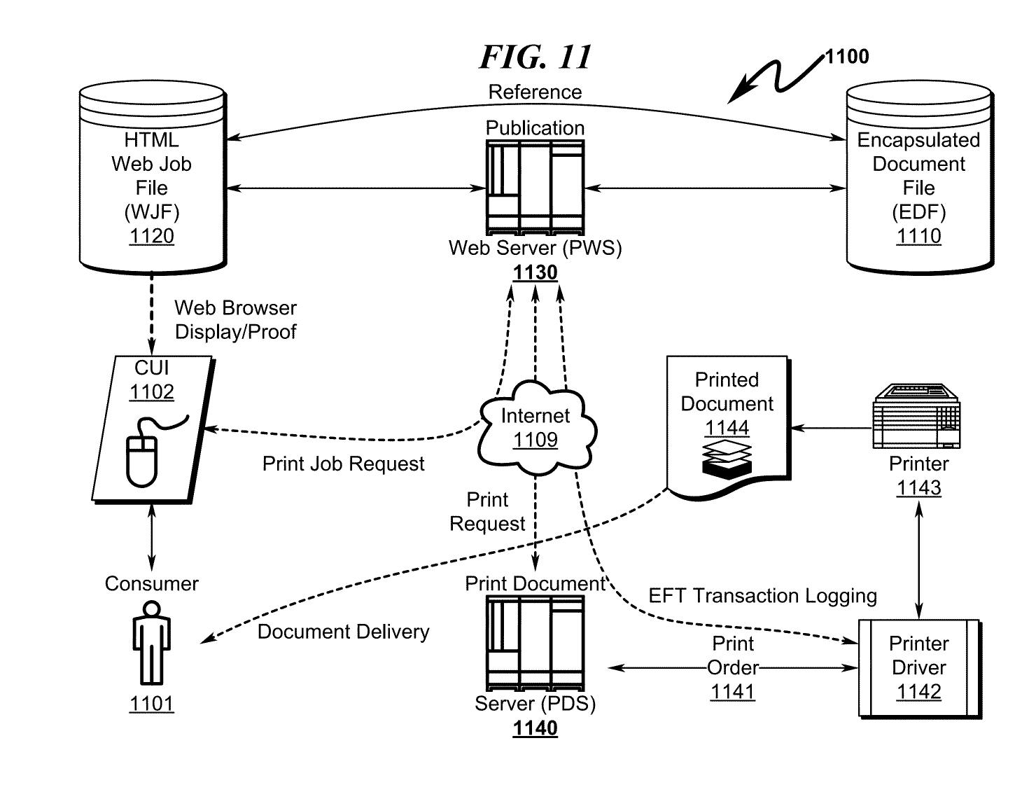

The present invention anticipates a wide variety of file formats for the Encapsulated Document File (EDF) and its delivery to the physical printer, but several exemplary methodologies for implementing this file structure are generally illustrated in FIG. 9 (0900)-FIG. 11 (1100) and discussed below.

### Image Module Format (IMF) (0900)

As generally illustrated in FIG. 9 (0900), the EDF (0910) may be implemented as a single file structure that comprises an application executable header (0911) merged with the print pricing matrix (PPM) (0912), electronic funds transfer (ETF) processing software (0913), an encryption access module (EAM) (0914) to permit access to the image PPP payload (0915) comprising the VAI (0916)/VPG (0917) combinations.

The IMF is designed to be self-contained and suitable for transfer using conventional file transfer/email communications. The application executable header (0911) may be designed to operate under a particular operating system (WINDOWS®, etc.) and incorporate a GUI compatible with the particular operating system. This GUI may be configured to present a fixed print pricing matrix (PPM) (0912) or retrieve this information from a publication web server (PWS) (0930) to permit a variety of printing and pricing options for the consumer to select. Once the particular printing option is selected by the consumer, the electronic funds transfer (ETF) processor (0913) operates to transfer funds from the consumer to the publisher using the PWS (0930) (or another electronic funds processing computer). The ETF processor (0913) may communicate with and/or control the print order (0931) as it is directed to the printer driver (0932) and eventually the physical printing device (0933).

This EDF format may be preferable in situations where the PPP image payload (0915) is relatively small and a self-contained file structure is desired. As indicated in this diagram, the PPM (0912) may be incorporated within the overall EDF image (0910) or may be retrieved from the PWS (0930) based on an encapsulated document identifier (EDI) (a unique identifier associated with the EDF image (0910) such as an image cyclic redundancy code (CRC) or other unique identifier). This information may also be used to index ETF information stored in the PWS (0930) for use in billing the customer for the print order (0931) as it is delivered to the print driver (0932) and/or physical printer (0933). In response to the reception of the EDI by the PWS (0930), the PWS (0930) may respond with an encryption key provided to the encryption access module (EAM) (0914) for use in decrypting the PPP image payload (0915) within the EDF (0910). An alternative to this procedure is to have the encryption key for the PPP image payload (0915) encapsulated within the EDF (0910).

### Compressed Module Format (CMF) (1000)

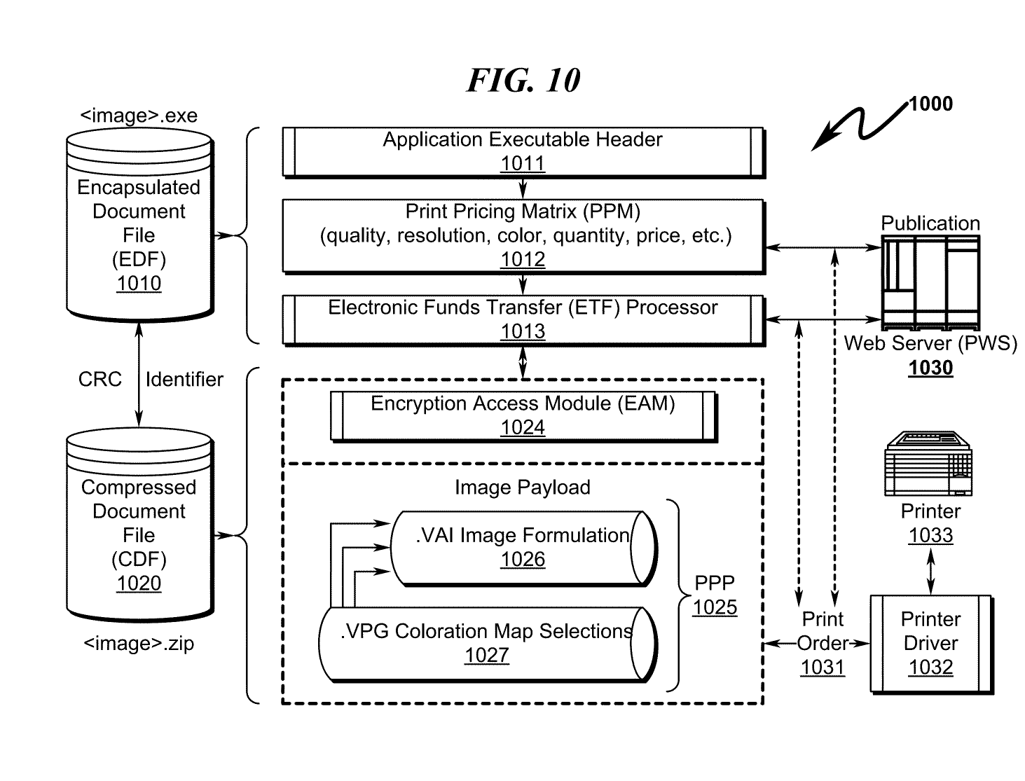

The EDF file architecture of FIG. 9 (0900) may be modified as depicted in FIG. 10 (1000) to incorporate the use of a small executable EDF image (1010) in conjunction with a compressed document file (CDF) (1020) that may be formulated using a conventional file archival format such as ZIP, 7-ZIP, J-ZIP, RAR, TAR, or others well known to those skilled in the art. In this manner the publisher may uniquely package the PPP image payload (1025) using an encryption key tied to a particular customer (and associated print pricing matrix (PPM) (1012)). This allows the EDF image (1010) to retrieve the PPP image payload (1025) by referencing its name and retrieving the appropriate CDF data (1020) using the appropriate file extension (ZIP, etc.). Once opened using the appropriate encryption key received from the PWS (1030), the EAM (1024) permits access to the raw payload data (1025) and transmission of same as the print order (1031) to the printer driver (1032) and eventually the physical printer (1033).

The bifurcation of the EDF (1010) from the CDF (1020) also permits the CDF (1020) to be stored on the PWS (1030) or some other data server and thus need not be directly transmitted to the print publisher. In this situation, the print publisher may utilize an Internet or web access to retrieve instructions to direct the print order (1031) to the printer driver (1032) and the physical printer (1033).

### Hypertext Module Format (HMF) (100)

The EDF file architecture of FIG. 10 (1000) may be modified as depicted in FIG. 11 (1100) to incorporate the use of an EDF file (1110) in conjunction with a hypertext web job file (1120). In this configuration the publication web server (PWS) (1130) may be used to host the EDF (1110) and in doing so generate a web-browser compatible presentation web job file (WJF) file (1120) that when presented on the consumer (1101) user interface (1102) presents a dialog that interacts with software residing on the PWS (1130) to communicate with a selected print document server (1140) to actually generate hardcopy of the data stored in the EDF (1110). The PDS (1140) is responsible for actually processing the print order (1141) to the printer driver (1142) and on to the physical printer (1143). Documents produced from this printing operation are then delivered to the consumer (1101).

What is significant about this architecture variant is that the HTML web job file (WJF) (1120) may be something as simple as a web link to the WJF (1120) hosted on the PWS (1130) or it may be a standalone HTML file that is shipped to the consumer (1101) or generated locally on the consumer computer for display using the consumers user interface web browser (1102). This HTML container file need not incorporate the actual EDF (1110) information, but can reference one or more offline data servers for this purpose.

As with the architecture depicted in FIG. 10 (1000), this WJF (1120) based system minimizes the amount of data that the customer (1101) need be responsible for while still protecting the integrity of the EDF (1110) information as it progresses through the print production process to a final printed document (1144). Furthermore, this methodology leverages the existing display and data entry user interface (1102) present in the consumer (1101) computing device to minimize the impact of changes in operating systems and presentation platforms.

### Exemplary Customer User Print Job Setup Interface (1200)

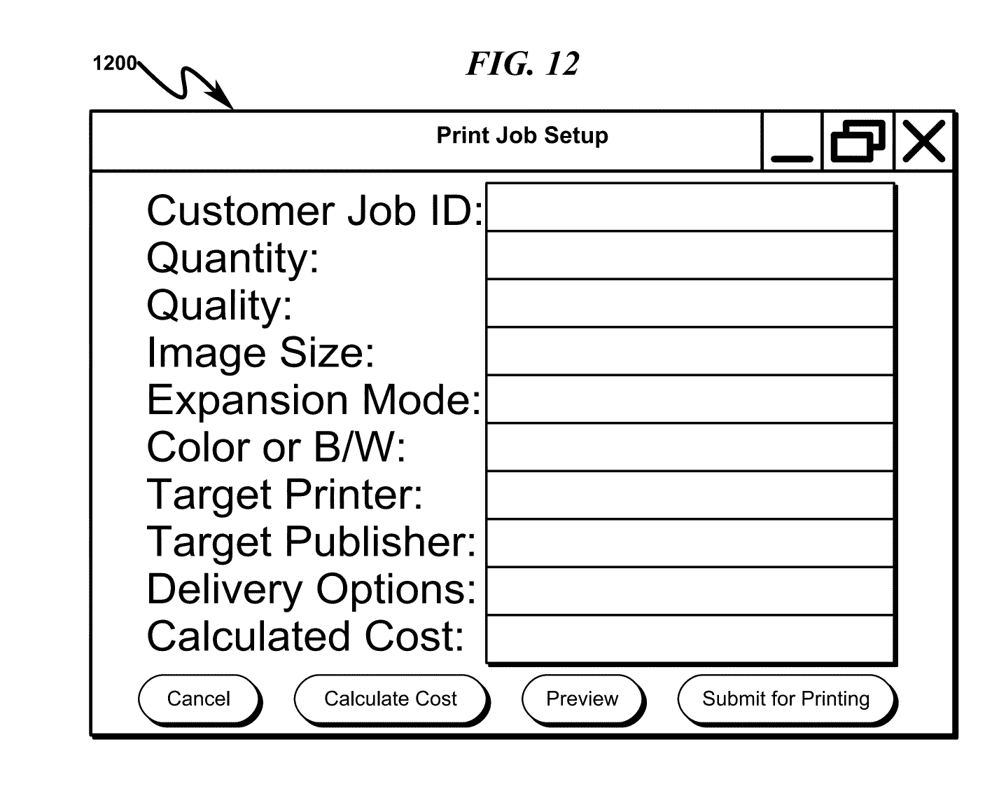

The EDF formats described above may incorporate a wide variety of consumer user interfaces to specify the print job characteristics of a particular PPP document. One exemplary print setup request dialog is generally illustrated in FIG. 12 (1200) and incorporates the following fields:
Customer Job ID: This user-defined field specifies the customer job ID for the print job being defined.
Quantity: This field defines the number of copies for the print job.
Quality: This field defines the print quality for the print job. Note that different cost structures can be defined for draft vs. high quality prints.
Image Size: This field defines the size of the printed image.
Expansion Mode: This field defines the type of image expansion that may occur when increasing the size of a particular image to fit the desired image size. A variety of publisher-proprietary algorithms may be specified in this field.
Color or B/W: This field defines whether the image is to be printed in black-and-white, color, or some limited range of colors.
Target Printer: This field defines the target printer by specific printer identifier or by generic type of printer.
Target Publisher: This field defines the target publisher for the document as in which publishing house will generate the printer output.
Delivery Options: This field defines the delivery options for the production print to the consumer.
Calculated Cost: This field is calculated and displays the consumer cost for the print job.

One skilled in the art will recognize that this list is exemplary and may be added to or reduced based on the particular invention application context.

### Exemplary 3D Printer Application (1300)-(1600)

The present invention may be embodied in some preferred embodiments that incorporate the capability of 3D printing. Several preferred embodiment are anticipated to support this 3D printing context and are described below.

Printing from Part/Product Database (1300)

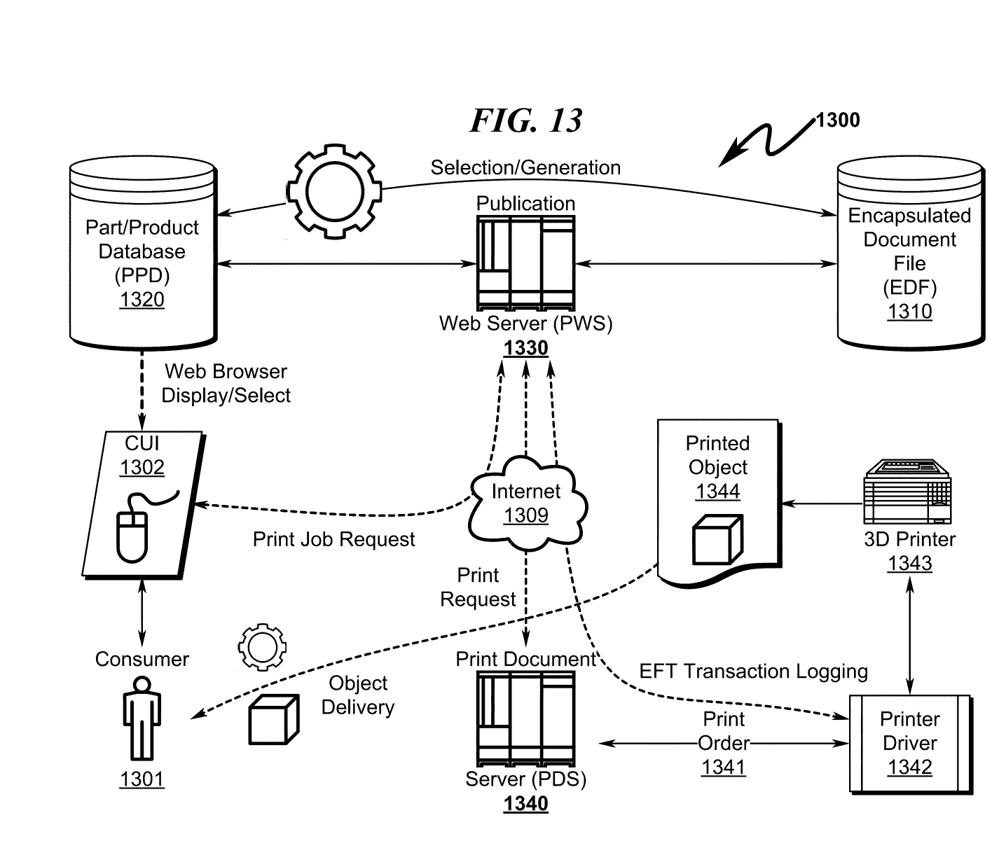

As generally illustrated in FIG. 13 (1300), an exemplary configuration in this application generates the EDF (1310) from selections from a part/product database (1320) that may be populated by a manufacturer or other source of original/replacement parts/products. The system operates as detailed before (using one or more of the various EDF (1310) methodologies described that may permit selection of the printing profile and other generation characteristics to have the part/product trigger a print order (1341) that drives (1342) a 3D printer (1343) to generate the 3D printed object (1344). While the actual location of the 3D printer (1343) may vary based on application context, it is anticipated that the 3D printer (1343) may be local to the customer (1301) to permit rapid access to the part/product being printed. This could be a printer owned by the customer (1301) or a printer that is within a given locale easily accessible by the customer (1301). Thus, rather than shipping a part to the customer (1301), the customer may opt to have the part created locally using a 3D printing process.

### Manufacturer CAD File Distribution (1400)

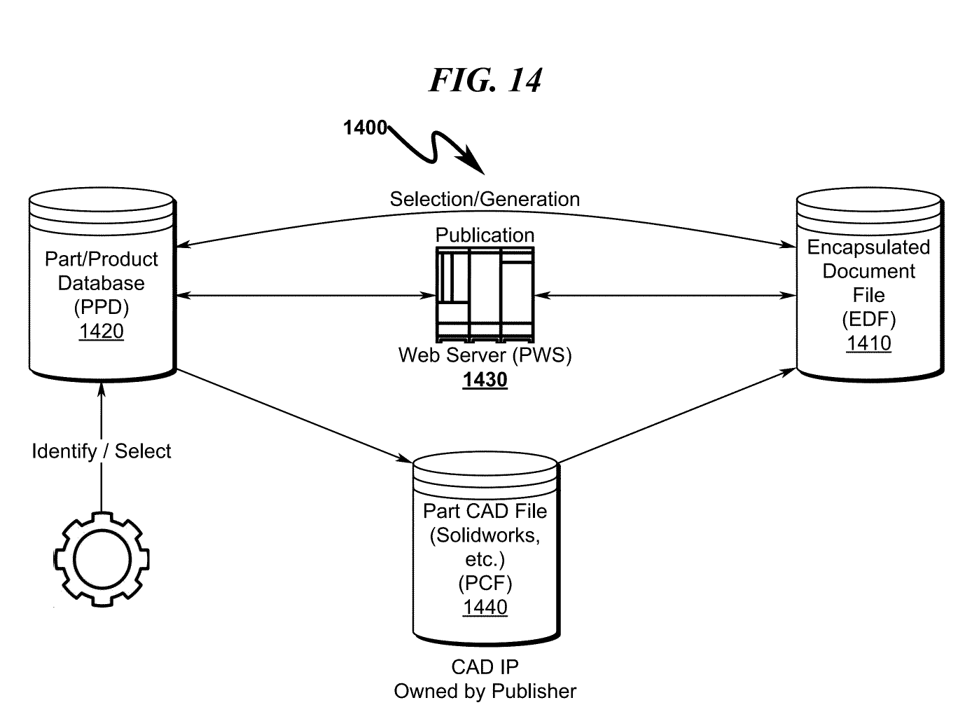

As generally illustrated in FIG. 14 (1400), within this context the EDF file (1410) may be generated in a variety of ways. As generally illustrated in FIG. 14 (1400), this EDF file (1410) may be generated directly in response to a part/product database lookup (1420) that points to a CAD file (1440) database containing complete 3D models for a given part/product that is to be reproduced for the customer. As with other options for printing described herein, the part/product publisher who has IP rights in the 3D model designs may determine the price/part and other types of pricing to be associated with the reproduction of the given part within the context of the overall printing system.

### Part Replacement Using 3D Scanning (1500)

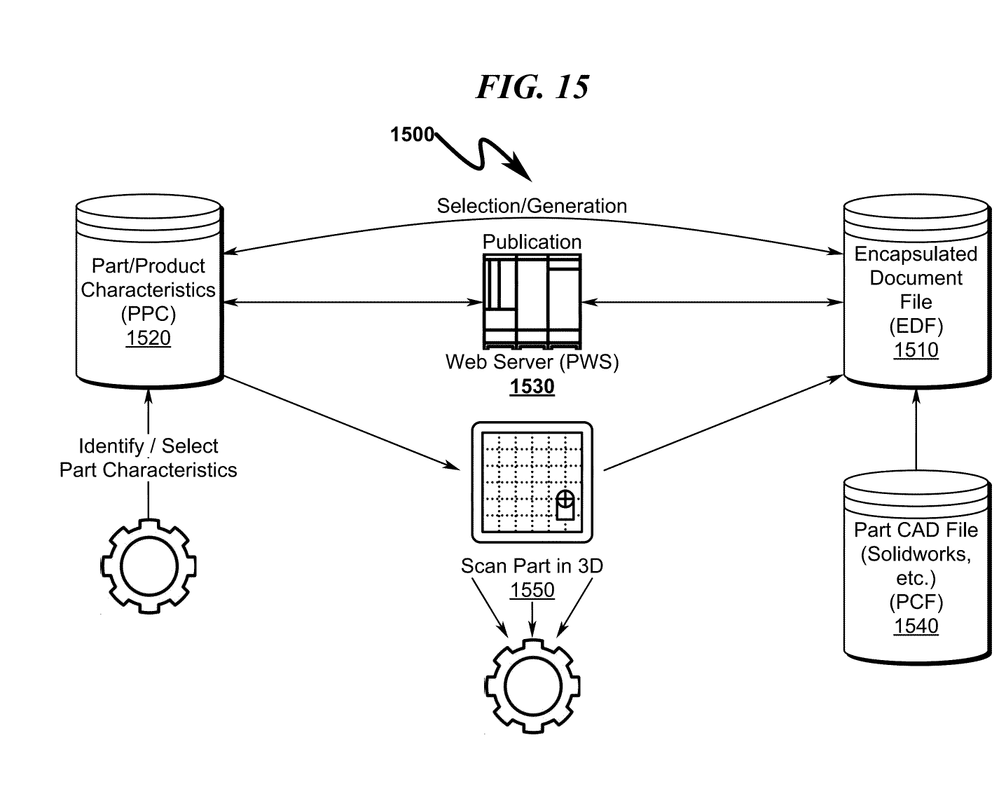

As generally described in FIG. 15 (1500), the system of FIG. 14 (1400) may be augmented with a 3D scanner (1550) that permits an arbitrary part/product to be scanned and reproduced using information retrieved from the part/product characteristics (PPC) (1520) database. The customer in this instance may not know part/product identifier, but may be able to identify the manufacturer. A scan of the part/product may then be used to not only identify the specific part/product, but also determine the correct CAD file (whether constructed or taken from a known database) for which to generate the required EDF (1510). In some circumstances the 3D scan (1550) of the part/product may be sufficient to generate a replacement part/product without the need for the part/product characteristics (PPC) (1520) database. In many of these circumstances a “repair shop” comprising a 3D scanner (1550) may be established in local communities to act as a local supplier of parts that are generated from either direct scans of a defective part and also as a target for CAD files retrieved from specific manufacturers.

### Original Part/Product Distribution (1600)

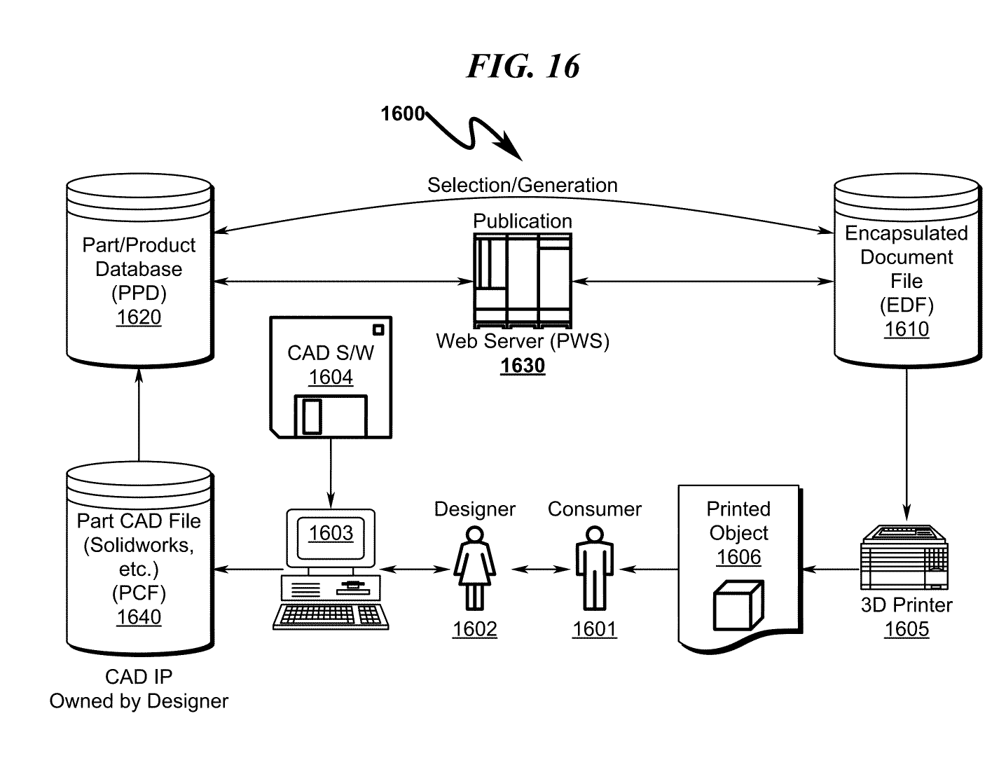

FIG. 16 (1600) illustrates an anticipated scenario in which a customer (1601) may interact with a designer (1602) to generate a custom 3D image using a computer (1603) running any number of CAD tools (SOLIDWORKS®, AUTOCAD®, TURBOCAD®, etc.) (1604). In this scenario the designer (1602) creates a CAD file (1640) that is then processed by the PWS (1630) and placed in a database (1620) for generation of an EDF (1610) that can be used to generate the custom part/product using a 3D printer (1605) with the resulting 3D part/product (1606) being delivered to the customer (1601).

This configuration permits custom parts/products to be created by designers (1602) who have control over the distribution/reproduction of the parts/products. This permits a revenue stream to be managed by the designer (1602) by controlling reproduction of the custom part/product and ensuring that NRE costs are appropriately recovered from the customer (1601).

### Print Distribution Rights Management

In all of these scenarios the ability to regulate the number of “prints” of the 3D object using the EDF data structures and associated methods described herein provides a method by which owners of intellectual property (IP) may generate revenue for their IP as it is produced. This is akin to situations where the author of a book receives royalties for every sale of a printed copy of the book. While the system/method described herein may provide for the unlimited reproduction of a 3D object, the reproduction controls contained within the Print Pricing Matrix (PPM) may limit the number of prints available to a given customer, or may set different pricing levels based on the number of prints that are generated (or have been generated by that customer or by all customers in total). This enables, for example, a sculptor to offer his/her work for sale on a limited basis for high quality reproduction but also permit low quality versions of the work to be sold in much higher volume. Similarly, a photographer or artist may wish that high quality versions of their work only be generated in large format, whereas low-quality versions can only be generated in smaller formats or on particular types of print stock.

### Exemplary Custom Printing Application (1700)

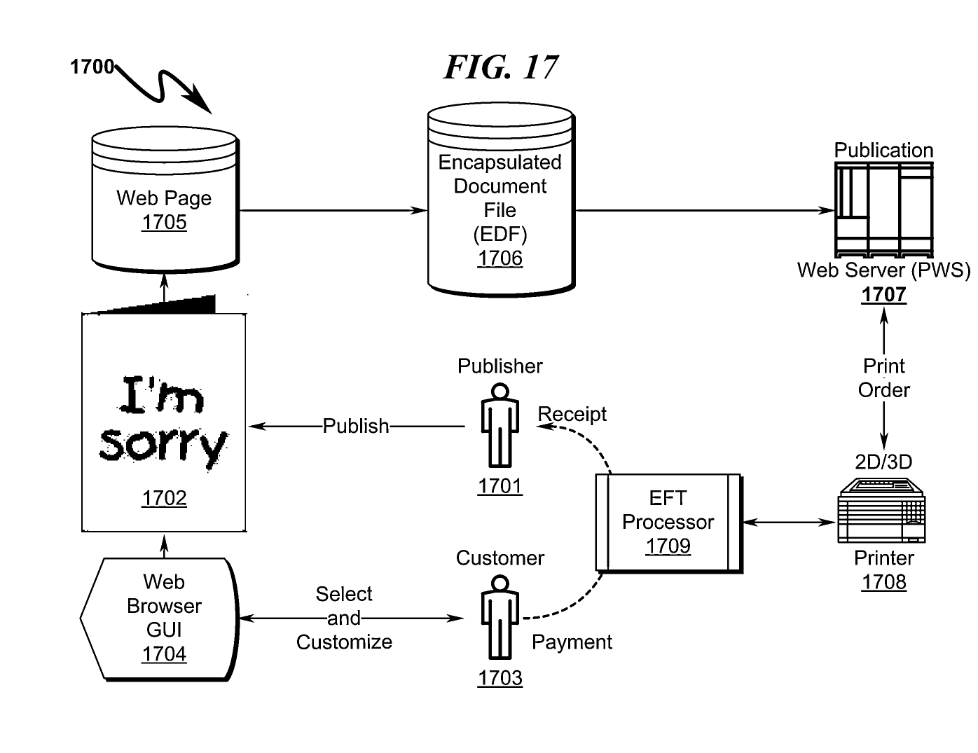

As generally depicted in FIG. 17 (1700), one anticipated application for the present invention is in the area of custom printing applications in which a publisher (1701) publishes a number of stock documents (greeting cards, brochures, etc.) (1702) each having associated VAI and VPG associated characteristics. In this application scenario, the customer (1703) interacts with a web browser GUI (1704) to render various PPP combinations of VAI+VPG selections within a web page (1705). Once a desired rendering of the artwork (1702) is selected, it can then be associated with an EDF file (1706) (whether embedded within or referenced by the EDF (1706) and then presented to a publication web server (PWS) (1707) or some other printer server that services the print request to a 2D or 3D printer (1708). Print renderings of the PPP information within the EDF (1706) are then rendered on the printer (1707) under control of the EFT processor (1709) that remits payment from the customer (1703) to the publisher (1701) for each print rendering.

A significant benefit of this application context is that the artwork (1702) may be customized in both 2D and 3D contexts. Thus, it would be permissible in this application to generate customized 3D greeting cards and the like. The customization may include text and graphics as well as VAI/VPG combinations selected by the publisher (1701) to be visually appealing. This capability permits the printer (1708) to be located anywhere and the greeting card in this example to be mailed directly from the printer complete with both 2D and 3D customization. Similar examples could be applied to contexts in which customized books are published and directed towards a particular individual (such as with penned inscriptions inside the cover or the addition of relief artwork on the cover or within the book pages). Yet another application of this technology is to the generation of relief printing on custom artwork such as with comic books and the like.

The ETF processor (1709) in this configuration works with information in the EDF (1706) to ensure that the intellectual property (IP) rights of the publisher (1701) are respected in that each printing of the artwork (1702) to the printer (1708) results in a payment remittance from the customer (1703) to the publisher (1701). Thus, the document (1702), while customized, remains the intellectual property (IP) of the publisher (1701), as it represents a derivative work of the original VAI+VPG combination

### Unique Serialized Renderings (1800)

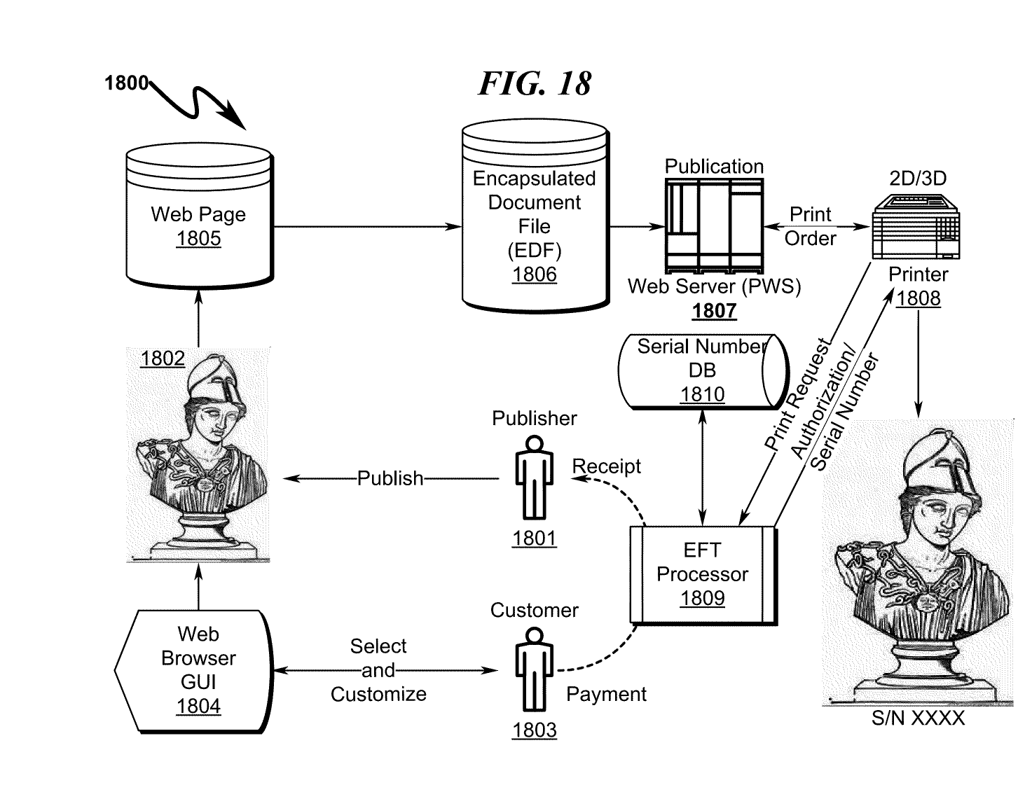

In some anticipated applications of the present invention as generally depicted in FIG. 18 (1800), the capability to generate unique serialized renderings may be included within the printing process to ensure that each printed product has a unique serial number. This might be useful in situations where the provenance of the generated work is to be identified or in situations where a limited number of prints is authorized. Since the present invention anticipates not only 2D but 3D printing, this feature can have particular application not only to graphic image printing but also the generation of three dimensional structures having unique identifiers (artwork, etc.), serialized parts (as in medical implants), and the like.

As generally depicted in FIG. 18 (1800), the EFT processor (1809) can be configured in this situation to interact with a serial number database (1810) that keeps track of the current number of print renderings and informs the print processor (1808) of the number of prints that have been produced (and potentially the number of authorized prints). This information is then used to generate the particular rendering (if authorized) and inscribe the rendering with a unique serial number.

This printing methodology allows the cost of a given rendering to be different depending on the number of print renderings that have been produced. For example, early renderings of a given piece of art might be relatively inexpensive, with the cost for subsequent renderings rising exponentially as demand increases. While the example depicted in FIG. 18 (1800) illustrates this technique applied to sculpture, it can equally be applied to the printing of books, comic books, greeting cards, postcards, and other like printed matter.

### Custom Greeting Cards (1900)

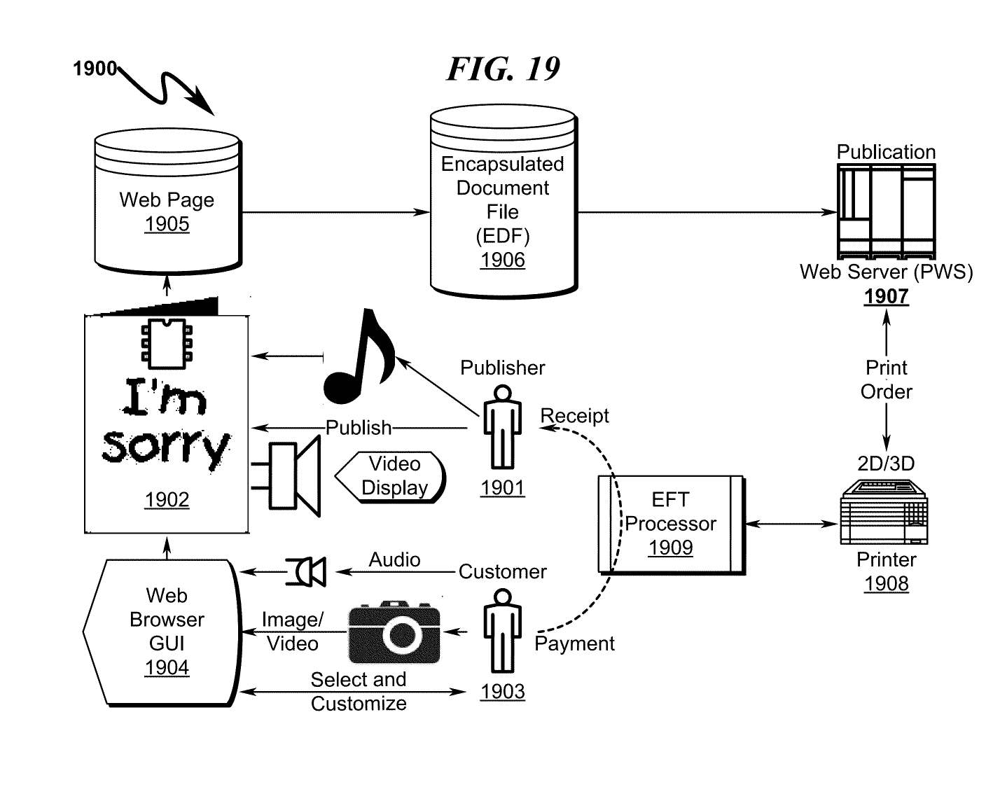

The application context associated with custom greeting cards has been briefly discussed and depicted generally in FIG. 17 (1700). This application context may be expanded in some preferred embodiments via the use of custom audio/image/video information that is provided by the customer and integrated with stock audio/sound provided by the publisher as generally depicted in FIG. 19 (1900).

In this configuration, the artwork (1902) comprises a greeting card configured with an audio processor chip that has memory capable of programming by the publisher (1901) with stock songs and the like. This information may be ‘mixed’ with additional audio input from the consumer (1903) and then used to generate a custom audio/song combination that is then integrated with other custom print/relief features on the greeting card (1902). This configuration permits the publisher (1901) to retain control of the music and/or audio that is integrated with the customer's input. Additionally, this configuration permits licensing of a wide variety of music and other audio to the publisher (1902) for use in this application. Thus, the configuration shown may incorporate multiple publishers (1901) that have IP that may be contributed to the generation of a custom greeting card (1902) as selected by the customer (1903).

As depicted in FIG. 19 (1900), the present invention anticipates that in some invention embodiments the greeting card may incorporate audio/image/video presentation hardware and associated memory supporting same so that the publisher (1901) and/or customer (1903) may embed more than audio on the greeting card (1902). This image information may be obtained from custom configurations provided by the publisher (1901) or customer (1903) or may be pulled from stock image/video data supplied by either party or a third party provider.

### Photograph Print Distribution (2000)

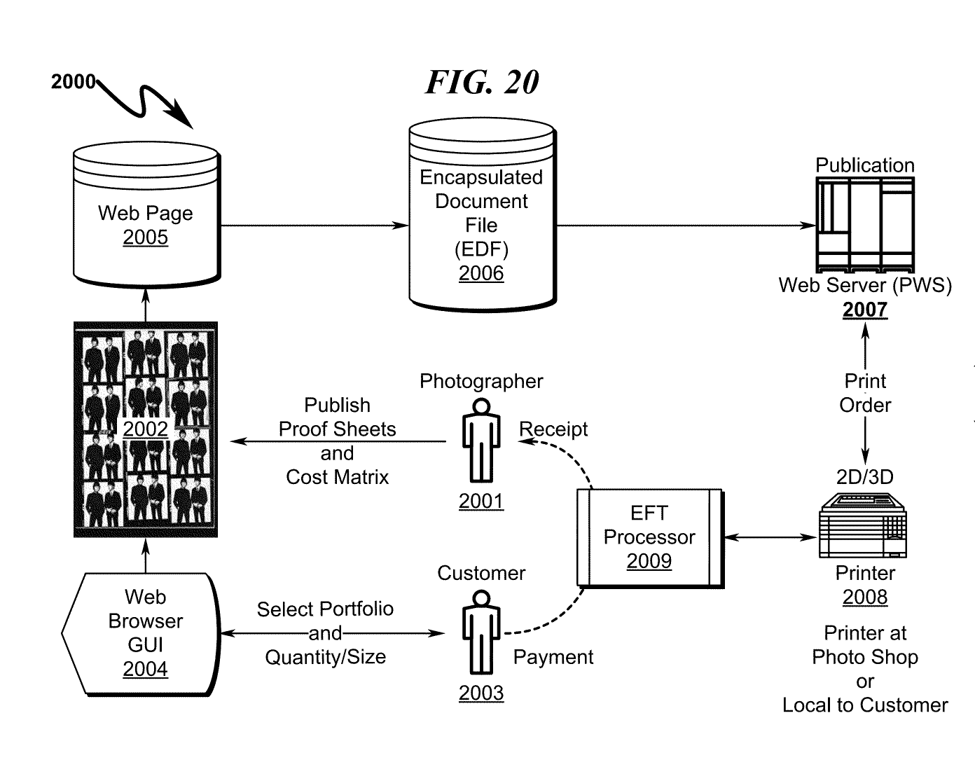

An anticipated application for some preferred invention embodiments is in the area of photograph print distribution. As generally illustrated in FIG. 20 (2000), in this context a photographer (2001) may wish to publish a proof sheet (2002) containing photographs (from a photo shoot, wedding, etc.) and allow a customer (2003) to select various photograph combinations, packaged sets, combination of sizes, etc. using a web browser GUI (2004). These selections are rendered on a web page (2005) and packaged into EDF data (2006) for later processing by a print server (2007) and rendering on a printer (2008).

The advantage of this system is that the photographer (2001) need not have printing capability for the resulting photos to be printed and delivered to the customer (2003), and in some circumstances the proof sheet can be directly printed on printers owned by the customer (2003). Additionally, spatially diverse customers (2003) may have access to the photos for selection/viewing and then be charged as needed for printing of individual photographs. The system as depicted can also incorporate additional EFT functionality to charge for visual access to the photographs and limit access to the photographs to authorized individuals.

In this manner, a photographer (2001) need not have direct access to large-form printers (2008) in order to service clients in this capacity, and the use of remote photo shop printers becomes a practical possibility for the photographer (2001) without the fear that the photo image data will be replicated/rendered without their permission. It is anticipated that in some of these embodiments the photographer (2001) may interact with the PWS (2007) to ensure that proper color calibration is maintained on the printer (2008) for the purposes of maintaining the quality of the proof/production prints (2002) generated by the printer (2008).

### Exemplary Glyph Mappings (2100)-(2400)

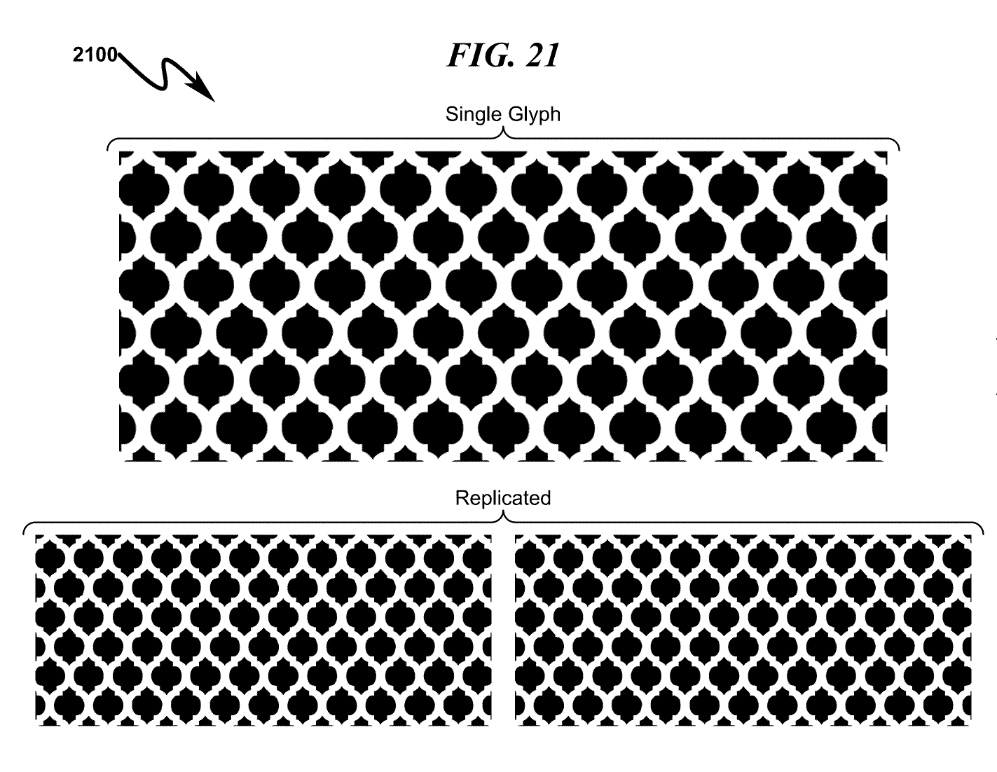

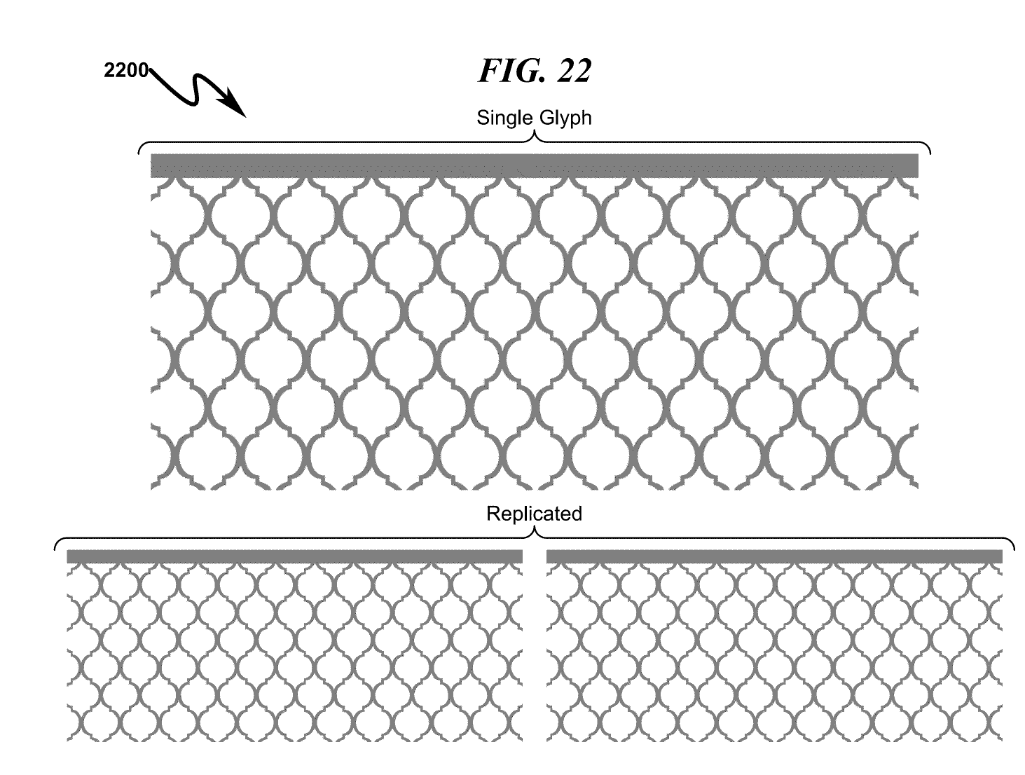

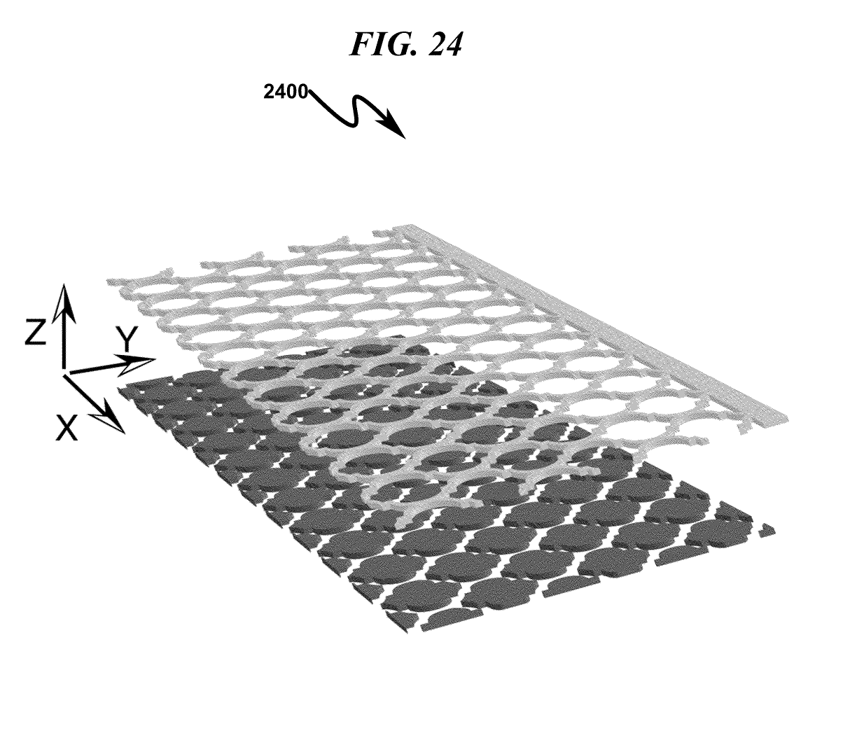

It may be instructive to see visual examples of the use of font-based glyph structures in practice as provided in FIG. 21 (2100)-FIG. 24 (2400). FIG. 21 (2100) represents a first glyph structure that is normally constructed having a character width (offset) such that multiple selections of the font character will be placed in horizontally adjacent positions as indicated. A similar situation is presented in FIG. 22 (2200) where a second glyph structure is illustrated.

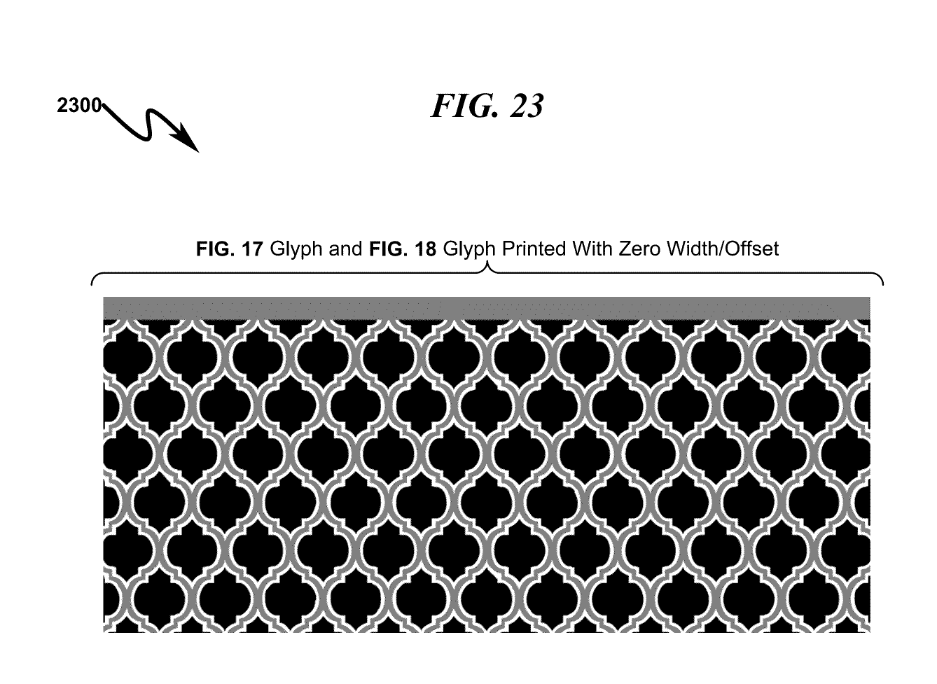

However, when the glyph structures of FIG. 21 (2100) and FIG. 22 (2200) are combined with zero character width (offset) characteristics, they overlap as indicated in FIG. 23 (2300) to produce a composite image. This effect is illustrated in the perspective view of FIG. 24 (2400) indicating that the glyphs are “stacked” in the Z-direction and as such the ORDER in which the font characters are displayed has an impact on the resulting image produced. Note that while the offset associated with the glyphs has been set to zero in these examples, there are anticipated situations in which the offset may be non-zero to achieve special effects such as shadowing or to provide a three-dimensional effect to the resulting composite image.

### Illustrative Process Flow (2500)-(3200)

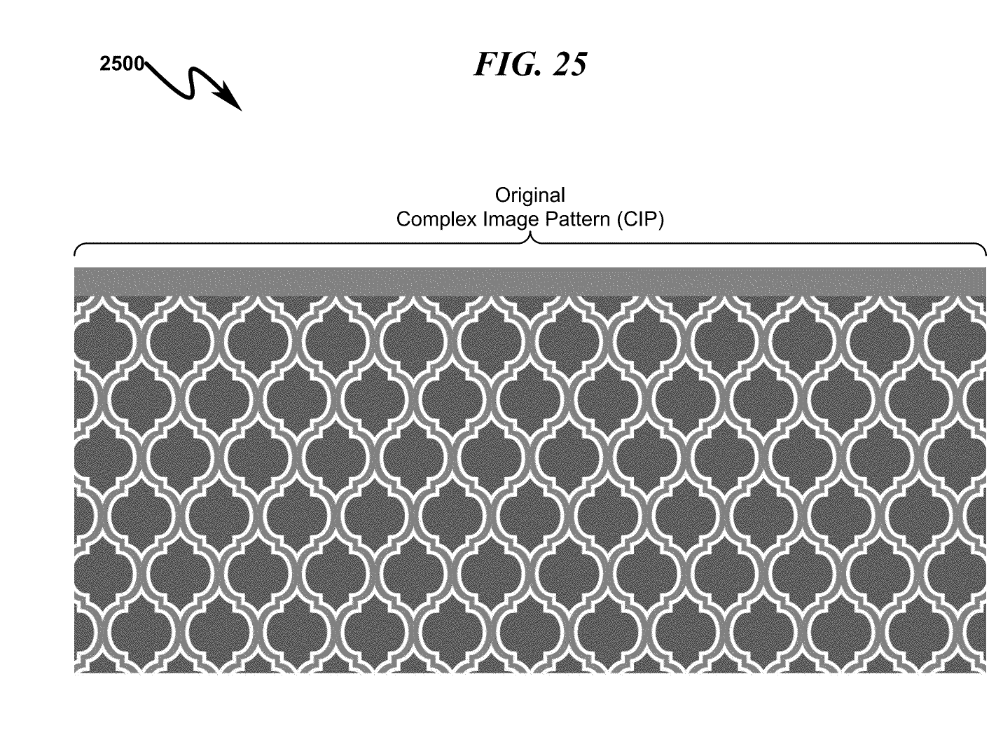

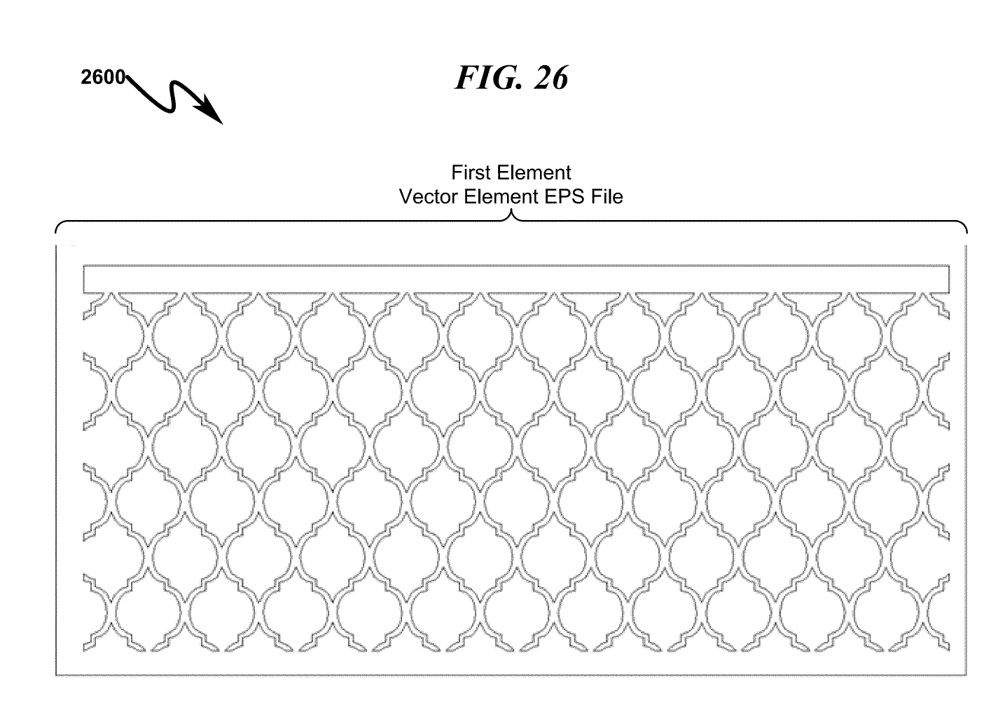

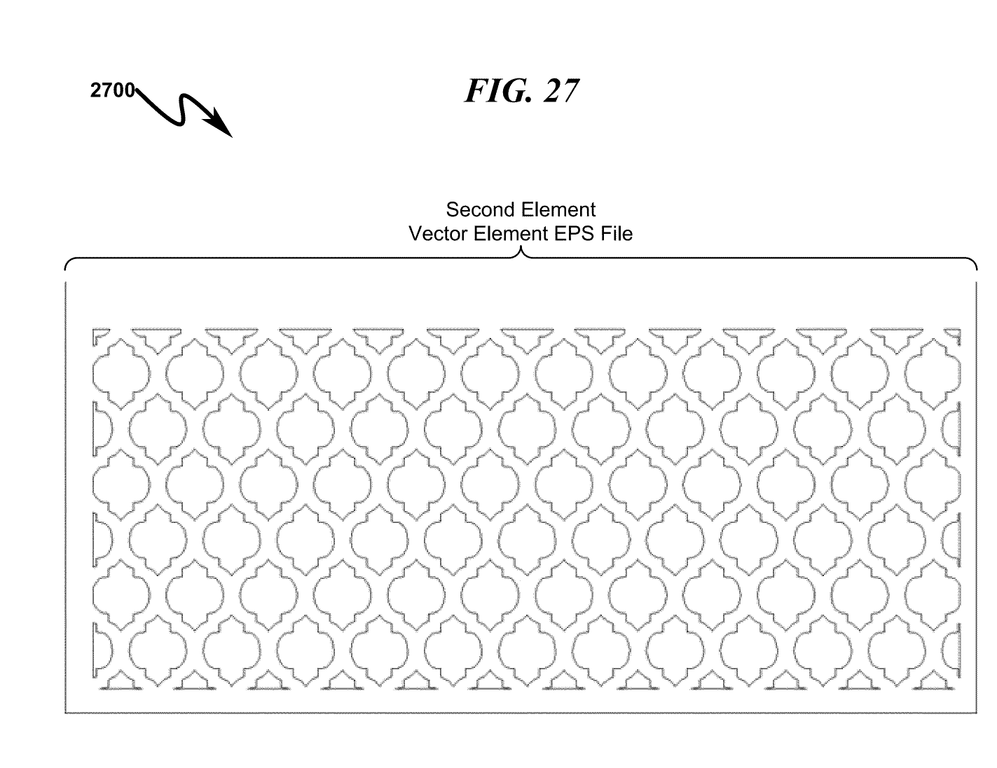

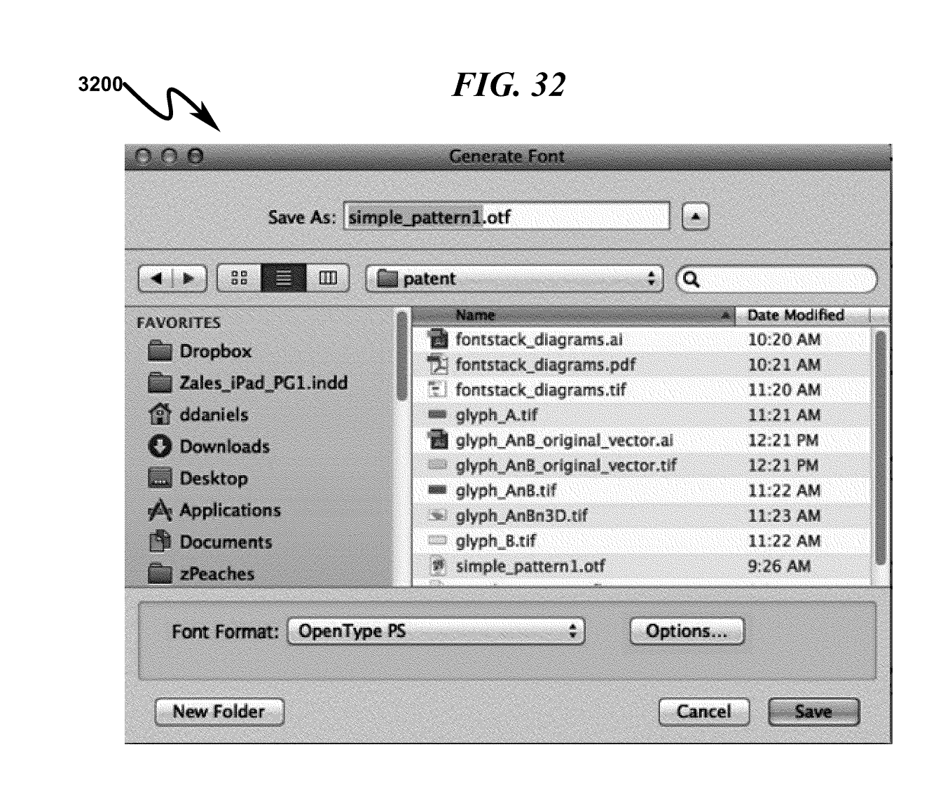

As an aid in understanding the data transformations that may occur in a typical application of the invention system/method, a visual depiction of an exemplary CIP transformation to web fonts is depicted in FIG. 25 (2500)-FIG. 32 (3200). FIG. 25 (2500) depicts original CIP data that may have associated with it various colors and other display attributes for each of the graphical entities depicted. This CIP data (2500) may originate as image data or vector data and is then transformed into each of its vector elements as EPS files in this example as depicted in FIG. 26 (2600) and FIG. 27 (2700) respectively. While two vector elements are illustrated here, the present invention anticipates that any number of vector elements may be generated depending on the particular CIP data processed.

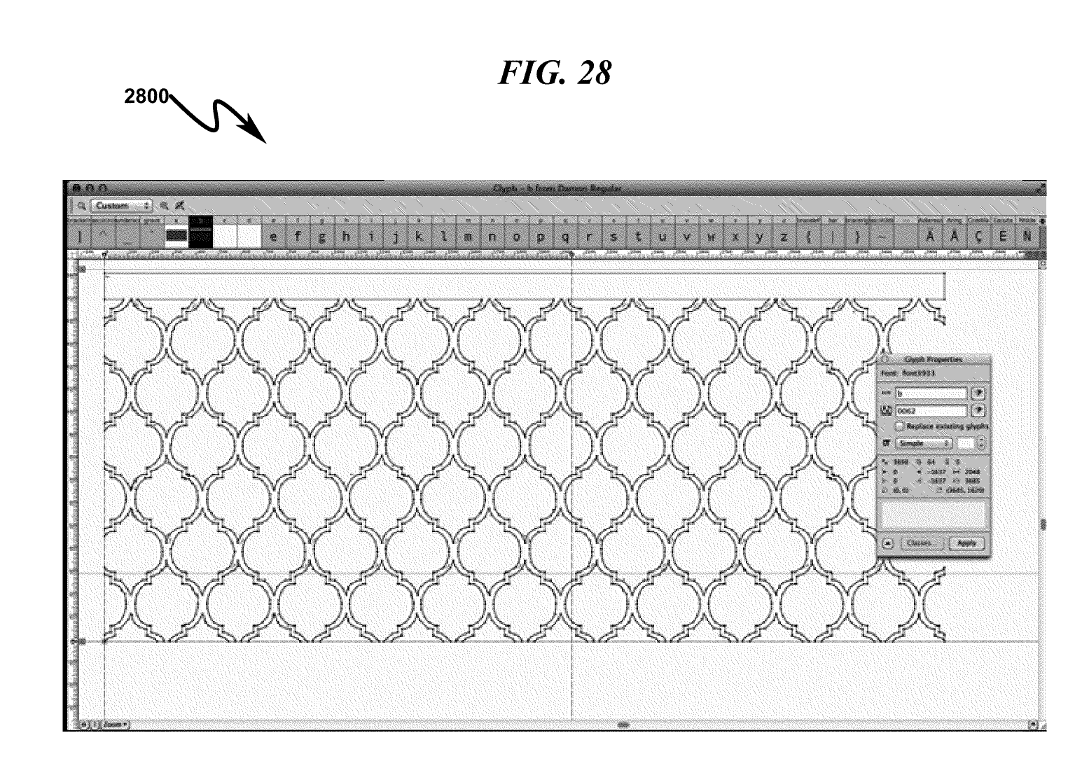

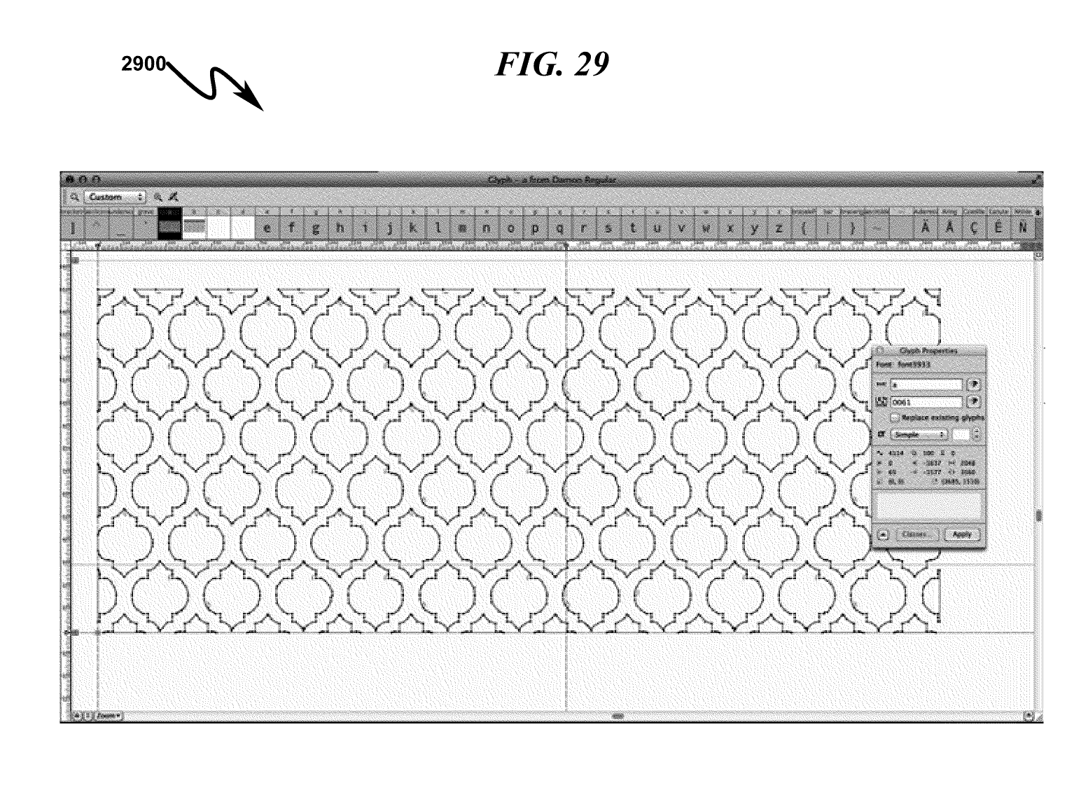

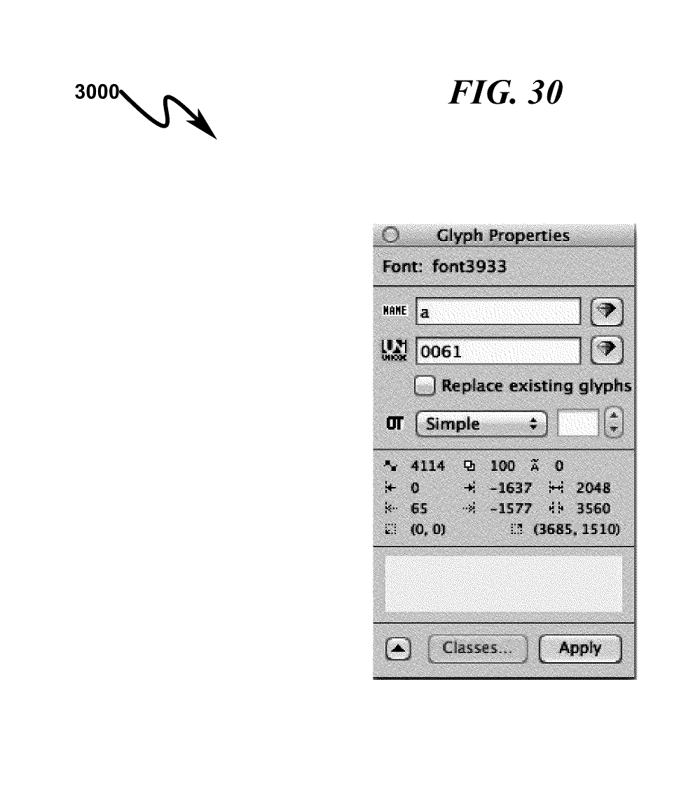

In this example each of the EPS vector elements depicted in FIG. 26 (2600) and FIG. 27 (2700) is individually loaded into a font editor as a glyph and assigned to a particular character within the font editor as generally depicted in FIG. 28 (2800) and FIG. 29 (2900) respectively. An expanded view of the font editor dialog making this assignment is generally illustrated in FIG. 30 (3000). While this mapping is shown in this example as being manually performed using a font editor, the system/method described herein may optimally perform this mapping automatically without human intervention.

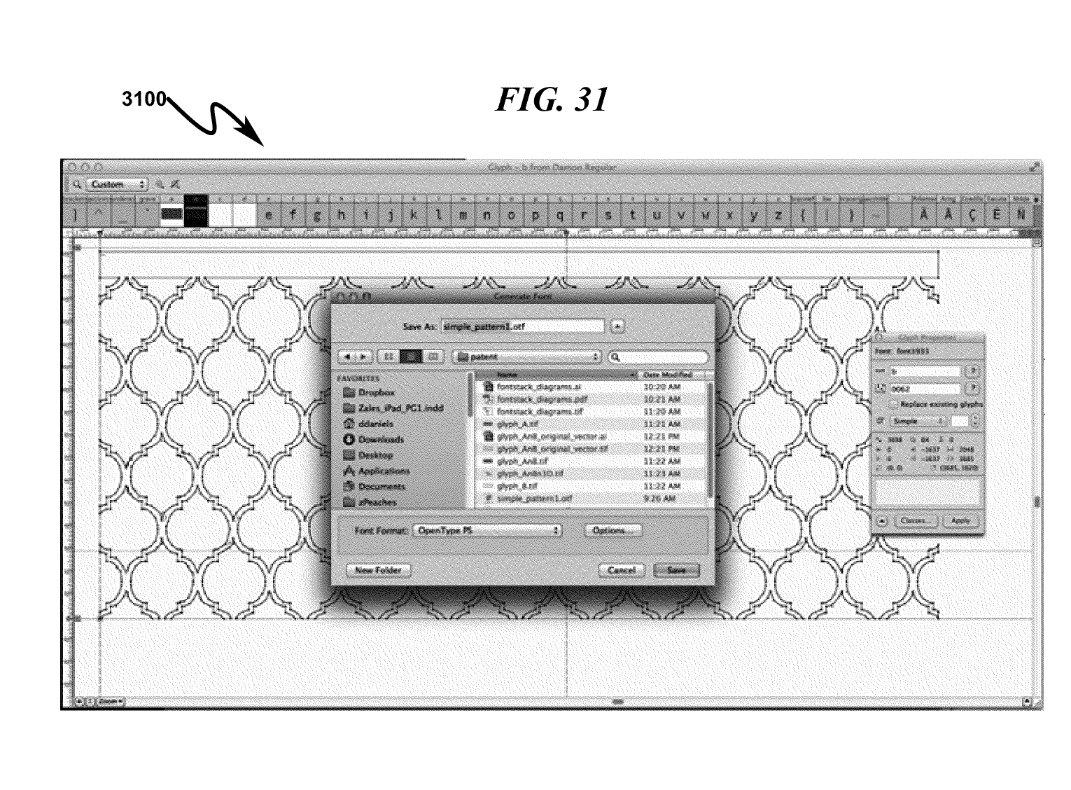

Once the individual font glyphs have been associated with respective font characters, the font is then saved as depicted in FIG. 31 (3100) in one of several standard font formats that can then be embedded within a web page for viewing by a user via the use of a standard web browser. An expanded view of the font editor font saving options dialog is generally depicted in FIG. 32 (3200). While this operation is generally depicted as manual in FIG. 31 (3100)-FIG. 32 (3200), it is anticipated that optimal embodiments of the present invention will save these resulting fonts without human intervention and be capable of embedding these fonts within web pages as a substitute for the use of manually generated image variations associated with the CIP.

### Exemplary HTML Content Generation

### Test Image (3300)-(4000)

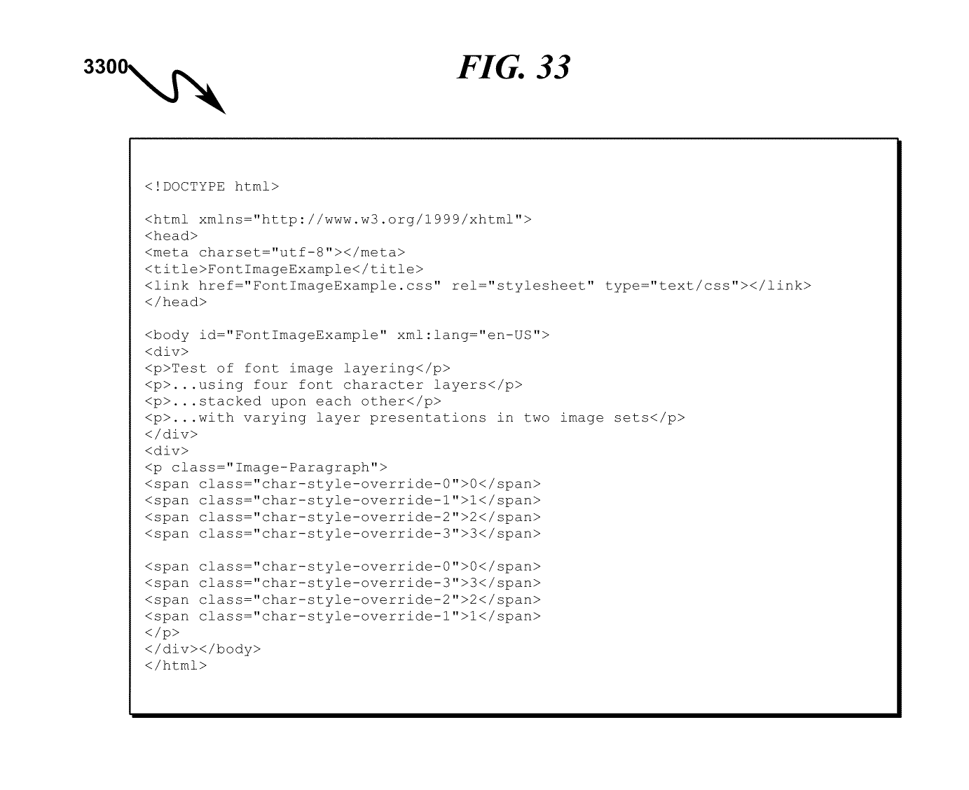

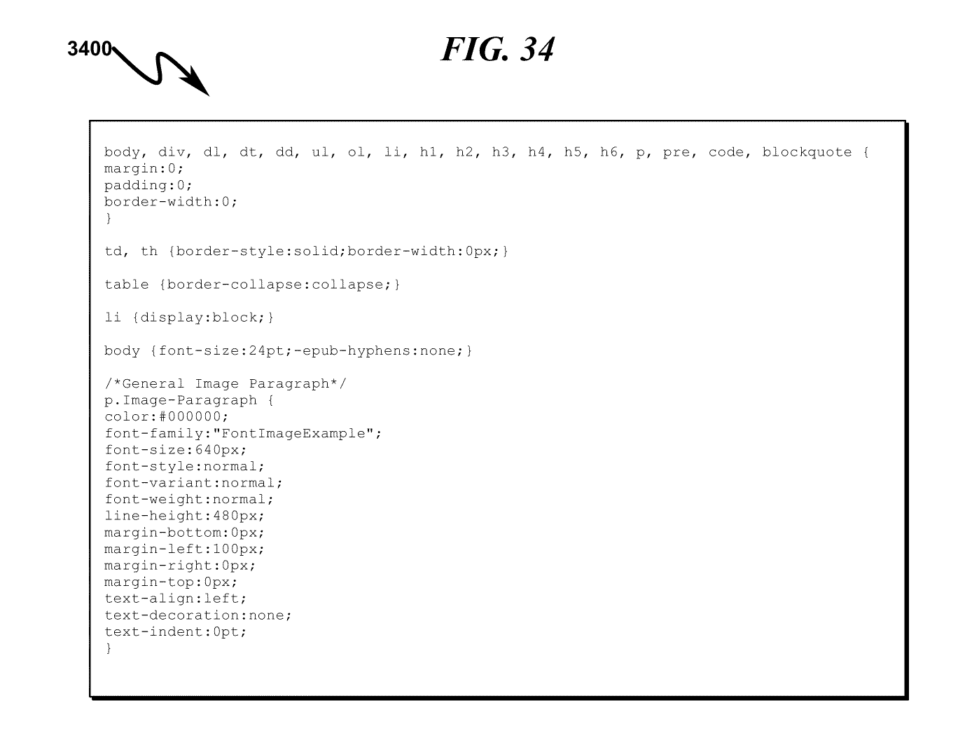

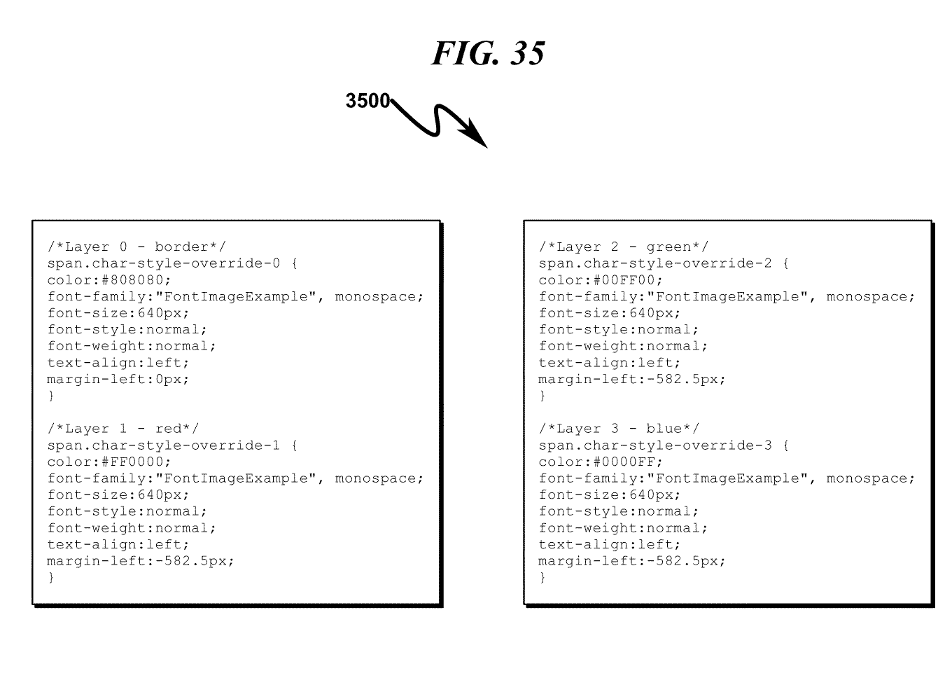

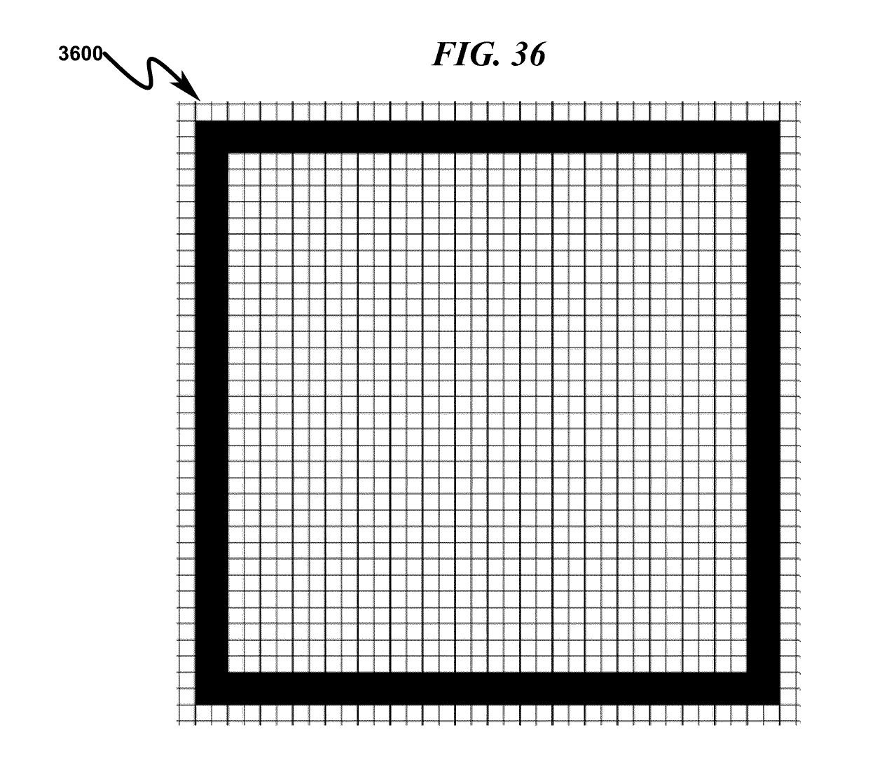

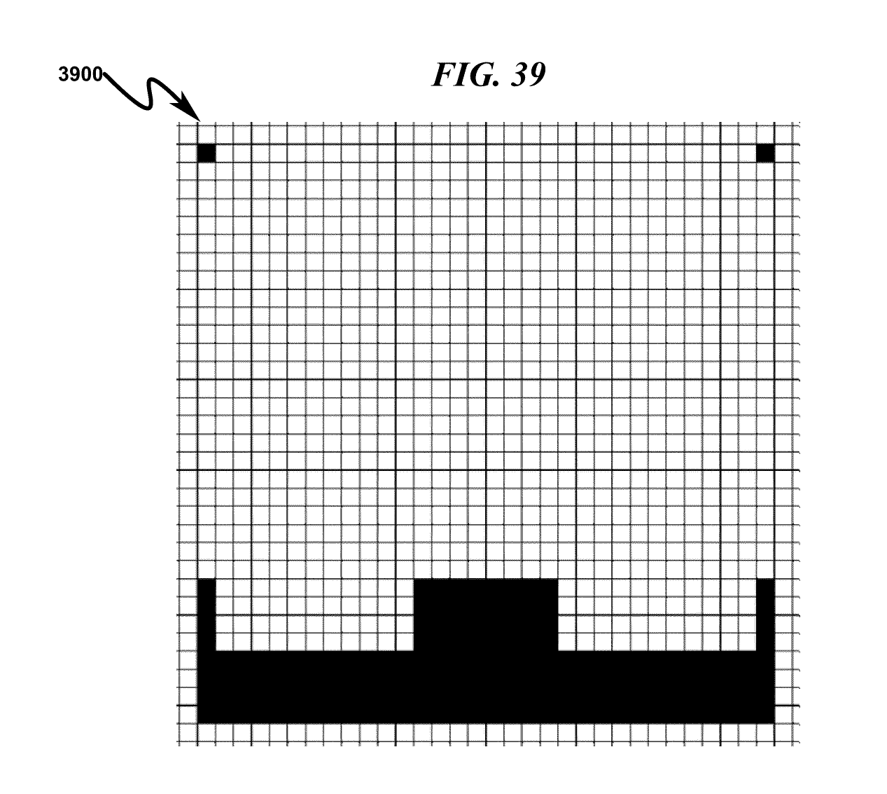

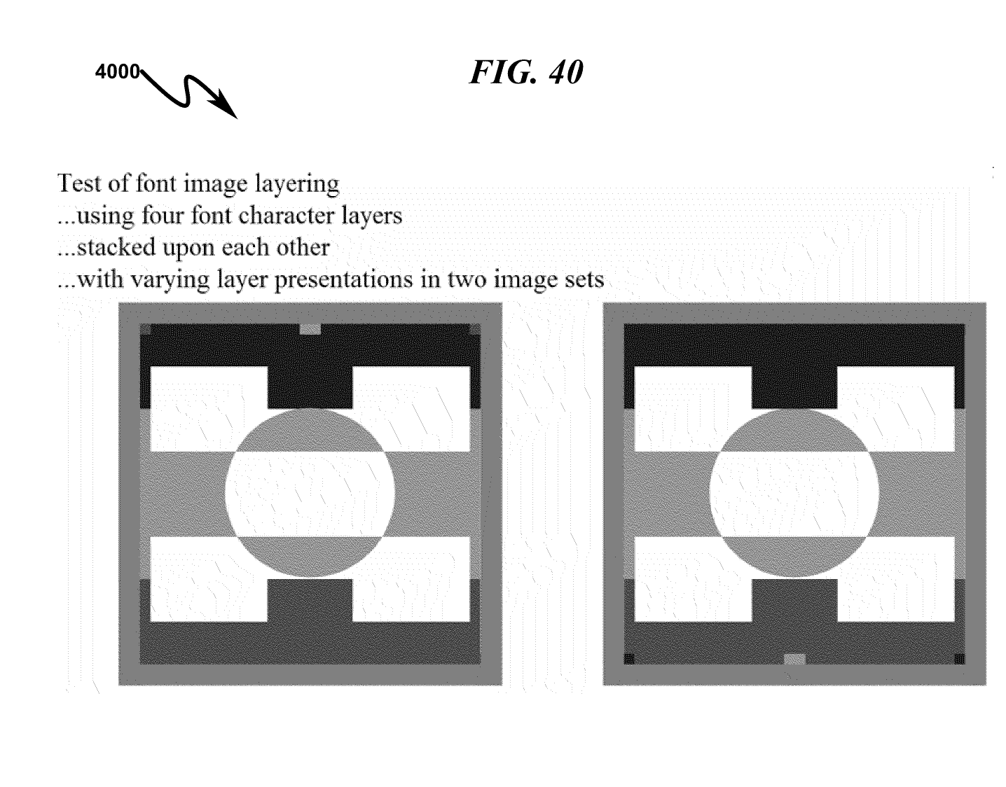

An example of the present invention as applied to a typical HTML browser context is illustrated in FIG. 33 (3300)-FIG. 40 (4000), in which a typical rendering HTML file (FIG. 33 (3300)) is used in conjunction with cascading style sheet (CSS) data (FIG. 34 (3400)-FIG. 35 (3500)) to render the font characters “0”, “1”, “2”, and “3” that have been defined by the font editor as depicted in FIG. 36 (3600)-FIG. 39 (3900) respectively to be associated with a BORDER and LAYER 1, LAYER 2, and LAYER 3 of the image to be displayed. Each character (“0”, “1”, “2”, and “3”) may be rendered with a different color as depicted in the HTML and CSS data depicted in FIG. 33 (3300)-FIG. 35 (3500). The rendered output from the HTML in FIG. 33 (3300) is depicted in FIG. 40 (4000).

It should be noted that the font editor images of FIG. 36 (3600)-FIG. 39 (3900) are exemplary images taken from a font editor/generator utility and may be generated using any number of automated means from raw image data as discussed herein. Once the font file (typically a True Type Font (TTF) file format) is generated, it may be installed for use in the operating system by a number of utilities or via the use of HTML scripts as defined by the application context. One skilled in the art will no doubt be capable of achieving this task given the TTF font file generated by the present invention.

This example illustrates a feature of the present invention in that the two images rendered in FIG. 40 (4000) are slightly different because the LAYERS are rendered in different order. This ordered difference may mask certain features of a given layer or provide a different visual appearance of the resulting rendered font-based image. This feature can be seen by inspecting the fiducial marks provided at the corners of the rendered image and comparing these to the font editor image data presented in FIG. 36 (3600)-FIG. 39 (3900).

It should be noted that the example presented in FIG. 33 (3300)-FIG. 40 (4000) represents a test image that is relatively simple in construction and generated in this case to clearly illustrate the layered nature of the image rendering process using the font-based structure defined by the present invention.

### Exemplary HTML Content Generation

### Picture (4100)-(4800)

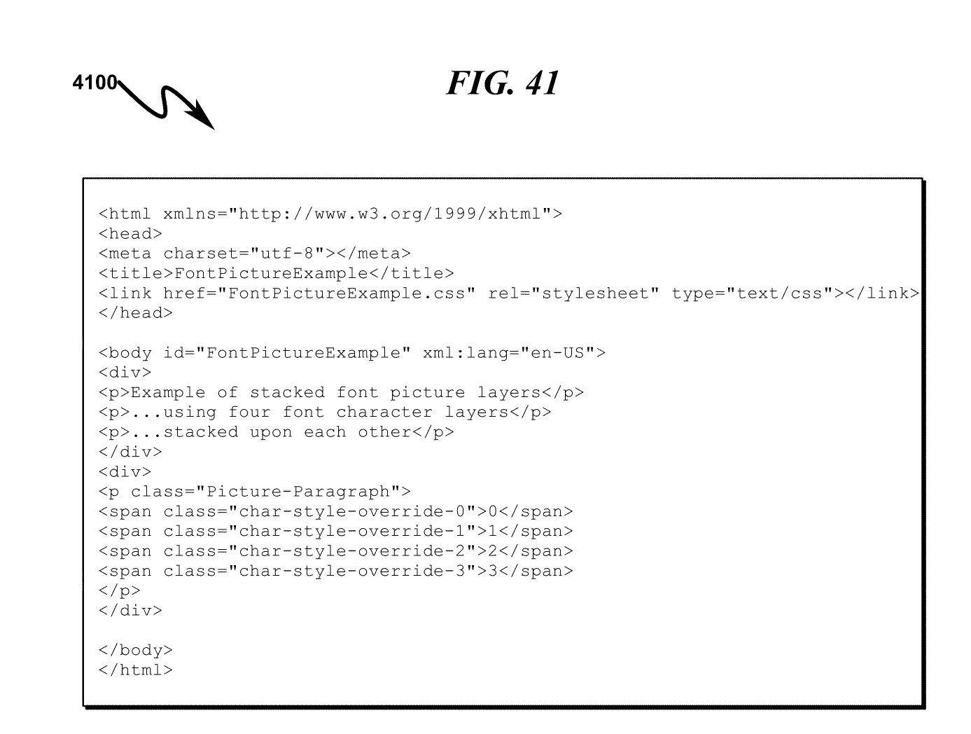

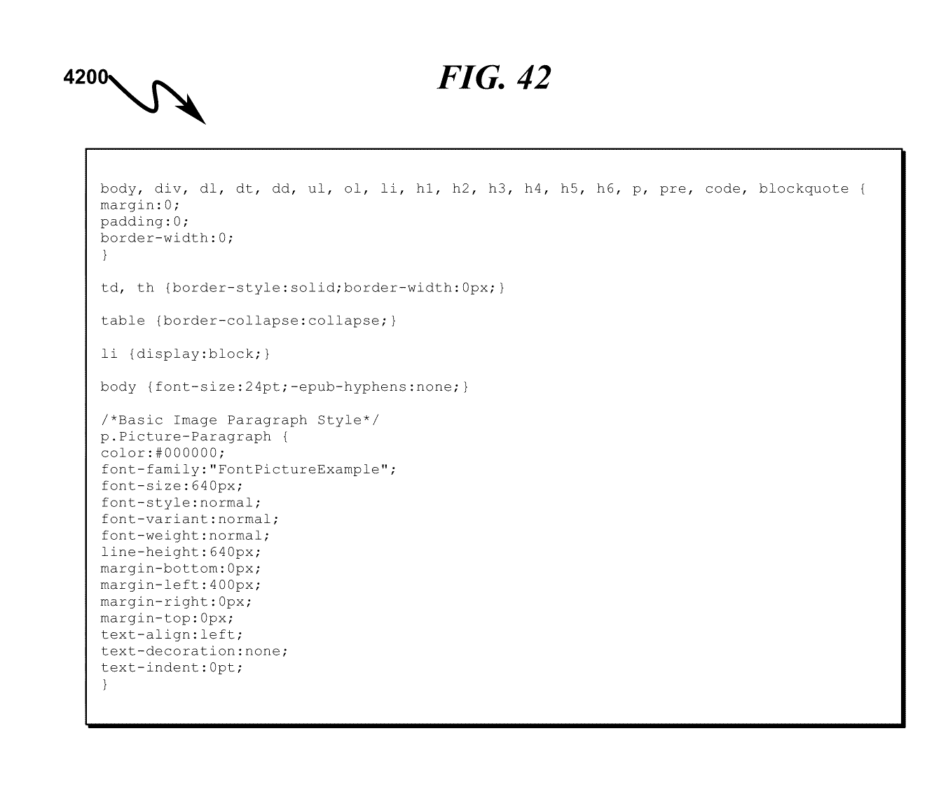

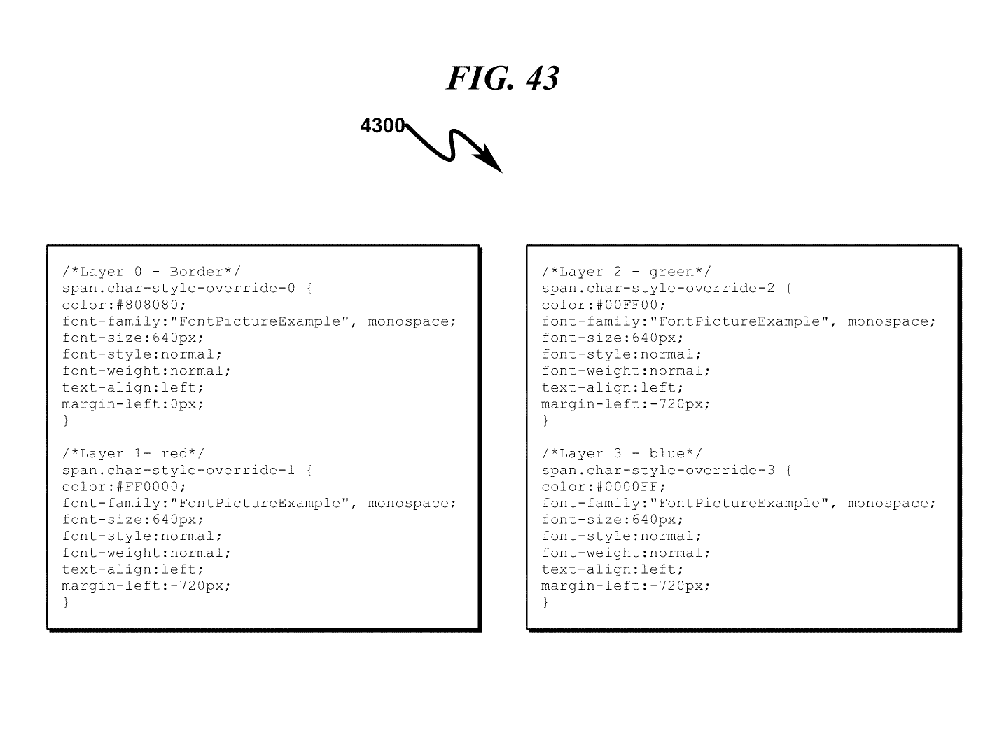

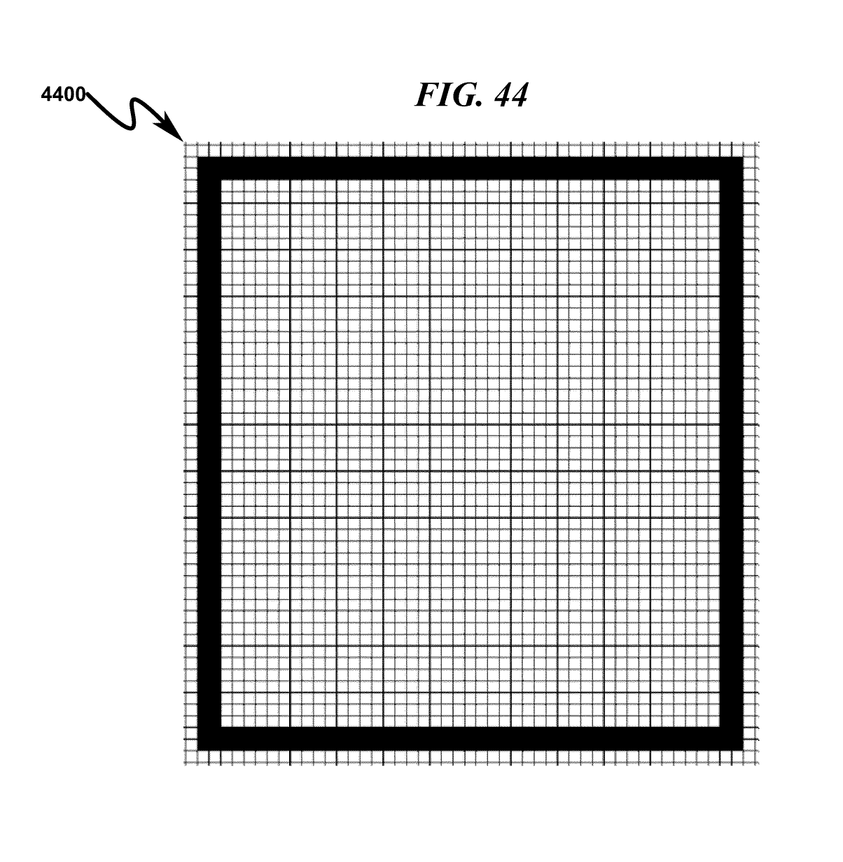

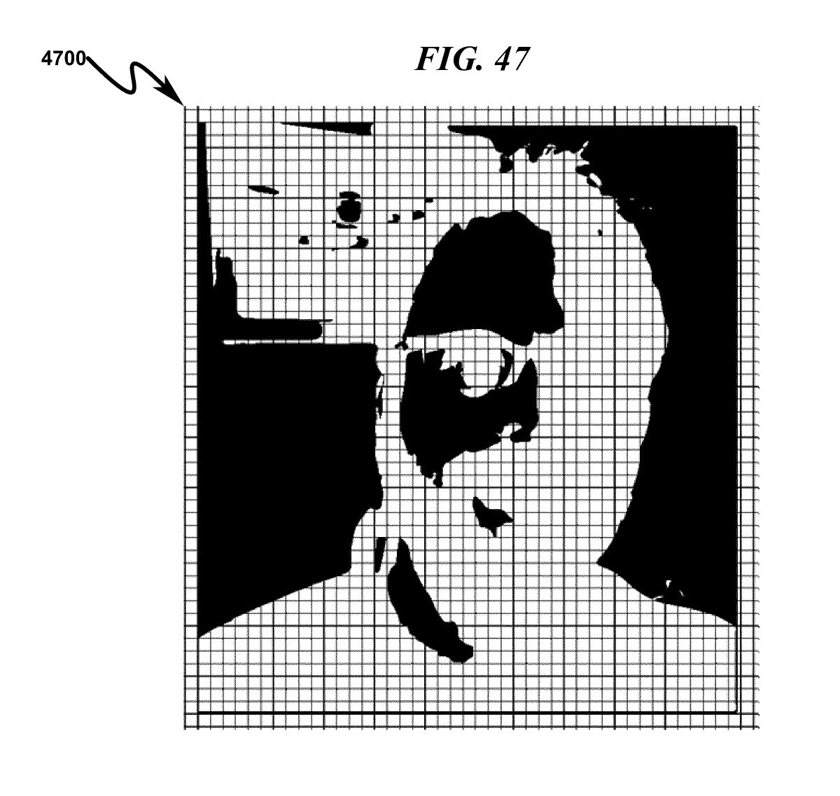

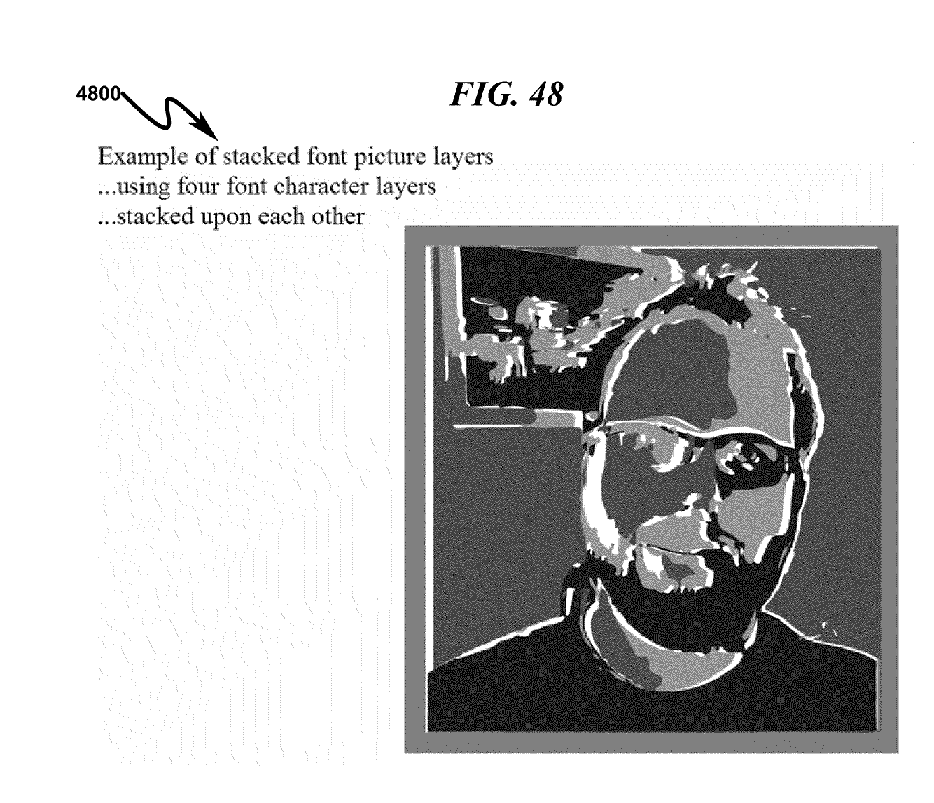

Another example of the present invention as applied to a typical HTML browser context is illustrated in FIG. 41 (4100)-FIG. 48 (4800), in which a typical rendering HTML file (FIG. 41 (4100)) is used in conjunction with cascading style sheet (CSS) data (FIG. 42 (4200)-FIG. 43 (4300)) to render the font characters “0”, “1”, “2”, and “3” that have been defined by the font editor as depicted in FIG. 44 (4400)-FIG. 47 (4700) respectively to be associated with a BORDER and LAYER 1, LAYER 2, and LAYER 3 of the image to be displayed. Each character (“0”, “1”, “2”, and “3”) may be rendered with a different color as depicted in the HTML and CSS data depicted in FIG. 41 (4100)-FIG. 43 (4300). The rendered output from the HTML in FIG. 41 (4100) is depicted in FIG. 48 (4800). Image layer offsets have been artificially introduced in this rendering to enhance the boundaries between various layers in the rendered image and illustrate the combination of various layers to form a composite image.

It should be noted that the font editor images of FIG. 44 (4400)-FIG. 47 (4700) are exemplary images taken from a font editor/generator utility and may be generated using any number of automated means from raw image data as discussed herein. Once the font file (typically a True Type Font (TTF) file format) is generated, it may be installed for use in the operating system by a number of utilities or via the use of HTML scripts as defined by the application context. One skilled in the art will no doubt be capable of achieving this task given the TTF font file generated by the present invention.

### Exemplary HTML Content Generation

### Portrait (4900)-(5600)

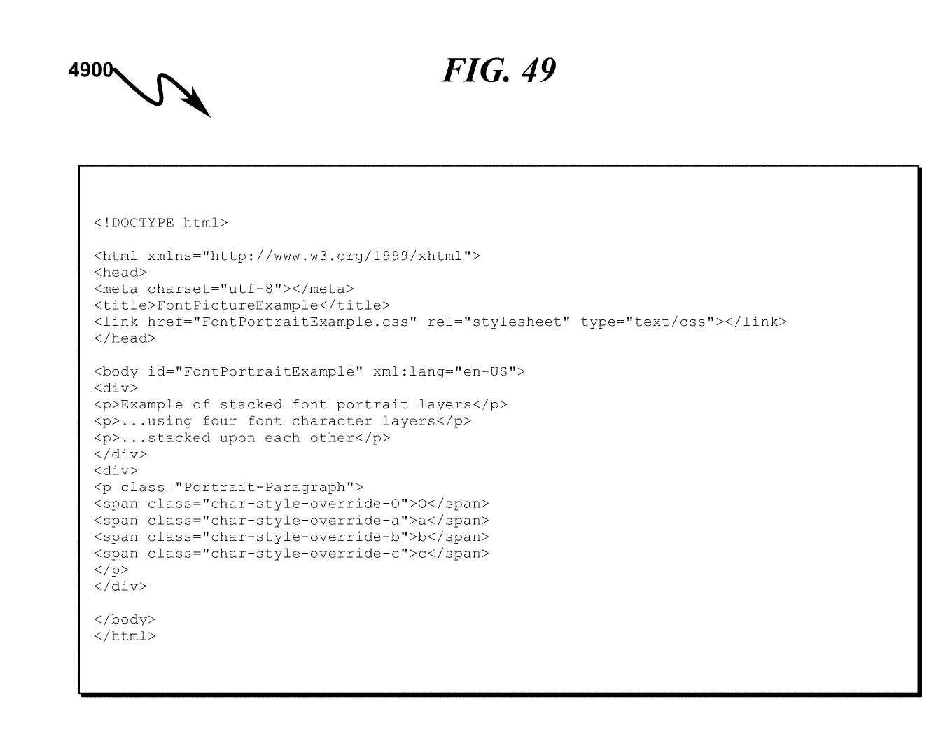

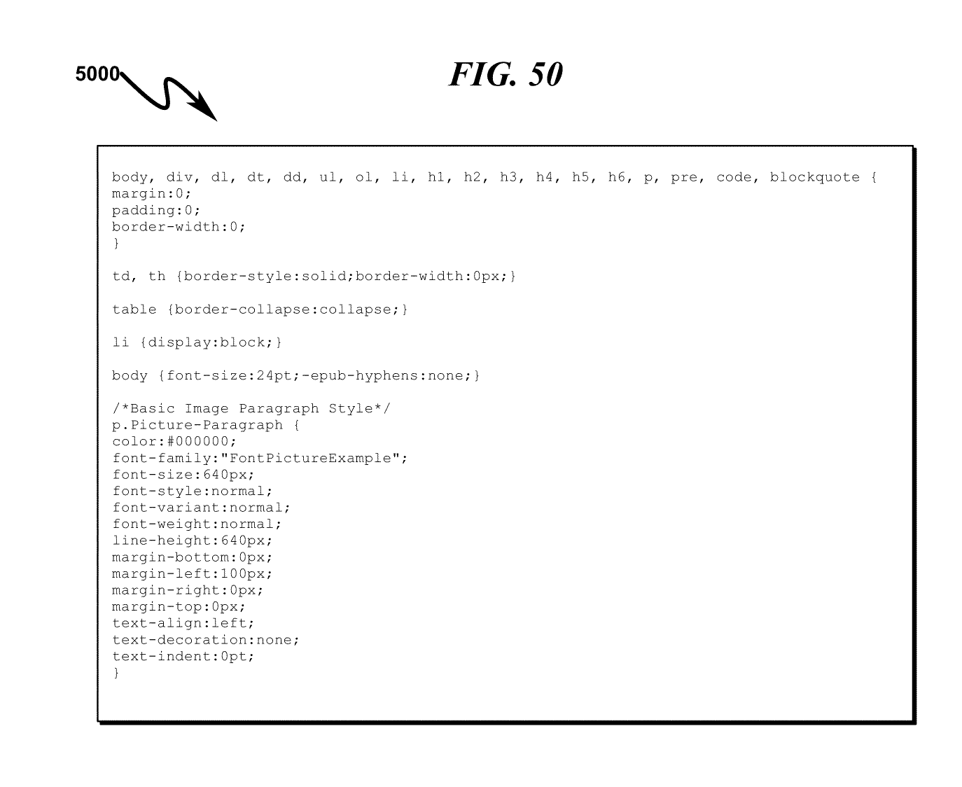

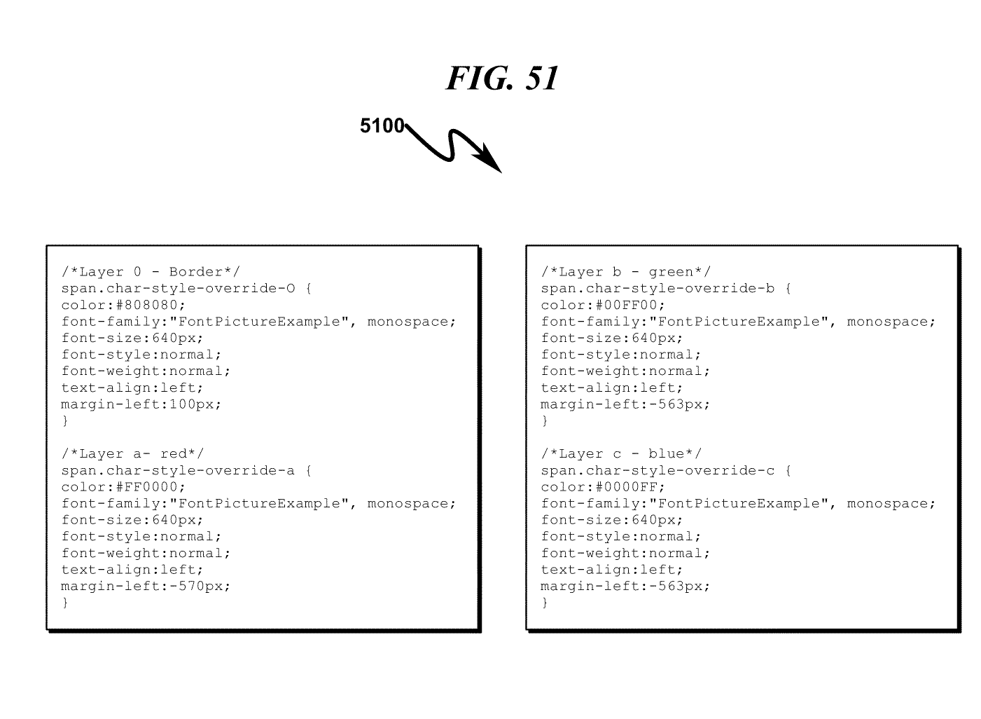

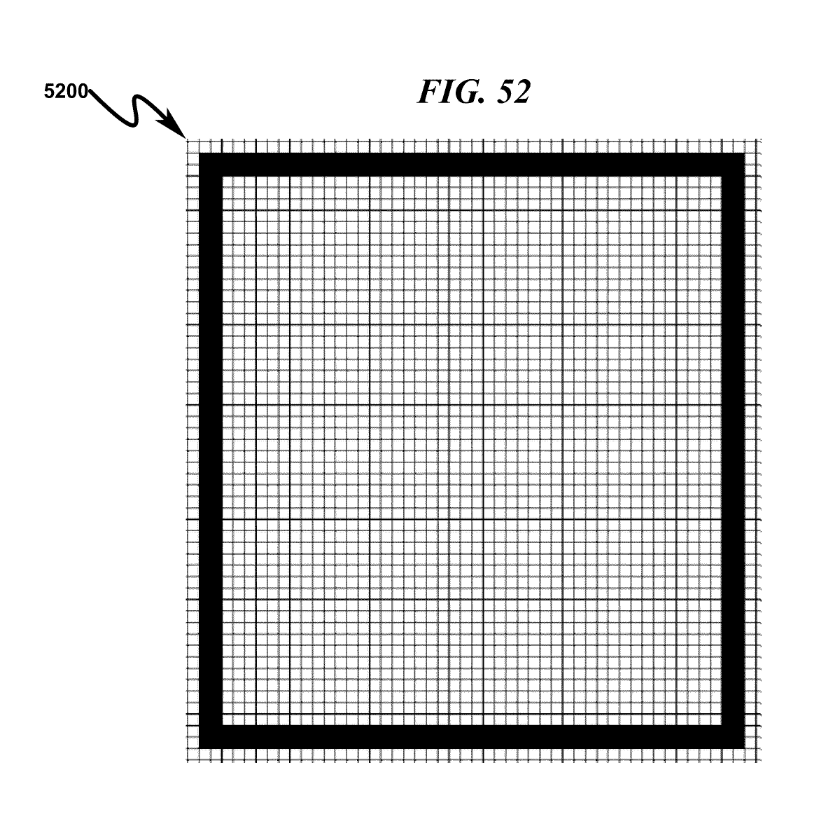

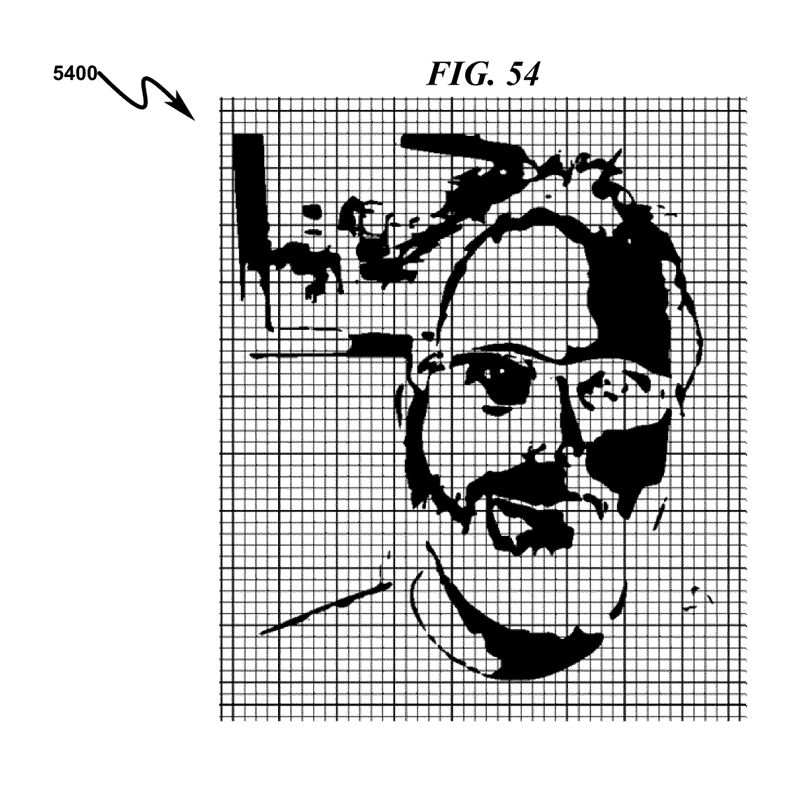

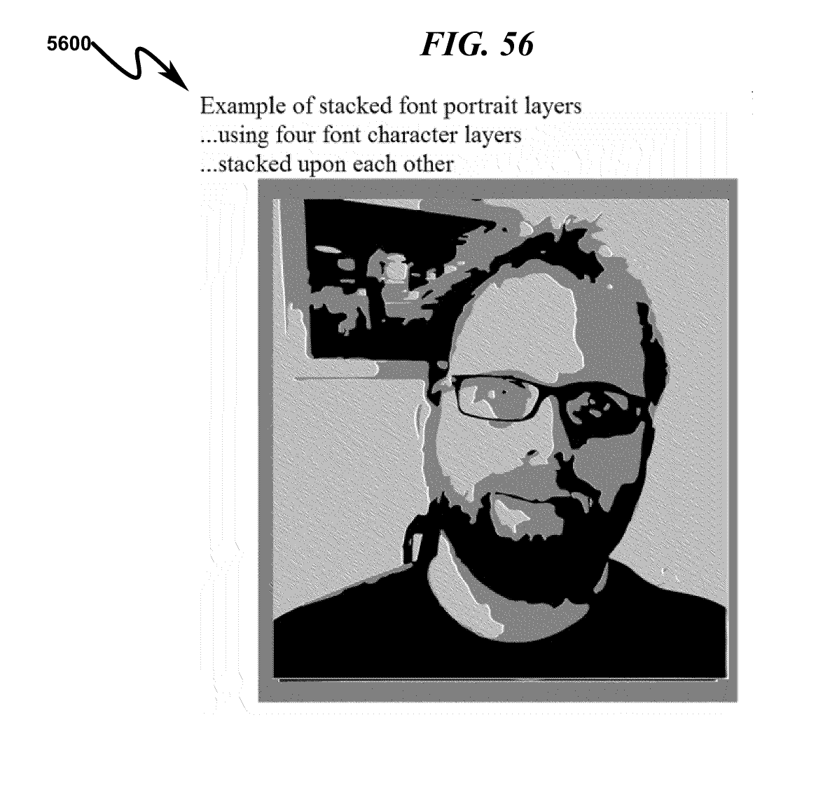

Another example of the present invention as applied to a typical HTML browser context is illustrated in FIG. 49 (4900)-FIG. 56 (5600), in which a typical rendering HTML file (FIG. 49 (4900)) is used in conjunction with cascading style sheet (CSS) data (FIG. 50 (5000)-FIG. 51 (5100)) to render the font characters “O”, “a”, “b”, and “c” that have been defined by the font editor as depicted in FIG. 52 (5200)-FIG. 54 (5400) respectively to be associated with a BORDER and LAYER 1, LAYER 2, and LAYER 3 of the image to be displayed. Each character (“O”, “a”, “b”, and “c”) may be rendered with a different color as depicted in the HTML and CSS data depicted in FIG. 50 (5000)-FIG. 51 (5100). Typically rendered output from the HTML in FIG. 49 (4900) is depicted in FIG. 56 (5600).

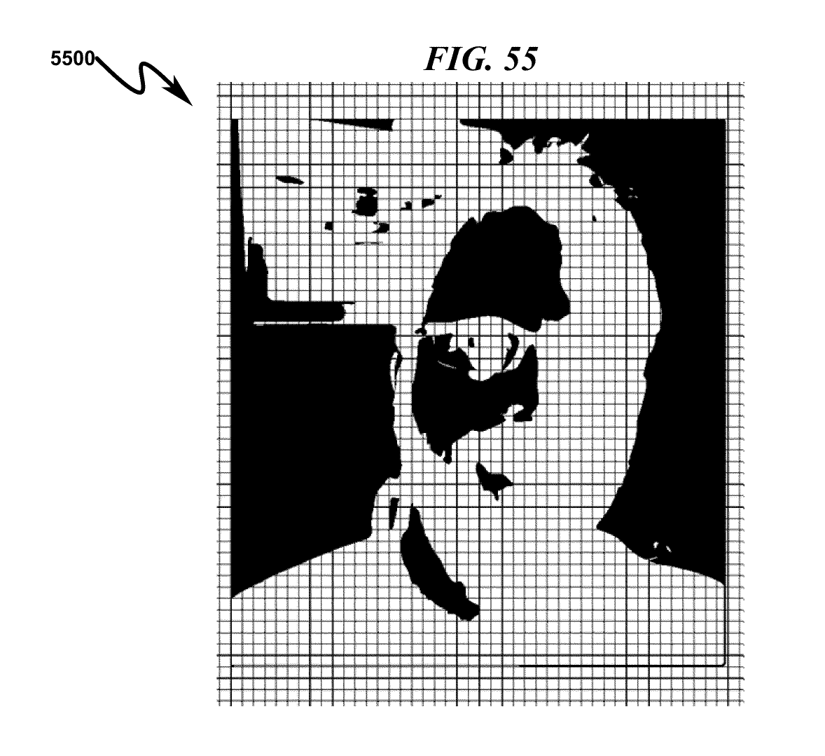

It should be noted that the font editor images of FIG. 52 (5200)-FIG. 55 (5500) are exemplary images taken from a font editor/generator utility and may be generated using any number of automated means from raw image data as discussed herein. Once the font file (typically a True Type Font (TTF) file format) is generated, it may be installed for use in the operating system by a number of utilities or via the use of HTML scripts as defined by the application context. One skilled in the art will no doubt be capable of achieving this task given the TTF font file generated by the present invention.

### System Fonts Vs. Embedded Web Fonts (5700)-(5800)

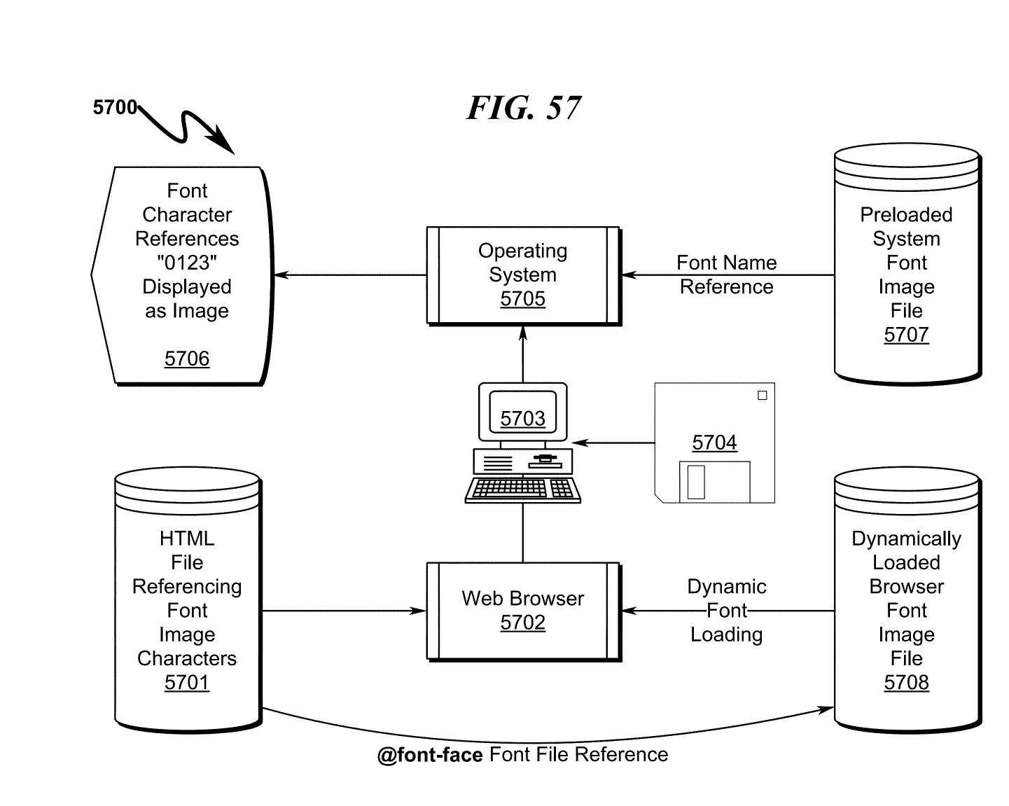

The present invention anticipates that rendering of graphic images using the font data that is extracted from the original image files may occur in a number of ways as generally illustrated in FIG. 57 (5700). Here it can be seen that the HTML file (5701) incorporating references to the image-based font file characters is interpreted by a web browser (5702) under control of a computer system (5703) executing machine instructions read from a computer readable medium (5704) as controlled by an operating system (5705). The execution of these machine instructions and operating system interpretation of the HTML document (5701) results in a graphical display (5706) that renders the desired graphical images in terms of individual font characters comprising distinct glyphs.

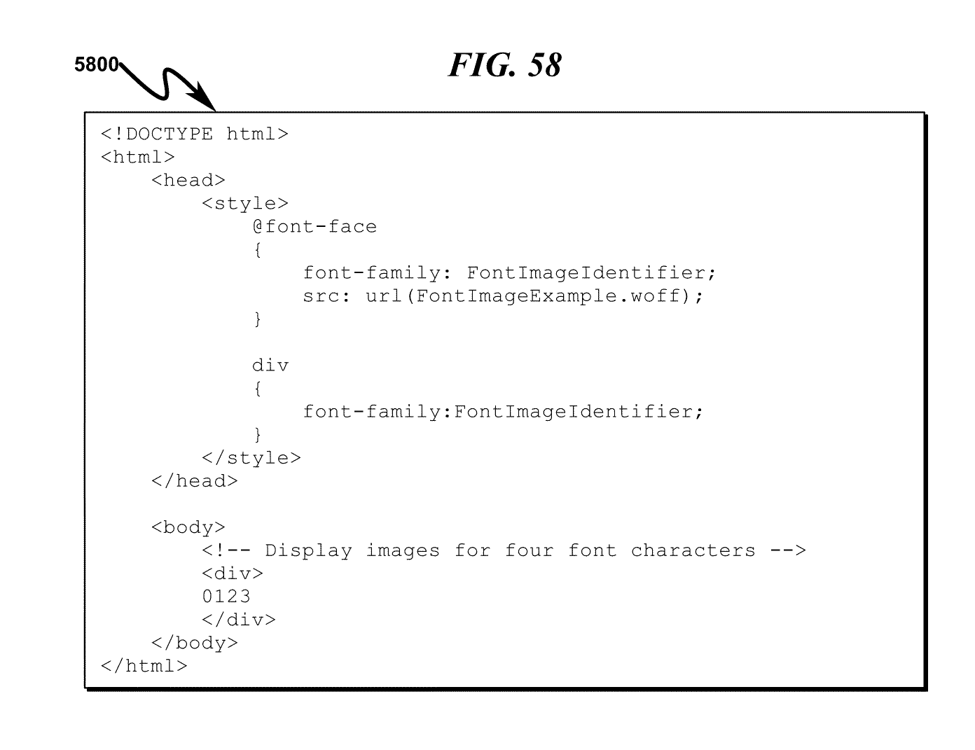

Exactly how the operating system (5705) is made aware of the image font library can occur in several ways. One methodology is to have the font file be installed as a system font (5707) such that it is part of the operating system and globally available. Another methodology that is preferred is to embed a file reference (5708) to the font within the HTML file using a CSS3 @font-face rule as generally depicted in FIG. 58 (5800). Here the FontImageIdentifer tag is used to identify the font internally and the FontImageExample.woff file represents the Web Open Font Format (WOFF) web font file that contains the image layers represented as separate characters. Hybrids of this approach are also possible wherein some of the font images are contained in system fonts and others are dynamically loaded. It should be noted that the use of system fonts (5707) may in some circumstances be loaded onto the operating system (5705) using HTML scripts or the like with no loss of generality in the overall invention scope.

### Font Alignment Options (5900)-(6300)

A significant deviation from the prior art treatment of fonts as implemented by the present invention is the purposeful overlapping of font displays to generate images in an efficient and web-portable manner. There are several techniques that may be utilized to achieve this overlapping characteristic.

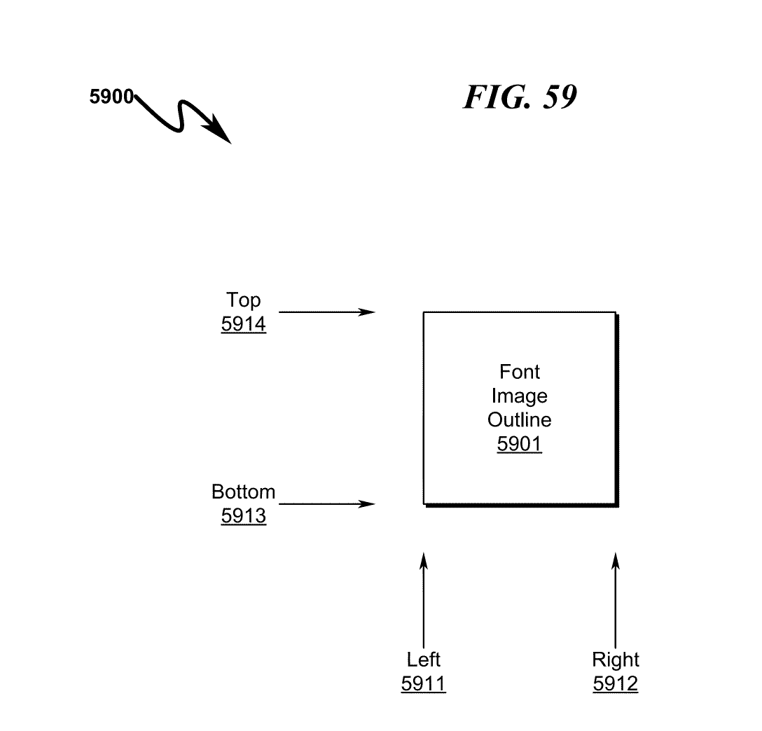

As generally illustrated in FIG. 59 (5900), a given font character definition (incorporating the image layer to be rendered) (5901) is defined by a left (5911), right (5912), bottom (5913), and top (5914) extent. Typically the font is configured for display such that these extents are used to define the position of the next font character to be displayed when text is rendered for display by the web browser and operating system. In addition to the left (5911), right (5912), bottom (5913), and top (5914) extents there are typically additional MARGIN parameters that dictate inter-character X (inter-character) and Y (inter-line) spacing.

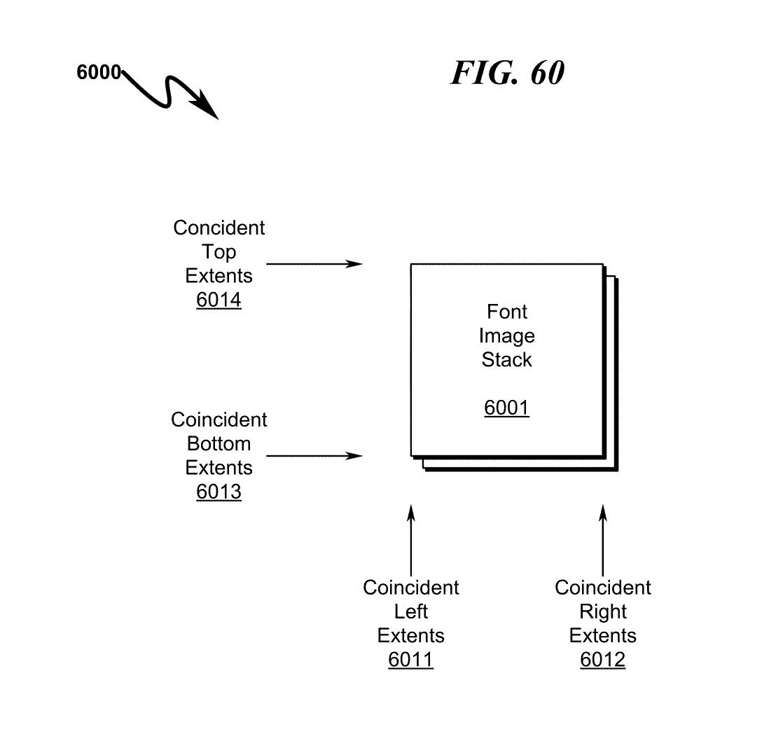

The present invention is configured to override these normal operations and force overlap of the individual font characters in a Z-plane configuration as generally depicted in FIG. 24 (2400) and FIG. 60 (6000) and provide for extents that are coincident (6011, 6012, 6013, 6014) for all the font characters representing the image stack (6001).

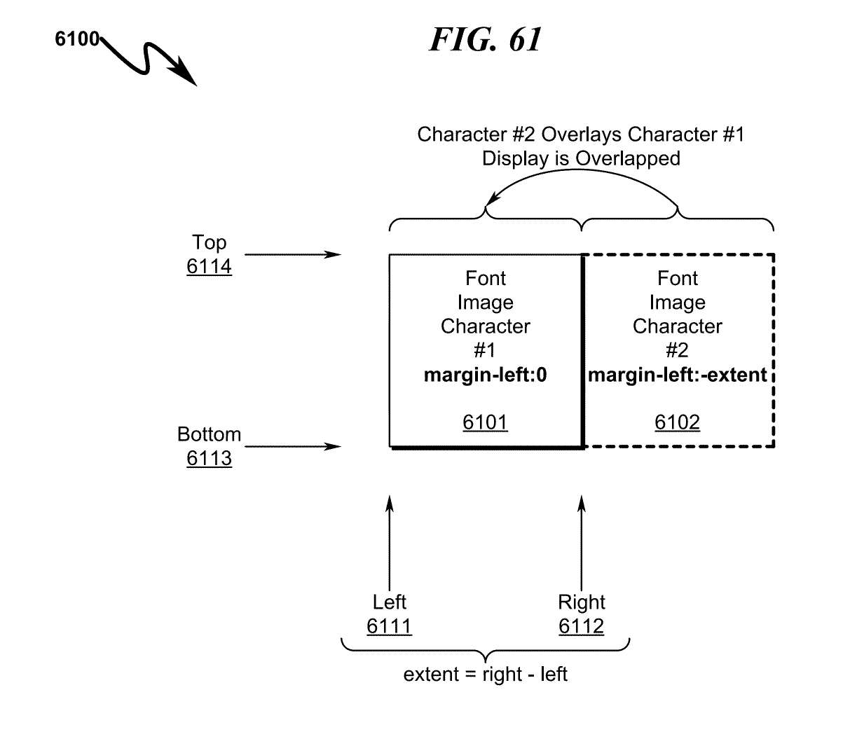

The overlapping nature of the font characters can be achieved using a wide variety of techniques. As generally illustrated in FIG. 33 (3300)-FIG. 56 (5600), this can be accomplished by printing one font character normally with a CSS margin-left parameter of zero (0) or some other fixed value and then adjusting the CSS margin-left parameter to be negative to move the subsequently displayed font characters to the left for the overwrite operation. Graphically, this general technique can be seen by inspection of FIG. 61 (6100), wherein a first font character (6101) is displayed with margin-left parameter of zero and a subsequent font character is displayed with margin-left parameter equal to the negative value of the font extent width (right (6112)-left (6111) extent values).

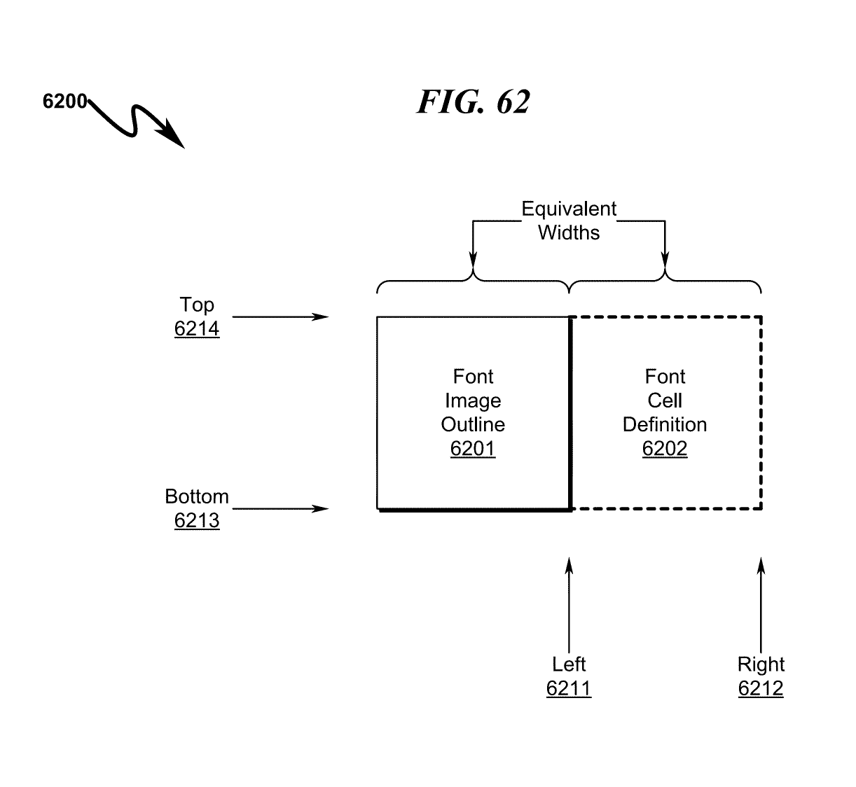

Another methodology as depicted in FIG. 62 (6200) might involve defining the font image (6201) to the left of the font cell definition area (6202) such that the margin-left parameter is embedded within the font character itself. Thus, once a given font character is displayed, a subsequent font character (as depicted in FIG. 62 (6200)) will be offset to the left to overwrite the previously displayed font image.

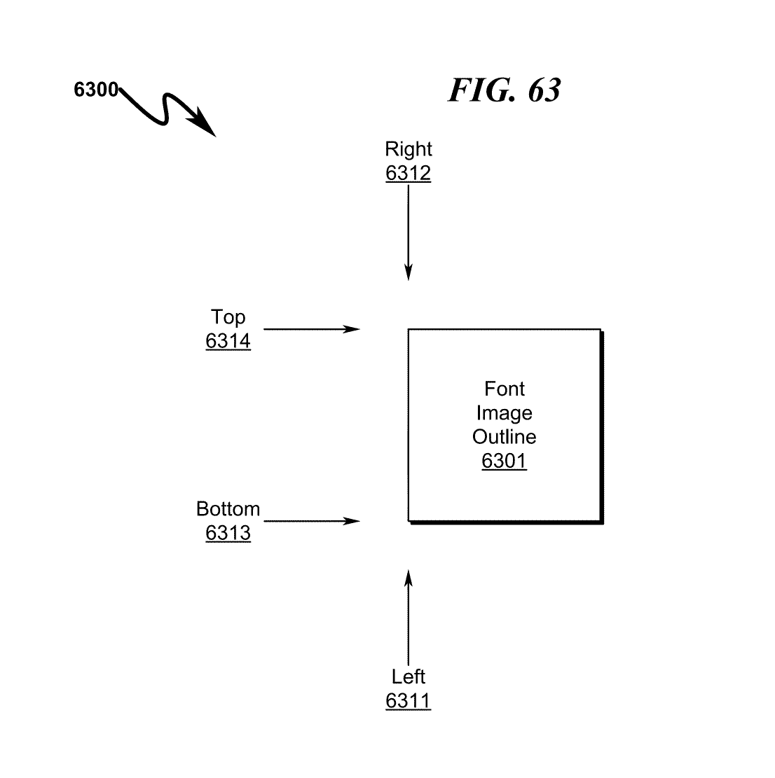

Yet another methodology to achieve this overlap is depicted in FIG. 63 (6300) wherein the left (6311) and right (6312) extents are defined to be coincident in the font definition, thus the font has no “width” to be stepped once displayed. While the font “width” in this context may be zero, this does not necessarily mean that there is no information to be rendered when the font is displayed, but rather that the step width to the next character is defined as zero (indicating no spacing between characters). Here as in other examples the font kerning and/or metrics settings are adjusted to align each font character with the previously presented character along a commonly viewed Z-axis.

### Glyph Rendering (6400)

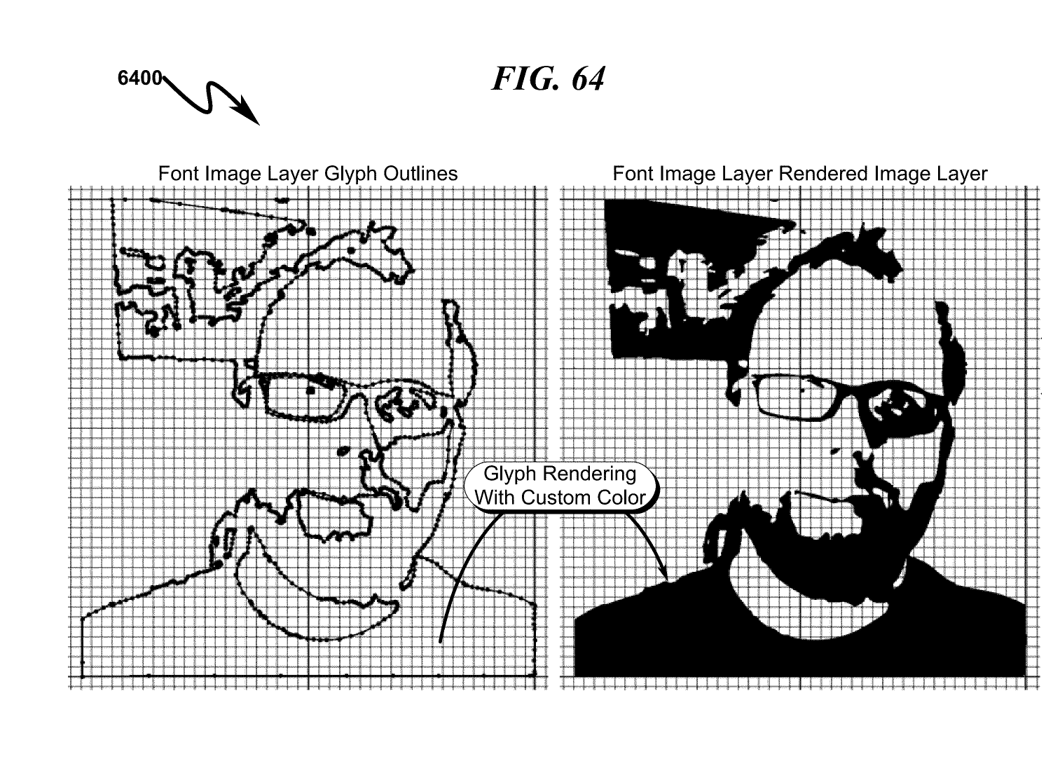

While the present invention anticipates that in most circumstances the color palette associated with a given font character will be defined external to the font definition within a given font library, it must be noted in some circumstances that the font library definition for a given character element is comprised of a number of glyph elements as generally depicted in FIG. 64 (6400). Each of these individual glyph elements is rendered to an output region on the display and may be associated within the font library with a specific color palette. While this color palette may be overridden when the font is actually rendered, in some circumstances it may be desirable to retain the color palette as defined in the font library when the image stack is rendered on a display or via a printer.

### System Summary

The present invention system anticipates a wide variety of variations in the basic theme of construction, but can be generalized as a print management system comprising:
(a) publication web server (PWS);
(b) image vectorizer;
(c) font generator; and
(d) font embedder;
wherein
the PWS is configured to receive complex image pattern data (CIP) representing an image;
the PWS is configured to direct the image vectorizer to convert the CIP to generate an intermediate graphic format (IGF) by vectorizing the CIP into specific vector pattern steps (VPS) of distinctive shapes, sizes, and colors;
the PWS is configured to direct the font generator to convert the IGF to a font definition data (FDD) that describes the VPS in terms of a standard display font (SDF);
the PWS is configured to direct the font embedder to embed the SDF into a web page using an embedded web font (EWF); and
the web page is configured to enable a user to display the IGF representation of the CIP via rendering of the EWF using a web browser.

This general system summary may be augmented by the various elements described herein to produce a wide variety of invention embodiments consistent with this overall design description.

### Method Summary

The present invention method anticipates a wide variety of variations in the basic theme of implementation, but can be generalized as a print management method comprising:
(1) receiving a complex image pattern data (CIP) representing an image via a publication web server (PWS);
(2) converting the CIP to an intermediate graphic format (IGF) by vectorizing the CIP into specific vector pattern steps (VPS) of distinctive shapes, sizes, and colors;
(3) converting the IGF to font definition data (FDD) that describes the VPS in terms of a standard display font (SDF);
(4) embedding the SDF into a web page using an embedded web font (EWF); and
(5) visually rendering the IGF representation of the CIP via use of the EWF using a web browser display.

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Alternate System Summary

An alternate invention system embodiment anticipates a wide variety of variations in the basic theme of construction, but can be generalized as a print management system comprising:
(a) publication web server (PWS); and
(b) printer;
wherein
the PWS is configured to present a graphical user interface (GUI) operating on a computer system executing instructions from a computer readable medium;
the PWS is configured to define font-based vector artwork images (VAI) and associated vector palette groups (VPG) by a publisher using the GUI;
the PWS is configured to accept customer selected VAI+VPG combinations for publication and allow the customer to visually proof images created by the combinations using the GUI;
the PWS is configured to determine if the visual proof of the customer selected VAI+VPG combinations is approved by the customer;
the PWS is configured to place a web order by the customer for a proof/production print (PPP) of the customer selected VAI+VPG combinations;
the PWS is configured to generate an intermediate graphic file (IGF) document of the PPP and generate an encapsulated document file (EDF) from the IGF;
the PWS is configured to transmit the EDF to the printer to render a physical print of the PPP using a print server driver (PSD);
the PWS is configured to generate prints of the PPP via the PSD using the printer as defined by the web order; and
the PWS is configured to process an electronic financial transaction from the customer to the publisher for each of the PPP prints generated by the PSD in the web order.

This general system summary may be augmented by the various elements described herein to produce a wide variety of invention embodiments consistent with this overall design description.

### Alternate Method Summary

An alternate invention method embodiment anticipates a wide variety of variations in the basic theme of implementation, but can be generalized as a print management method comprising:
(1) Defining font-based vector artwork images (VAI) and associated vector palette groups (VPG) by a publisher using a publication web server (PWS) graphical user interface (GUI) operating on a computer system executing instructions from a computer readable medium;
(2) Under control of the PWS, accepting customer selected VAI+VPG combinations for publication and allowing the customer to visually proof images created by the combinations using the GUI;
(3) Under control of the PWS, determining if the visual proof of the customer selected VAI+VPG combinations is approved by the customer, and if not, proceeding to step (2);
(4) Under control of the PWS, placing a web order by the customer for a proof/production print (PPP) of the customer selected VAI+VPG combinations;
(5) Under control of the PWS, generating an intermediate graphic file (IGF) document of the PPP and generating an encapsulated document file (EDF) from the IGF;
(6) Under control of the PWS, transmitting the EDF to a printer to render a physical print of the PPP using a print server driver (PSD);
(7) Under control of the PWS, generating prints of the PPP via the PSD using the printer as defined by the web order; and
(8) Under control of the PWS, processing an electronic financial transaction from the customer to the publisher for each of the PPP prints generated by the PSD in the web order.

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### System/Method Options

The system/method described herein may incorporate a wide variety of features, including but not limited to the following:
Color compensation for display monitors may be implemented based on a COLOR MONKEY® update of target printer characteristics.
Local color compensation for draft printing may be implemented at the user's computer site.
Print Pricing Matrix (PPM) may comprise a wide variety of entries such as quality, resolution, color, quantity, price.
The PPP may comprise a PDF file.
The EDF may further comprise a password locked PDF file.
The EDF may be matched to a target printer.
The EDF may incorporate a PPM.
The EDF may be configured to encrypt the PPP.
The EDF may comprise an executable self-extracting file.
The EDF decompression key may be located at the web server hosting the print processing operation.
The EDF may be configured to communicate with PWS and print based on a key provided to the printer driver with subsequent FLUSH of printer queue and printer memory.
The EDF may incorporate information necessary to expand/contract image size (with varying price points) based on the image sizing selected.
   One skilled in the art will recognize that this list is not exhaustive.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the IGF comprises a file format selected from a group consisting of: Encapsulated PostScript (EPS); and Scalable Vector Graphics (SVG).
An embodiment wherein the IGF further comprises a standard display font (SDF), the SDF selected from a group consisting of: Web Open Font Format (WOFF); TrueType; OpenType; and Embedded OpenType.
An embodiment wherein the IGF further comprises a standard display font (SDF) further comprising an embedded web font (EWF) wherein the EWF is configured to have zero horizontal advance glyph offsets and zero vertical advance glyph offsets.
An embodiment wherein the IGF further comprises vector artwork images (VAI) and vector pallet groups (VPG) associated with the VAI.
An embodiment wherein the IGF is a component of proof/production print (PPP) data associated with an encapsulated document file (EDF) wherein the EDF contains control information necessary to regulate the physical rendering of the PPP on a printer, the association selected from a group consisting of: encapsulation of the PPP within the EDF; and referencing the PPP external to the EDF.
An embodiment wherein the IGF generation further comprises a display proof approval entry dialog configured to associate a vector palette group (VPG) with a vector artwork image (VAI).
An embodiment wherein the PWS is configured to transfer the IGF to a printer configured to render a representation of the IGF, the rendering selected from a group consisting of: two-dimensional printing; and three-dimensional printing.
An embodiment wherein the printer is configured to communicate with an electronic funds transfer (EFT) server to authorize the rendering before the transfer.
An embodiment wherein the printer is configured to communicate with an electronic funds transfer (EFT) server to remit payment from a customer to a publisher after the IGF is rendered.

One skilled in the art will recognize that other embodiments are possible based on combinations of elements taught within the above invention description.

### Generalized Computer Usable Medium

In various alternate embodiments, the present invention may be implemented as a computer program product for use with a computerized computing system. Those skilled in the art will readily appreciate that programs defining the functions defined by the present invention can be written in any appropriate programming language and delivered to a computer in many forms, including but not limited to: (a) information permanently stored on non-writeable storage media (e.g., read-only memory devices such as ROMs or CD-ROM disks); (b) information alterably stored on writeable storage media (e.g., floppy disks and hard drives); and/or (c) information conveyed to a computer through communication media, such as a local area network, a telephone network, or a public network such as the Internet. When carrying computer readable instructions that implement the present invention methods, such computer readable media represent alternate embodiments of the present invention.

As generally illustrated herein, the present invention system embodiments can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. Pursuant to In re Beauregard, 35 USPQ2d 1383 (U.S. Pat. No. 5,710,578), the present invention anticipates and includes this type of computer readable media within the scope of the invention. Pursuant to In re Nuijten, 500 F.3d 1346 (Fed. Cir. 2007) (U.S. patent application Ser. No. 09/211,928), the present invention scope is limited to computer readable media wherein the media is both tangible and non-transitory.

### CONCLUSION

A print management system/method allowing definition of font-based vector artwork images (VAI) that may be associated with selected vector palette groups (VPG) for print publication has been disclosed. The system/method operates to permit a publisher to define a catalog of VAIs and associated VPGs that together define sets of font-based presentation images (FPI). Customers may select among the various FPI to generate a proof/production print (PPP) file that is processed by a web server to generate an encapsulated document file (EDF) incorporating the PPP in addition to information supporting an electronic financial transaction (EFT) between the customer and publisher. The customer may transfer the EDF to a printer who then activates the EDF to affect both the print publication of the PPP and an ETF between the customer and publisher based on the number of physical prints of the PPP by the printer.

1. A print management system comprising:
(a) publication web server (PWS);
(b) image vectorizer;
(c) font generator; and
(d) font embedder;
wherein
said PWS is configured to receive complex image pattern data (CIP) representing an image;
said PWS is configured to direct said image vectorizer to convert said CIP to generate an intermediate graphic format (IGF) by vectorizing said CIP into specific vector pattern steps (VPS) of distinctive shapes, sizes, and colors;
said PWS is configured to direct said font generator to convert said IGF to font definition data (FDD) that describes said VPS in terms of a standard display font (SDF);
said PWS is configured to direct said font embedder to embed said SDF into a web page using an embedded web font (EWF); and
said web page is configured to visually render said IGF representation of said CIP via use of said EWF using a web browser display.

2. The print management system of claim 1 wherein said IGF comprises a file format selected from a group consisting of: Encapsulated PostScript (EPS); and Scalable Vector Graphics (SVG).

3. The print management system of claim 1 wherein said SDF is selected from a group consisting of: Web Open Font Format (WOFF); TrueType; OpenType; and Embedded OpenType.

4. The print management system of claim 1 wherein said EWF is configured to have zero horizontal advance glyph offsets and zero vertical advance glyph offsets.

5. The print management system of claim 1 wherein said IGF further comprises vector artwork images (VAI) and vector pallet groups (VPG) associated with said VAI.

6. The print management system of claim 1 wherein said IGF is a component of proof/production print (PPP) data associated with an encapsulated document file (EDF) wherein said EDF contains control information necessary to regulate the physical rendering of said PPP on a printer, said association selected from a group consisting of: encapsulation of said PPP within said EDF; and referencing said PPP external to said EDF.

7. The print management system of claim 1 wherein said IGF generation further comprises a display proof approval entry dialog configured to associate a vector palette group (VPG) with a vector artwork image (VAI).

8. The print management system of claim 1 wherein said PWS is configured to transfer said IGF to a printer configured to render a representation of said IGF, said rendering selected from a group consisting of: two-dimensional printing; and three-dimensional printing.

9. The print management system of claim 8 wherein said printer is configured to communicate with an electronic funds transfer (EFT) server to authorize said rendering before said transfer.

10. The print management system of claim 8 wherein said printer is configured to communicate with an electronic funds transfer (EFT) server to remit payment from a customer to a publisher after said IGF is rendered.

11. A print management method comprising:
(1) receiving a complex image pattern data (CIP) representing an image via a publication web server (PWS);
(2) converting said CIP to an intermediate graphic format (IGF) by vectorizing said CIP into specific vector pattern steps (VPS) of distinctive shapes, sizes, and colors;
(3) converting said IGF to font definition data (FDD) that describes said VPS in terms of a standard display font (SDF);
(4) embedding said SDF into a web page using an embedded web font (EWF); and
(5) visually rendering said IGF representation of said CIP via use of said EWF using a web browser display.

12. The print management method of claim 11 wherein said IGF comprises a file format selected from a group consisting of: Encapsulated PostScript (EPS); and Scalable Vector Graphics (SVG).

13. The print management method of claim 11 wherein said SDF is selected from a group consisting of: Web Open Font Format (WOFF); TrueType; OpenType; and Embedded OpenType.

14. The print management method of claim 11 wherein said EWF is configured to have zero horizontal advance glyph offsets and zero vertical advance glyph offsets.

15. The print management method of claim 11 wherein said IGF further comprises vector artwork images (VAI) and vector pallet groups (VPG) associated with said VAI.

16. The print management method of claim 11 wherein said IGF is a component of proof/production print (PPP) data associated with an encapsulated document file (EDF) wherein said EDF contains control information necessary to regulate the physical rendering of said PPP on a printer, said association selected from a group consisting of: encapsulation of said PPP within said EDF; and referencing said PPP external to said EDF.

17. The print management method of claim 11 wherein said IGF generation further comprises a display proof approval entry dialog configured to associate a vector palette group (VPG) with a vector artwork image (VAI).

18. The print management method of claim 11 wherein said PWS is configured to transfer said IGF to a printer configured to render a representation of said IGF, said rendering selected from a group consisting of: two-dimensional printing; and three-dimensional printing.

19. The print management method of claim 18 wherein said printer is configured to communicate with an electronic funds transfer (EFT) server to authorize said rendering before said transfer.

20. The print management method of claim 18 wherein said printer is configured to communicate with an electronic funds transfer (EFT) server to remit payment from a customer to a publisher after said IGF is rendered.

21. A tangible non-transitory computer usable medium having computer-readable program code means embodied thereon comprising a print management method comprising:
(1) receiving complex image pattern data (CIP) representing an image;
(2) converting said CIP to an intermediate graphic format (IGF) by vectorizing said CIP into specific vector pattern steps (VPS) of distinctive shapes, sizes, and colors;
(3) converting said IGF to font definition data (FDD) that describes said VPS in terms of a standard display font (SDF);
(4) embedding said SDF into a web page using an embedded web font (EWF); and
(5) visually rendering said IGF representation of said CIP via use of said EWF using a web browser display.

22. The computer usable medium of claim 21 wherein said IGF comprises a file format selected from a group consisting of: Encapsulated PostScript (EPS); and Scalable Vector Graphics (SVG).

23. The computer usable medium of claim 21 wherein said SDF is selected from a group consisting of: Web Open Font Format (WOFF); TrueType; OpenType; and Embedded OpenType.

24. The computer usable medium of claim 21 wherein said EWF is configured to have zero horizontal advance glyph offsets and zero vertical advance glyph offsets.

25. The computer usable medium of claim 21 wherein said IGF further comprises vector artwork images (VAI) and vector pallet groups (VPG) associated with said VAI.

26. The computer usable medium of claim 21 wherein said IGF is a component of proof/production print (PPP) data associated with an encapsulated document file (EDF) wherein said EDF contains control information necessary to regulate the physical rendering of said PPP on a printer, said association selected from a group consisting of: encapsulation of said PPP within said EDF; and referencing said PPP external to said EDF.

27. The computer usable medium of claim 21 wherein said IGF generation further comprises a display proof approval entry dialog configured to associate a vector palette group (VPG) with a vector artwork image (VAI).

28. The computer usable medium of claim 21 wherein said PWS is configured to transfer said IGF to a printer configured to render a representation of said IGF, said rendering selected from a group consisting of: two-dimensional printing; and three-dimensional printing.

29. The computer usable medium of claim 28 wherein said printer is configured to communicate with an electronic funds transfer (EFT) server to authorize said rendering before said transfer.

30. The computer usable medium of claim 28 wherein said printer is configured to communicate with an electronic funds transfer (EFT) server to remit payment from a customer to a publisher after said IGF is rendered.

31. A print management system comprising:
(a) publication web server (PWS); and
(b) printer;
wherein
said PWS is configured to present a graphical user interface (GUI) operating on a computer system executing instructions from a computer readable medium;
said PWS is configured to define font-based vector artwork images (VAI) and associated vector palette groups (VPG) by a publisher using said GUI;
said PWS is configured to accept customer selected VAI+VPG combinations for publication and allow said customer to visually proof images created by said combinations using said GUI;
said PWS is configured to determine if said visual proof of said customer selected VAI+VPG combinations is approved by said customer;
said PWS is configured to place a web order by said customer for a proof/production print (PPP) of said customer selected VAI+VPG combinations;
said PWS is configured to generate an intermediate graphic file (IGF) document of said PPP and generate an encapsulated document file (EDF) from said IGF;
said PWS is configured to transmit said EDF to said printer to render a physical print of said PPP using a print server driver (PSD);
said PWS is configured to generate prints of the PPP via said PSD using said printer as defined by said web order; and
said PWS is configured to process an electronic financial transaction from said customer to said publisher for each of said PPP prints generated by said PSD in said web order.

32. The print management system of claim 31 wherein said IGF comprises a file format selected from a group consisting of: Encapsulated PostScript (EPS); and Scalable Vector Graphics (SVG).

33. The print management system of claim 31 wherein said IGF further comprises a standard display font (SDF), said SDF selected from a group consisting of: Web Open Font Format (WOFF); TrueType; OpenType; and Embedded OpenType.

34. The print management system of claim 31 wherein said IGF further comprises a standard display font (SDF) further comprising an embedded web font (EWF) wherein said EWF is configured to have zero horizontal advance glyph offsets and zero vertical advance glyph offsets.

35. The print management system of claim 31 wherein said IGF further comprises vector artwork images (VAI) and vector pallet groups (VPG) associated with said VAI.

36. The print management system of claim 31 wherein said IGF is a component of proof/production print (PPP) data associated with an encapsulated document file (EDF) wherein said EDF contains control information necessary to regulate the physical rendering of said PPP on a printer, said association selected from a group consisting of: encapsulation of said PPP within said EDF; and referencing said PPP external to said EDF.

37. The print management system of claim 31 wherein said IGF generation further comprises a display proof approval entry dialog configured to associate a vector palette group (VPG) with a vector artwork image (VAI).

38. The print management system of claim 31 wherein said PWS is configured to transfer said IGF to a printer configured to render a representation of said IGF, said rendering selected from a group consisting of: two-dimensional printing; and three-dimensional printing.

39. The print management system of claim 38 wherein said printer is configured to communicate with an electronic funds transfer (EFT) server to authorize said rendering before said transfer.

40. The print management system of claim 38 wherein said printer is configured to communicate with an electronic funds transfer (EFT) server to remit payment from a customer to a publisher after said IGF is rendered.

41. A print management method comprising:
(1) Defining font-based vector artwork images (VAI) and associated vector palette groups (VPG) by a publisher using a publication web server (PWS) graphical user interface (GUI) operating on a computer system executing instructions from a computer readable medium;
(2) Under control of said PWS, accepting customer selected VAI+VPG combinations for publication and allowing said customer to visually proof images created by said combinations using said GUI;
(3) Under control of said PWS, determining if said visual proof of said customer selected VAI+VPG combinations is approved by said customer, and if not, proceeding to said step (2);
(4) Under control of said PWS, placing a web order by said customer for a proof/production print (PPP) of said customer selected VAI+VPG combinations;
(5) Under control of said PWS, generating an intermediate graphic file (IGF) document of said PPP and generating an encapsulated document file (EDF) from said IGF;
(6) Under control of said PWS, transmitting said EDF to a printer to render a physical print of said PPP using a print server driver (PSD);
(7) Under control of said PWS, generating prints of the PPP via said PSD using said printer as defined by said web order; and
(8) Under control of said PWS, processing an electronic financial transaction from said customer to said publisher for each of said PPP prints generated by said PSD in said web order.

42. The print management method of claim 41 wherein said IGF comprises a file format selected from a group consisting of: Encapsulated PostScript (EPS); and Scalable Vector Graphics (SVG).

43. The print management method of claim 41 wherein said IGF further comprises a standard display font (SDF), said SDF selected from a group consisting of: Web Open Font Format (WOFF); TrueType; OpenType; and Embedded OpenType.

44. The print management method of claim 41 wherein said IGF further comprises a standard display font (SDF) further comprising an embedded web font (EWF) wherein said EWF is configured to have zero horizontal advance glyph offsets and zero vertical advance glyph offsets.

45. The print management method of claim 41 wherein said IGF further comprises vector artwork images (VAI) and vector pallet groups (VPG) associated with said VAI.

46. The print management method of claim 41 wherein said IGF is a component of proof/production print (PPP) data associated with an encapsulated document file (EDF) wherein said EDF contains control information necessary to regulate the physical rendering of said PPP on a printer, said association selected from a group consisting of: encapsulation of said PPP within said EDF; and referencing said PPP external to said EDF.

47. The print management method of claim 41 wherein said IGF generation further comprises a display proof approval entry dialog configured to associate a vector palette group (VPG) with a vector artwork image (VAI).

48. The print management method of claim 41 wherein said PWS is configured to transfer said IGF to a printer configured to render a representation of said IGF, said rendering selected from a group consisting of: two-dimensional printing; and three-dimensional printing.

49. The print management method of claim 48 wherein said printer is configured to communicate with an electronic funds transfer (EFT) server to authorize said rendering before said transfer.

50. The print management method of claim 48 wherein said printer is configured to communicate with an electronic funds transfer (EFT) server to remit payment from a customer to a publisher after said IGF is rendered.

51. A tangible non-transitory computer usable medium having computer-readable program code means embodied thereon comprising a print management method comprising:
(1) Defining font-based vector artwork images (VAI) and associated vector palette groups (VPG) by a publisher using a publication web server (PWS) graphical user interface (GUI) operating on a computer system executing instructions from a computer readable medium;
(2) Under control of said PWS, accepting customer selected VAI+VPG combinations for publication and allowing said customer to visually proof images created by said combinations using said GUI;
(3) Under control of said PWS, determining if said visual proof of said customer selected VAI+VPG combinations is approved by said customer, and if not, proceeding to said step (2);
(4) Under control of said PWS, placing a web order by said customer for a proof/production print (PPP) of said customer selected VAI+VPG combinations;
(5) Under control of said PWS, generating an intermediate graphic file (IGF) document of said PPP and generating an encapsulated document file (EDF) from said IGF;
(6) Under control of said PWS, transmitting said EDF to a printer to render a physical print of said PPP using a print server driver (PSD);
(7) Under control of said PWS, generating prints of the PPP via said PSD using said printer as defined by said web order; and
(8) Under control of said PWS, processing an electronic financial transaction from said customer to said publisher for each of said PPP prints generated by said PSD in said web order.

52. The computer usable medium of claim 51 wherein said IGF comprises a file format selected from a group consisting of: Encapsulated PostScript (EPS); and Scalable Vector Graphics (SVG).

53. The computer usable medium of claim 51 wherein said IGF further comprises a standard display font (SDF), said SDF selected from a group consisting of: Web Open Font Format (WOFF); TrueType; OpenType; and Embedded OpenType.

54. The computer usable medium of claim 51 wherein said IGF further comprises a standard display font (SDF) further comprising an embedded web font (EWF) wherein said EWF is configured to have zero horizontal advance glyph offsets and zero vertical advance glyph offsets.

55. The computer usable medium of claim 51 wherein said IGF further comprises vector artwork images (VAI) and vector pallet groups (VPG) associated with said VAI.

56. The computer usable medium of claim 51 wherein said IGF is a component of proof/production print (PPP) data associated with an encapsulated document file (EDF) wherein said EDF contains control information necessary to regulate the physical rendering of said PPP on a printer, said association selected from a group consisting of: encapsulation of said PPP within said EDF; and referencing said PPP external to said EDF.

57. The computer usable medium of claim 51 wherein said IGF generation further comprises a display proof approval entry dialog configured to associate a vector palette group (VPG) with a vector artwork image (VAI).

58. The computer usable medium of claim 51 wherein said PWS is configured to transfer said IGF to a printer configured to render a representation of said IGF, said rendering selected from a group consisting of: two-dimensional printing; and three-dimensional printing.

59. The computer usable medium of claim 58 wherein said printer is configured to communicate with an electronic funds transfer (EFT) server to authorize said rendering before said transfer.

60. The computer usable medium of claim 58 wherein said printer is configured to communicate with an electronic funds transfer (EFT) server to remit payment from a customer to a publisher after said IGF is rendered.
